(19) United States
(12) Patent Application Publication
(10) Pub. No.: US 2025/0190017 A1
(43) Pub. Date: Jun. 12, 2025

(54) POSITIONING, STABILISING, AND INTERFACING STRUCTURES AND SYSTEM INCORPORATING SAME

(71) Applicant: RESMED PTY LTD, Bella Vista, New South Wales (AU)

(72) Inventors: Ian Andrew LAW, Sydney (AU); Aaron Samuel DAVIDSON, Sydney (AU); Hugh Francis Stewart THOMAS, Sydney (AU); Albert Jack Greenwood WOFFENDEN, Sydney (AU); Kishore MARKAPURAM CHENGALVARAYAN, Sydney (AU); Memduh GUNEY, Sydney (AU); Riley Joel MOORE, Sydney (AU); Gregory Kendall KNIGHT, Sydney (AU); Ashley Taylor CONEN, Sydney (AU)

(21) Appl. No.: 18/840,114

(22) PCT Filed: Feb. 22, 2023
(86) PCT No.: PCT/AU2023/050120

§ 371 Date: Aug. 21, 2024

(30) Foreign Application Priority Data
Feb. 22, 2022 (AU) 2022900404
Mar. 18, 2022 (AU) 2022900671
Aug. 31, 2022 (AU) 2022902498

(51) Int. Cl. G06F 1/16

(52) U.S. Cl. CPC G06F 1/163

(57) ABSTRACT

A head-mounted display system comprising: a head-mounted display unit comprising: a display unit housing comprising a display; and an interfacing structure; and a positioning and stabilising structure comprising: a pair of arms connected in use to respective lateral sides of the display unit housing, the arms being substantially rigid and being constructed and arranged to project posteriorly from the display unit housing on respective lateral sides, a posterior portion of each arm comprising a superior arm connection portion and an inferior arm connection portion; a top strap portion to connect between each of the superior arm connection portions of the pair of arms and the head-mounted display unit; and an occipital strap portion to connect between the inferior arm connection portions and engage a portion of the user's head overlying or lying inferior to an occipital region of the user's head in use.

A portion of the disclosure of this patent document contains material which is subject to copyright protection. The copyright owner has no objection to the facsimile reproduction by anyone of the patent document or the patent disclosure, as it appears in Patent Office patent files or records, but otherwise reserves all copyright rights whatsoever.

### 1 CROSS-REFERENCE TO RELATED APPLICATIONS

This application claims the benefit of Australian Provisional Application No. 2022900404, filed 22 Feb. 2022, Australian Provisional Application No. 2022900671, filed 18 Mar. 2022, and Australian Provisional Application No. 2022902498, filed 31 Aug. 2022, each of which is incorporated herein by reference in its entirety.

### 2 BACKGROUND OF THE TECHNOLOGY

### 2.1 Field of the Technology

The present technology relates generally to head mounted displays, positioning and stabilizing structures, user interfacing structures, and other components for use in head mounted displays, associated head-mounted display assemblies and systems including a display unit and positioning and stabilizing structure, interfacing structures and or components, and methods. The present technology finds particular application in the use of immersive reality head mounted displays and is herein described in that context. It is to be appreciated that the present technology may have broader application and may be used in any type of head-mounted display arrangement including, but not limited to, virtual reality displays, augmented reality displays, and/or mixed reality displays.

### 2.2 Description of the Related Art

It is to be understood that, if any prior art is referred to herein, such reference does not constitute an admission that the prior art forms a part of the common general knowledge in the art, in Australia or any other country.

### 2.2.1 Immersive Technology

An immersive technology refers to technology that attempts to replicate or augment a physical environment through the means of a digital or virtual environment by creating a surrounding sensory feeling, thereby creating a sense of immersion.

In particular, an immersive technology provides the user visual immersion, and creates virtual objects and/or a virtual environment. The immersive technology may also provide immersion for at least one of the other five senses.

### 2.2.2 Virtual Reality

Virtual reality (VR) is a computer-generated three-dimensional image or environment that is presented to a user. In other words, the environment may be entirely virtual. Specifically, the user observes an electronic screen in order to observe virtual or computer generated images in a virtual environment. Since the created environment is entirely virtual, the user may be blocked and/or obstructed from interacting with their physical environment (e.g., they may be unable to hear and/or see the physical objects in the physical environment that they are currently located).

The electronic screen may be supported in the user's line of sight (e.g., mounted to the user's head). While observing the electronic screen, visual feedback output by the electronic screen and observed by the user may produce a virtual environment intended to simulate an actual environment. For example, the user may be able to look around (e.g.,) 360° by pivoting their head or their entire body, and interact with virtual objects observable by the user through the electronic screen. This may provide the user with an immersive experience where the virtual environment provides stimuli to at least one of the user's five senses, and replaces the corresponding stimuli of the physical environment while the user uses the VR device. Typically, the stimuli relates at least to the user's sense of sight (i.e., because they are viewing an electronic screen), but other senses may also be included. The electronic screens are typically mounted to the user's head so that they may be positioned in close proximity to the user's eyes, which allows the user to easily observe the virtual environment.

The VR device may produce other forms of feedback in addition to, or aside from, visual feedback. For example, the VR device may include and/or be connected to a speaker in order to provide auditory feedback. The VR device may also include tactile feedback (e.g., in the form of haptic response), which may correspond to the visual and/or auditory feedback. This may create a more immersive virtual environment, because the user receives stimuli corresponding to more than one of the user's senses.

While using a VR device, a user may wish to limit or block ambient stimulation. For example, the user may want to avoid seeing and/or hearing the ambient environment in order to better process stimuli from the VR device in the virtual environment. Thus, VR devices may limit and/or prevent the user's eyes from receiving ambient light. In some examples, this may be done by providing a seal against the user's face. In some examples, a shield may be disposed proximate to (e.g., in contact or close contact with) the user's face, but may not seal against the user's face. In either example, ambient light may not reach the user's eyes, so that the only light observable by the user is from the electronic screen.

In other examples, the VR devices may limit and/or prevent the user's ears from hearing ambient noise. In some examples, this may be done by providing the user with headphones (e.g., noise cancelling headphones), which may output sounds from the VR device and/or limit the user from hearing noises from their physical environment. In some examples, the VR device may output sounds at a volume sufficient to limit the user from hearing ambient noise.

In any example, the user may not want to become overstimulated (e.g., by both their physical environment and the virtual environment). Therefore, blocking and/or limiting the ambient from stimulating the user assists the user in focusing on the virtual environment, without possible distractions from the ambient.

Different types of VR devices are described below. Generally, a single VR device may include at least two different classifications. For example, the VR device may be classified by its portability and by how the display unit is coupled to the rest of the interface. These classifications may be independent, so that classification in one group (e.g., the portability of the unit) does not predetermine classification into another group. There may also be additional categories to classify VR devices, which are not explicitly listed below.

### 2.2.2.1 Portability

### 2.2.2.1.1 Fixed Unit

In some forms, a VR device may be used in conjunction with a separate device, like a computer or video game console. This type of VR device may be fixed, since it cannot be used without the computer or video game console, and thus locations where it can be used are limited (e.g., by the location of the computer or video game console).

Since the VR device can be used in conjunction with the computer or video game console, the VR device may be connected to the computer or video game console. For example, an electrical cord may tether the two systems together. This may further “fix” the location of the VR device, since the user wearing the VR device cannot move further from the computer or video game console than the length of the electrical cord. In other examples, the VR device may be wirelessly connected (e.g., via Bluetooth, Wi-Fi, etc.), but may still be relatively fixed by the strength of the wireless signal.

The connection to the computer or video game console may provide control functions to the VR device. The controls may be communicated (i.e., through a wired connector or wirelessly) in order to help operate the VR device. In examples of a fixed unit VR device, these controls may be necessary in order to operate the display screen, and the VR device may not be operable without the connection to the computer or video game console.

In some forms, the computer or video game console may provide electrical power to the VR device, so that the user does not need to support a battery on their head. This may make the VR device more comfortable to wear, since the user does not need to support the weight of a battery.

The user may also receive outputs from the computer or video game console at least partially through the VR device, as opposed to through a television or monitor, which may provide the user with a more immersive experience while using the computer or video game console (e.g., playing a video game). In other words, the display output of the VR device may be substantially the same as the output from a computer monitor or television. Some controls and/or sensors necessary to output these images may be housed in the computer or video game console, which may further reduce the weight that the user is required to support on their body.

In some forms, movement sensors may be positioned remote from the VR device, and connected to the computer or video game console. For example, at least one camera may face the user in order to track movements of the user's head. The processing of the data recorded by the camera(s) may be done by the computer or video game console, before being transmitted to the VR device. While this may assist in weight reduction of the VR device, it may also further limit where the VR device can be used. In other words, the VR device must be in the sight line of the camera(s).

### 2.2.2.1.2 Portable Unit

In some forms, the VR device may be a self-contained unit, which includes a power source and sensors, so that the VR device does not need to be connected to a computer or video game console. This provides the user more freedom of use and movement. For example, the user is not limited to using the VR device near a computer or video game console, and could use the VR device outdoors, or in other environments that do not include computers or televisions.

Since the VR device is not connected to a computer or video game console in use, the VR device is required to support all necessary electronic components. This includes batteries, sensors, and processors. These components add weight to the VR device, which the user must support on their body. Appropriate weight distribution may be needed so that this added weight does not increase discomfort to a user wearing the VR device.

In some forms, the electrical components of the VR device are contained in a single housing, which may be disposed directly in front of the user's face, in use. This configuration may be referred to as a “brick.” In this configuration, the center of gravity of the VR device without the positioning and stabilizing structure is directly in front of the user's face. In order to oppose the moment created by the force of gravity, the positioning and stabilizing structure coupled to the brick configuration must provide a force directed into the user's face, for example created by tension in headgear straps. While the brick configuration may be beneficial for manufacturing (e.g., since all electrical components are in close proximity) and may allow interchangeability of positioning and stabilizing structures (e.g., because they include no electrical connections), the force necessary to maintain the position of the VR device (e.g., tensile forces in headgear) may be uncomfortable to the user. Specifically, the VR device may dig into the user's face, leading to irritation and markings on the user's skin. The combination of forces may feel like “clamping” as the user's head receives force from the display housing on their face and force from headgear on the back of their head. This may make a user less likely to wear the VR device.

As VR and other mixed reality devices may be used in a manner involving vigorous movement of the user's head and/or their entire body (for example during gaming), there may be significant forces/moments tending to disrupt the position of the device on the user's head. Simply forcing the device more tightly against the user's head to tolerate large disruptive forces may not be acceptable as it may be uncomfortable for the user or become uncomfortable after only a short period of time.

In some forms, electrical components may be spaced apart throughout the VR device, instead of entirely in front of the user's face. For example, some electrical components (e.g., the battery) may be disposed on the positioning and stabilizing structure, particularly on a posterior contacting portion. In this way, the weight of the battery (or other electrical components) may create a moment directed in the opposite direction from the moment created by the remainder of the VR device (e.g., the display). Thus, it may be sufficient for the positioning and stabilizing structure to apply a lower clamping force, which in turn creates a lower force against the user's face (e.g., fewer marks on their skin). However, cleaning and/or replacing the positioning and stabilizing structure may be more difficult in some such existing devices because of the electrical connections.

In some forms, spacing the electrical components apart may involve positioning some of the electrical components separate from the rest of the VR device. For example, a battery and/or a processor may be electrically connected, but carried separately from the rest of the VR device. Unlike in the “fixed units” described above, the battery and/or processor may be portable, along with the remainder of the VR device. For example, the battery and/or the processor may be carried on the user's belt or in the user's pocket. This may provide the benefit of reduced weight on the user's head, but would not provide a counteracting moment. The tensile force provided by the positioning and stabilizing structure may still be less than the “brick” configuration, since the total weight supported by the head is less.

### 2.2.2.2 Display Connection

### 2.2.2.2.1 Integrated Display Screen

In some forms, the display screen is an integral piece of the VR device, and generally cannot be detached or removed from the rest of the VR device.

The display screen may be fixed within a housing, and protected from damage. For example, the display screen may be completely covered by the housing, which may reduce the occurrence of scratches. Additionally, integrating display screen with the rest of the VR device eliminates the occurrence of losing the display screen.

In these forms, the display screen functions purely as an immersive technology display. The vast majority of “fixed units” will include an integrated display screen. “Portable units” may include an integrated display screen, or may include a removable display screen (described below).

### 2.2.2.2.2 Removable Display Screen

In some forms, the display screen is a separate structure that can be removed from the VR device, and used separately.

In some forms, a portable electronic device (e.g., a cell phone) may be selectively inserted into a housing of the VR device. The portable electronic device may include most or all of the sensors and/or processors, and may create a virtual environment through a downloadable app.

Portable electronic devices are generally light weight, and may not require the positioning and stabilizing structure to apply a large force to the user's head.

### 2.2.3 Augmented Reality

In some forms, augmented reality (AR) is a computer-generated three-dimensional image or environment that is presented to a user.

While similar to VR, AR differs in that the virtual environment created at least in part by the electronic screen is observed in combination with the user's physical environment. In other words, AR creates virtual objects in order to alter and/or enhance the user's physical environment with elements of a virtual environment. The result of AR is a combined environment that includes physical and virtual objects, and therefore an environment that is both physical and virtual.

For example, images created by the electronic screen may be overlayed into the user's physical environment. Only a portion of an AR combination environment presented to the user includes virtual objects. Thus, the user may wish to continue to receive ambient stimulation from their physical environment while using an AR device (e.g., in order to continue to observe the physical or non-virtual component of the combination environment).

Since AR may be used with the user's physical environment, an AR device may not be electrically connected, or otherwise tethered, to a computer or video game console. Instead the AR device may include a battery, or other power source. This may provide the user with the greatest freedom of movement, so that they can explore a variety of physical environments while using the AR device.

This key difference between VR and AR may lead to different types of wearable electronic screens. As described above, a user of a VR device may wish to block ambient light, so the housing of the electronic screen may be opaque in order to limit or prevent ambient light from reaching the user. However, the user of an AR device may want to see the virtual environment blended with their actual environment. The electronic screen in an AR device may be similarly supported in front of the user's eyes, but, screens in AR devices may be transparent or translucent, and the screens may not be supported by an opaque housing (or opaque material may not substantially obstruct the user's line of sight). This may allow the user to continue receiving ambient stimulation, where the virtual environment is simultaneously present. Notwithstanding, some VR devices that do not have a transparent screen through which the user can see their real world surroundings may be configurable for AR by acquiring real-time video of the user's real-world surroundings from the user's perspective (e.g., with cameras on the display housing) and displaying it on the display screen.

Additionally, a person using an AR device may be more mobile than a person using a VR device (e.g., because an AR user can see their physical environment and/or are not tethered to a computer or video game console). Thus, a person using an AR device may wish to wear the device for an extended period of time, while also moving around (e.g., walking, running, biking, etc.). Including components, like batteries, on the AR device may make the AR device uncomfortable for the user's head and/or neck, and may discourage the user from wearing the AR device for long periods of time.

### 2.2.4 Mixed Reality

Mixed reality (MR) is similar to AR but may be more immersive because the MR device may provide the user more ways to interact with virtual objects or environment than an AR device. The virtual reality in MR may also be overlayed and/or blended with the user's physical environment. Unlike AR however, a user may be able to interact with the virtual environment akin to what occurs in VR. In other words, while AR may present only a computer generated image in the physical environment, MR may present the user with the same or similar computer generated image but allow for interaction with the image in the physical environment (e.g., using a hand to “grab” an object produced virtually). Thus, the virtual environment may further merge with a physical environment so that the combined environment better replicates an actual environment.

### 2.2.5 Head-Mounted Display Interface

A head-mounted display interface enables a user to have an immersive experience of a virtual environment and have broad application in fields such as communications, training, medical and surgical practice, engineering, and video gaming.

Different head-mounted display interfaces can each provide a different level of immersion. For example, some head-mounted display interfaces can provide the user with a total immersive experience. One example of a total immersive experience is virtual reality (VR). The head-mounted display interface can also provide partial immersion consistent with using an AR device.

VR head-mounted display interfaces typically are provided as a system that includes a display unit which is arranged to be held in an operational position in front of a user's face. The display unit typically includes a housing containing a display and a user interface structure constructed and arranged to be in opposing relation with the user's face. The user interface structure may extend about the display and define, in conjunction with the housing, a viewing opening to the display. The user interfacing structure may engage with the face and include a cushion for user comfort and/or be light sealing to block ambient light from the display. The head-mounted display system further comprises a positioning and stabilizing structure that is disposed on the user's head to maintain the display unit in position.

Other head-mounted display interfaces can provide a less than total immersive experience. In other words, the user can experience elements of their physical environment, as well as a virtual environment. Examples of a less than total immersive experience are augmented reality (AR) and mixed reality (MR).

AR and/or MR head-mounted display interfaces are also typically provided as a system that includes a display unit which is arranged to be held in an operational position in front of a user's face. Likewise, the display unit typically includes a housing containing a display and a user interface structure constructed and arranged to be in opposing relation with the user's face. The head-mounted display system of the AR and/or MR head-mounted display is also similar to VR in that it further comprises a positioning and stabilizing structure that is disposed on the user's head to maintain the display unit in position. However, AR and/or MR head-mounted displays do not include a cushion that totally seals ambient light from the display, since these less than total immersive experience require an element of the physical environment. Instead, head-mounted displays in augmented and/or mixed allow the user to see the physical environment in combination with the virtual environment.

In any types of immersive technology, it is important that the head-mounted display interface is comfortable in order to allow the user to wear the head-mounted display for extended periods of time. Additionally, it is important that the display is able to provide changing images with changing position and/or orientation of the user's head in order to create an environment, whether partially or entirely virtual, that is similar to or replicates one that is entirely physical.

### 2.2.5.1 Interfacing Structure

The head-mounted displays may include a user interfacing structure. Since it is in direct contact with the user's face, the shape and configuration of the interfacing portion can have a direct impact on the effectiveness and comfort of the display unit.

The design of a user interfacing structure presents a number of challenges. The face has a complex three-dimensional shape. The size and shape of noses and heads varies considerably between individuals. Since the head includes bone, cartilage and soft tissue, different regions of the face respond differently to mechanical forces.

One type of interfacing structure extends around the periphery of the display unit and is intended to seal against the user's face when force is applied to the user interface with the interfacing structure in confronting engagement with the user's face. The interfacing structure may include a pad made of a polyurethane (PU). With this type of interfacing structure, there may be gaps between the interfacing structure and the face, and additional force may be required to force the display unit against the face in order to achieve the desired contact.

The regions not engaged at all by the user interface may allow gaps to form between the facial interface and the user's face through which undesirable light pollution may ingress into the display unit (e.g., particularly when using virtual reality). The light pollution or “light leak” may decrease the efficacy and enjoyment of the overall immersive experience for the user. In addition, previous systems may be difficult to adjust to enable application for a wide variety of head sizes. Further still, the display unit and associated stabilizing structure may often be relatively heavy and may be difficult to clean which may thus further limit the comfort and useability of the system.

Another type of interfacing structure incorporates a flap seal of thin material positioned about a portion of the periphery of the display unit so as to provide a sealing action against the face of the user. Like the previous style of interfacing structure, if the match between the face and the interfacing structure is not good, additional force may be required to achieve a seal, or light may leak into the display unit in-use. Furthermore, if the shape of the interfacing structure does not match that of the user, it may crease or buckle in-use, giving rise to undesirable light penetration.

A user interface may be partly characterised according to the design intent of where the interfacing structure is to engage with the face in-use. Some interfacing structures may be limited to engaging with regions of the user's face that protrude beyond the arc of curvature of the face engaging surface of the interfacing structure. These regions may typically include the user's forehead and cheek bones. This may result in user discomfort at localised stress points. Other facial regions may not be engaged at all by the interfacing structure or may only be engaged in a negligible manner that may thus be insufficient to increase the translation distance of the clamping pressure. These regions may typically include the sides of the user's face, or the region adjacent and surrounding the users nose. To the extent to which there is a mismatch between the shape of the users' face and the interfacing structure, it is advantageous for the interfacing structure or a related component to be adaptable in order for an appropriate contact or other relationship to form.

### 2.2.5.2 Positioning and Stabilizing

To hold the display unit in its correct operational position, the head-mounted display system further comprises a positioning and stabilizing structure that is disposed on the user's head. These structures may be responsible for providing forces to counter gravitational forces of the head-mounted display and/or interfacing structure. In the past these structures have been formed from expandable rigid structures that are typically applied to the head under tension to maintain the display unit in its operational position. Such systems have been prone to exert a clamping pressure on the user's face which can result in user discomfort at localised stress points. Also, previous systems may be difficult to adjust to allow wide application head sizes. Further, the display unit and associated stabilizing structure are often heavy, difficult to clean which further limit the comfort and useability of the system.

Certain other head mounted display systems may be functionally unsuitable for the present field. For example, positioning and stabilizing structures designed for ornamental and visual aesthetics may not have the structural capabilities to maintain a suitable pressure around the face. For example, an excess of clamping pressure may cause discomfort to the user, or alternatively, insufficient clamping pressure on the users' face may not effectively seal the display from ambient light.

Certain other head mounted display systems may be uncomfortable or impractical for the present technology. For example, if the system is used for prolonged time periods.

As a consequence of these challenges, some head mounted displays suffer from being one or more of obtrusive, aesthetically undesirable, costly, poorly fitting, difficult to use, and uncomfortable especially when worn for long periods of time or when a user is unfamiliar with a system. Wrongly sized positioning and stabilizing structures can give rise reduced comfort and in turn, shortened periods of use.

Therefore, an interfacing portion of a user interface used for the fully immersive experience of a virtual environment are subject to forces corresponding to the movement of a user during the experience.

### 2.2.5.3 Materials

Materials used in head mounted display assemblies have included dense foams for contacting portions in the interfacing structures, rigid shells for the housings, and positioning and stabilizing structures formed from rigid plastic clamping structures. These materials have various drawbacks including not permitting the skin covered by the material to breath, being inflexible, difficult to clean and to prone trapping bacteria. As a result, products made with such material may be uncomfortable to wear for extended periods of time, causes skin irritation in some individuals and limit the application of the products.

### 3 BRIEF SUMMARY OF THE TECHNOLOGY

The present technology may be directed toward providing positioning and stabilizing structures used in the supporting, stabilizing, mounting, utilizing, and/or securing of a head-mounted display having one or more of improved comfort, cost, efficacy, ease of use and manufacturability.

A first aspect of the present technology relates to apparatuses used in the supporting, stabilizing, mounting, utilizing, and/or securing of a head-mounted display.

Another aspect of the present technology relates to methods used in the supporting, stabilizing, mounting, utilizing, and/or securing of a head-mounted display.

Another aspect is a positioning and stabilizing structure for a head-mounted display that comprising a rear (or posterior) support structure (or portion) arranged, in use, to contact a posterior region of the user's head.

In some forms, the posterior support portion or at least a portion thereof is disposed posterior of the otobasion superior of the user.

In some forms, the posterior support portion is biased into contact with the occipital region of the user.

In some forms, the positioning and stabilizing structure further comprises opposing connectors that are disposed on opposing sides of, and extending along the temporal regions of, the user's head to interconnect the posterior support portion to the head-mounted display unit. In some forms the positioning and stabilising structure comprises an anterior support portion connecting the posterior support portion to the head-mounted display unit.

The present technology may also be directed toward providing interfacing structures used in the supporting, cushioning, stabilizing, positioning, and/or sealing a head-mounted display in opposing relation with the user's face.

Another aspect relates to apparatuses used in the supporting, cushioning, stabilizing, positioning, and/or sealing a head-mounted display in opposing relation with the user's face.

Another aspect relates to methods used in supporting, cushioning, stabilizing, positioning, and/or sealing a head-mounted display in opposing relation with the user's face.

Another aspect of the present technology relates to a head-mounted display system including a head-mounted display unit comprising: 1) a display unit housing comprising a display; and 2) an interfacing structure connected to the display unit housing and constructed and arranged to engage the user's face in use. The head-mounted display system further comprises a positioning and stabilising structure constructed and arranged to hold the head-mounted display unit in an operable position on the user's head in use, the positioning and stabilising structure comprising: 1) a pair of arms connected in use to respective lateral sides of the display unit housing, the arms being constructed and arranged to project posteriorly from the display unit housing on respective lateral sides of the user's head in use, a posterior portion of each arm comprising a superior arm connection portion and an inferior arm connection portion; 2) a top strap portion constructed and arranged to connect between each of the superior arm connection portions of the pair of arms, the top strap portion being configured to engage the user's head at regions of the head superior to positions of the pair of arms during use; and 3) an occipital strap portion constructed and arranged to connect between the inferior arm connection portions and engage a portion of the user's head overlying or lying inferior to an occipital region of the user's head in use.

In an example, when the head-mounted display system is worn, a portion of each arm posterior of the head-mounted display unit has increased rigidity as compared to the top strap portion.

In further examples: a) the arms are pivotably attached to the display unit housing; b) each arm is at least partially covered by a textile sleeve; c) the top strap portion connects to the head-mounted display unit in addition to each of the superior arm connection portions of the pair of arms; d) the top strap portion connects to the head-mounted display unit at a single location; e) the top strap portion is substantially Y-shaped, the top strap portion having an anterior leg connected to the head-mounted display unit and a pair of posterior legs connected to the superior arm connection portions of the pair of arms; f) at least one portion of the top strap portion is selectively adjustable in length; g) the top strap portion is configured to pass through an eyelet on the head-mounted display unit, and loop back to be secured to itself; h) the top strap portion is configured to be secured to itself with a hook-and-loop connection; i) the occipital strap portion comprises an occipital strap connector at one end of the occipital strap portion constructed and arranged to releaseably attach to a corresponding one of the inferior arm connection portions of the arms; j) the occipital strap connector is constructed and arranged to magnetically attach to the corresponding one of the inferior arm connection portions; k) the occipital strap portion is selectively adjustable in length; 1) the occipital strap portion is configured to pass through an eyelet on the occipital strap connector, looped back and be secured to itself; and/or m) the occipital strap portion is configured to be secured to itself with a hook-and-loop connection.

In further examples: n) one or both of the arms are formed in two parts releasably connected to each other; o) the two parts of each arm are moveably connected to each other to provide for size adjustment of the positioning and stabilising structure; p) one or both of the arms are releasably connected to the head-mounted display unit; q) one or both of the inferior arm connection portions are moveable relative to a remainder of the respective arm; r) the superior arm connection portion and the inferior arm connection portion of each arm are positioned posterior to the otobasion superior of the user's head in use; s) in use, each arm is structured to resist bending towards the superior and inferior directions; t) in use, each arm is structured to allow bending towards a medial direction to engage partially posterior-facing surfaces of the user's head; u) in use, when the top strap portion is in tension, the superior arm connection portions are urged towards the surface of the user's head; v) when the head-mounted display system is worn, the occipital strap portion is configured to urge the inferior arm connection portions towards the surface of the user's head when the occipital strap portion is tightened; w) each arm comprises one or more hinges to facilitate bending of the respective arm to conform to the shape of the user's head, when the head-mounted display system is worn; x) the inferior arm connection portions are configured to be positioned superior to the otobasion superior of the user's head in use; y) when the head-mounted display system is worn, each arm projects posteriorly and curves medially at a posterior portion of the user's head; and/or z) when the head-mounted display system is worn, each arm projects posteriorly and curves towards a superior direction away from the display unit housing.

Another aspect of the present technology relates to a positioning and stabilising structure for holding a head-mounted display unit in an operative position on a user's head, the positioning and stabilising structure comprising: a) a ring strap portion forming a ring shape including an occipital strap portion being constructed and arranged to engage a region of the user's head overlying the occipital bone or overlying the parietal bones proximate the occipital bone; and b) a pair of lateral strap portions configured to extend along respective sides of the user's head in use, each lateral strap portion having 1) a posterior end portion connected to a respective side of the ring strap portion at a connection location, and 2) an anterior end portion adapted to connect to a respective lateral side of a head-mounted display unit.

In an example, when the positioning and stabilising structure is worn in use, each connection location is positioned superior to the anterior end portion of the respective lateral strap portion.

In further examples: a) wherein each of the lateral strap portions extends at least partially superiorly in a direction from the anterior end portion to the posterior end portion; b) the ring strap portion is structured to substantially hold an in-use shape when the positioning and stabilising structure is not donned by the user; c) the positioning and stabilising structure is configured to resist angular change between the superior transverse strap portion and the occipital strap portion when the lateral strap portions are tensioned in use; d) a width of the occipital strap portion measured transversely to a length of the occipital strap portion is greater than a width of the superior transverse strap portion measured transversely to a length of the superior transverse strap portion; e) a thickness of the ring strap portion is greater than a thickness of the lateral strap portions; f) the thickness of the ring strap portion is greater than a thickness of the top strap portion; g) the ring strap portion comprises a plurality of segments formed separately and joined together to form the ring strap portion; h) the segments comprise a superior segment, a pair of lateral segments and an inferior segment; i) the ring strap portion comprises at least a pair of hinges, each hinge being located proximate one of the connection locations between the ring strap portion and a respective one of the lateral strap portions; j) each of the lateral strap portions is selectively adjustable in length; k) each of the lateral strap portions is configured to be secured to itself to form a loop that is adapted to connect to the head-mounted display unit; and/or 1) each of the lateral strap portions is configured to be secured to itself with a hook-and-loop connection.

In further examples: m) the occipital strap portion is constructed and arranged to be positioned at or proximate the Frankfort Horizontal plane of the user's head in use; n) the positioning and stabilising structure further comprises a top strap portion connected to the superior transverse strap portion or the occipital strap portion and configured to extend anteriorly therefrom, in use, over a portion of the user's head overlying the user's frontal bone, the top strap portion being adapted to connect to the head-mounted display unit; o) the ring strap portion has a rigidity at a location along its length that is different than the rigidity at a location along a length of each lateral strap portion; p) the top strap portion is selectively adjustable in length; q) the top strap portion is configured to be secured to itself to form a loop that is adapted to connect to the head-mounted display unit; r) the top strap portion is configured to be secured to itself with a hook-and-loop connection; s) the ring strap portion is wider in the superior transverse strap portion at a location intersecting the sagittal plane of the user's head in use than at other locations around the ring strap portion; t) the superior transverse strap portion comprises a greater width at the location intersecting the sagittal plane than at lateral portions of the superior transverse strap portion; u) the superior transverse strap portion comprises an anterior edge and a posterior edge, the anterior edge being more curved than the posterior edge to form the greater width; v) the anterior edge curves anteriorly in lateral to medial directions and the posterior edge is substantially not curved anteriorly or posteriorly; w) the ring strap portion has increased rigidity in areas directly adjacent the connection locations as compared to a rigidity in at least one other area of the ring strap portion; and/or x) the ring strap portion further includes a superior transverse strap portion constructed and arranged to engage a superior region of the user's head at or proximate a coronal plane.

Another aspect of the present technology relates to a head-mounted display system including a head-mounted display unit comprising: 1) a display unit housing comprising a display; and 2) an interfacing structure connected to the display unit housing and constructed and arranged to engage the user's face in use. The head-mounted display further comprises a positioning and stabilising structure constructed and arranged to hold the head-mounted display unit in an operable position on the user's head in use, the positioning and stabilising structure comprising: a band strap portion constructed and arranged to encircle the user's head in use, engage a region of the user's head overlying the frontal bone and form an occipital strap portion constructed and arranged to engage a region of the user's head overlying or lying inferior to the occipital bone, wherein the head-mounted display unit is pivotably attached to the band strap portion at a pair of pivot connections arranged to be positioned on respective sides on the user's head, in use, to enable the head-mounted display unit to pivot relative to the band strap portion about an axis aligned perpendicular to the sagittal plane of the user's head so as to allow movement of the display in superior and inferior directions during use.

In examples: a) the pivot connections are located proximate the mid-coronal plane of the user's head in use; b) the band strap portion comprises a pair of slots, the pivot connections being located within the slots, and the slots allowing the pivot connections to move with respect to the band strap portion along the length of the slots; c) the pivot connections enable the head-mounted display unit to move at least partially anteriorly during pivoting; d) the head-mounted display unit is configured to pivot between a viewing position in which the head-mounted display unit is positioned over the user's eyes and a non-viewing position in which the head-mounted display unit is positioned overlying the user's frontal bone; e) the slots are configured to cause the pivot connections to move at least partially anteriorly when the head-mounted display is pivoted from the viewing position to the non-viewing position; f) the positioning and stabilising structure comprises a parietal strap portion configured to engage the user's head at a region overlying the parietal bones of the user's head in use; g) the parietal strap portion is connected to the band strap portion; h) the parietal strap portion is connected to the band strap portion at locations spaced anteriorly from the pivot connections, when the head-mounted display system is worn; and/or i) the parietal strap portion comprises a pair of elastically extendable lateral portions proximate the band strap portion and a posterior portion that is less extendable than the elastically extendable lateral portions.

In further examples: j) the head-mounted display system further comprises a battery pack for powering the head-mounted display system; k) the battery pack is attached to the occipital strap portion; l) the band strap portion is adjustable in length; m) the band strap portion comprises a dial adjustment mechanism comprising a rotatable dial, the dial adjustment mechanism being configured to cause a change in length of the band strap portion when the dial is rotated; n) the dial adjustment mechanism is provided in the occipital strap portion of the band strap portion; o) the dial is positioned in the sagittal plane of the user's head in use; p) wherein the head-mounted display system comprises a pair of battery packs mounted to the occipital strap portion, each of the battery packs being located on a respective lateral side of the dial; q) the band strap portion comprises an outer layer formed from a textile material; r) the band strap portion comprises a rigidiser; s) the band strap portion comprises a textile sleeve, the rigidiser being inside the textile sleeve; t) the positioning and stabilising structure comprises a forehead pad attached to the band strap portion and configured to engage the user's forehead; and/or u) the forehead pad comprises a textile material.

Another aspect of the present technology relates to a positioning and stabilising structure for holding a head-mounted display unit in an operative position on a user's head, the positioning and stabilising structure comprising: 1) a pair of lateral strap portions adapted to connect to respective lateral sides of a head-mounted display unit, the lateral strap portions being connected to each other posterior to the user's head when the positioning and stabilising structure is worn, to form a band strap portion partially encircling the user's head; 2) an adjustment mechanism disposed between the lateral strap portions to connect the lateral strap portions at a posterior region of the user's head, the adjustment mechanism being configured to adjust a length of both lateral strap portions simultaneously and equally to thereby adjust a length of the band strap portion; and 3) an occipital strap portion constructed and arranged to engage a region of the user's head overlying the occipital bone.

In examples: a) the occipital strap portion is connected to the band strap portion; b) the adjustment mechanism is constructed and arranged to allow the user to selectively adjust the length of the band strap portion when the positioning and stabilising structure is worn by the user; c) the adjustment mechanism comprises a dial adjustment mechanism comprising a dial which when turned adjusts the length of the band strap portion; d) the dial is positioned in the sagittal plane of the user's head in use; e) the band strap portion is configured to engage a region of the user's head overlying the parietal bones in use; f) the band strap portion includes a rigidiser that imparts rigidity to the band strap portion at least at the region of the user's head overlying the parietal bones; g) the entire band strap portion includes a rigidiser that imparts rigidity to the band strap portion; h) when the positioning and stabilising structure is worn, the lateral strap portions are configured to each lie in use on a path extending posteriorly and partially superiorly away from the head-mounted display unit towards a posterior region of the user's head; and/or i) the occipital strap portion is semi-rigid.

In further examples: j) the occipital strap portion comprises a textile sleeve and at least one rigidiser within the textile sleeve; k) the textile sleeve is elastically extendable in length to allow for size adjustment of the occipital strap portion; l) the textile sleeve is a knitted tube; m) the occipital strap portion comprises a pair of rigidisers, each rigidiser comprising a posterior end, the posterior ends of the rigidisers being spaced laterally apart from each other proximate a posterior surface of the user's head when the positioning and stabilising structure is worn; n) the positioning and stabilising structure is worn, each rigidiser extends posteriorly and curves medially to follow curvature of the posterior surface of the user's head; o) when the positioning and stabilising structure is worn, each rigidiser extends posteriorly and curves inferiorly and medially to follow curvature of the posterior surface of the user's head; p) the textile sleeve is constrained by the rigidisers to lie on a curved path defined by curvature in each rigidiser, the textile sleeve being configured to stretch over and along the ridigisers to elastically extend in length; q) the positioning and stabilising structure further comprises a top strap portion connected to the band strap portion and adapted to attach to the head-mounted display unit; r) the top strap portion is aligned with the sagittal plane of the user's head; s) the top strap portion is configured to be secured to itself to form a loop that is adapted to connect to the head-mounted display unit; and/or t) the top strap portion is constructed and arranged to be secured to itself with a hook-and-loop connection.

Another aspect of the present technology relates to a positioning and stabilising structure for holding a head-mounted display unit in an operative position on a user's head, the positioning and stabilising structure comprising: 1) a superior transverse strap portion constructed and arranged to engage a superior portion of the user's head and extend from one lateral side of the user's head to the other lateral side, in use; 2) an occipital strap portion constructed and arranged to engage a region of the user's head overlying the occipital bone in use; 3) a pair of junctions where the superior transverse strap portion and the occipital strap portion join, the junctions being configured to respectively engage the lateral sides of the user's head, in use; and 4) a pair of lateral strap portions configured to respectively extend along the lateral sides of the user's head in use, each lateral strap portion having an anterior portion adapted to connect to the head-mounted display unit and a posterior portion connected to a respective junction of the superior transverse strap portion and the occipital strap portion.

In an example, each lateral strap portion includes a rigidiser that imparts rigidity to the lateral strap portion.

In further examples: a) the superior transverse strap portion is in use substantially aligned with a coronal plane of the user's head aligned with each otobasion superior of the user's head; b) in use, the superior transverse strap portion is wider at the sagittal plane of the user's head than proximate the junctions with the occipital strap portion; c) the lateral strap portions and the superior transverse strap portion are integrally formed; d) portions of the superior transverse strap portion proximate respective lateral strap portions include a rigidiser that imparts rigidity to the superior transverse strap portion; e) the superior transverse strap portion includes a rigidiser that imparts rigidity to the superior transverse strap portion along its entire length; f) the positioning and stabilising structure comprises a single rigidiser extending from one lateral strap portion through the superior transverse strap portion and into the other lateral strap portion; g) portions of the occipital strap portion proximate respective lateral strap portions include a rigidiser that imparts rigidity to the occipital strap portion; h) the single rigidiser comprises posteriorly projecting portions extending into respective ends of the occipital strap portion; i) the occipital strap portion comprises an occipital strap connector at one end of the occipital strap portion constructed and arranged to releaseably attach to an occipital strap connection portion at or proximate one of the junctions of the occipital strap portion and the superior transverse strap portion; j) the occipital strap connector is constructed and arranged to magnetically attach to the occipital strap connection portion; k) the occipital strap portion is selectively adjustable in length; 1) the occipital strap portion is configured to pass through an eyelet on the occipital strap connector, looped back and be secured to itself; and/or m) the occipital strap portion is configured to be secured to itself with a hook-and-loop connection.

In further examples: n) each of the lateral strap portions comprises a superior transverse strap connection portion connected to the superior transverse strap portion and an occipital strap connection portion connected to the occipital strap portion; o) each of the superior transverse strap portion and the occipital strap portion are selectively adjustable in length simultaneously; p) each of the lateral strap portions is selectively adjustable in length; q) each of the lateral strap portions is configured to be secured to itself to form a loop that is adapted to connect to the head-mounted display unit; r) each of the lateral strap portions is configured to be secured to itself with a hook-and-loop connection; s) the positioning and stabilising structure further comprises a top strap portion connected to the superior transverse strap portion and being adapted to connect to the head-mounted display unit; t) the top strap portion is selectively adjustable in length; u) the top strap portion is adapted to connect to the head-mounted display unit at a single location; v) the top strap portion is constructed and arranged to be secured to itself to form a loop that is adapted to connect to the head-mounted display unit; and/or w) the top strap portion is constructed and arranged to be secured to itself with a hook-and-loop connection.

Another aspect of the present technology relates to a head-mounted display system including a head-mounted display unit comprising: 1) a display unit housing comprising a display; 2) an interfacing structure connected to the display unit housing and constructed and arranged to engage the user's face in use; and 3) the positioning and stabilising structure of any one of the above aspects.

In examples: a) the head-mounted display unit comprises a pair of arms extending posteriorly from respective lateral sides of the display unit housing, the lateral strap portions each being configured to attach to a respective one of the arms; b) the arms are pivotably attached to the head-mounted display unit (e.g., the display unit housing); c) the lateral strap portions are constructed and arranged to be attached to the interfacing structure of the head-mounted display unit; d) the lateral strap portions are constructed and arranged to be attached to the display unit housing of the head-mounted display unit; e) the head-mounted display unit comprises a pair of side shields extending posteriorly from respective lateral sides of the head-mounted display unit past lateral portions of the interfacing structure; f) in use, each of the side shields extends posteriorly to a position proximate a respective otobasion superior of the user's head; g) the occipital strap portion is constructed and arranged to be attached to the side shields; h) the occipital strap portion is attached to the band strap portion proximate the head-mounted display unit; and/or i) the occipital strap portion is connected to the head-mounted display unit.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
   a pair of arms connected in use to respective lateral sides of the display unit housing, the arms being semi-rigid and being constructed and arranged to project posteriorly from the display unit housing on respective lateral sides of the user's head in use, a posterior portion of each arm comprising a superior arm connection portion and an inferior arm connection portion;
   a top strap portion constructed and arranged to connect between each of the superior arm connection portions of the pair of arms;
   an occipital strap portion constructed and arranged to connect between the inferior arm connection portions and engage a portion of the user's head overlying or lying inferior to an occipital region of the user's head in use.

In examples:
the arms are pivotably attached to the display unit housing;
each arm is at least partially covered by a textile sleeve;
the top strap portion connects to the head-mounted display unit in addition to each of the superior arm connection portions of the pair of arms;
the top strap portion connects to the head-mounted display unit at a single location;
the top strap portion is substantially Y-shaped;
at least one portion of the top strap portion is selectively adjustable in length;
the top strap portion passes through an eyelet on the head-mounted display unit, is looped back and is secured to itself;
the top strap portion is secured to itself with a hook-and-loop connection;
the occipital strap portion comprises an occipital strap connector at one end of the occipital strap portion constructed and arranged to releaseably attach to a corresponding one of the inferior connection portions of the arms;
the occipital strap connector is constructed and arranged to magnetically attach to the corresponding one of the inferior connection portions;
the occipital strap portion is selectively adjustable in length;
the occipital strap portion passes through an eyelet on the occipital strap connector, is looped back and is secured to itself;
the occipital strap portion is secured to itself with a hook-and-loop connection;
one or both of the arms are formed in two parts releasably connected to each other;
the two parts of each arm are moveably connected to each other to provide for size adjustment of the positioning and stabilising structure;
one or both of the arms are releasably connected to the head-mounted display unit;
one or both of the inferior connection portions are moveable relative to a remainder of the respective arm;
the superior connection portion and the inferior connection portion of each arm are positioned posterior to the otobasion superior of the user's head in use;
each arm is structured to resist bending towards the superior and anterior directions;
each arm is structured to allow for bending towards a medial direction to engage partially posterior-facing surfaces of the user's head;
when the top strap portion is in tension, the superior connection portions are urged towards the surface of the user's head;
when the occipital strap portion is tightened, the inferior connection portions are urged towards the surface of the user's head;
each arm comprises one or more hinges to facilitate bending of the respective arm to conform to the shape of the user's head;
the inferior connection portions are positioned superior to the otobasion superior of the user's head in use;
each arm projects posteriorly and curves medially at the posterior of the user's head; and/or
each arm projects posteriorly and curves towards a superior direction away from the display unit housing.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
   a ring strap portion forming a superior transverse strap portion constructed and arranged to engage a superior region of the user's head at or proximate a coronal plane aligned with each otobasion superior of the user's head, the ring strap portion further forming an occipital strap portion being constructed and arranged to engage a region of the user's head overlying the occipital bone or overlying the parietal bones proximate the occipital bone;
   a pair of lateral strap portions connected to the ring strap portion and being constructed and arranged to connect to respective lateral sides of the head-mounted display unit;
   wherein the head-mounted display unit comprises a weight, and the ring strap portion supports at least a majority of the weight via the lateral strap portions.

Another aspect of the present technology relates to a positioning and stabilising structure for a head-mounted display system, the head-mounted display system comprising a head-mounted display unit comprising a display unit housing comprising a display, the head-mounted display unit further comprising an interfacing structure connected to the display unit housing and being constructed and arranged to engage the user's face in use, the positioning and stabilising structure being constructed and arranged to hold the head-mounted display unit in an operable position on the user's head in use, the positioning and stabilising structure comprising:
a ring strap portion forming a superior transverse strap portion constructed and arranged to engage a superior region of the user's head at or proximate a coronal plane aligned with each otobasion superior of the user's head, the ring strap portion further forming an occipital strap portion being constructed and arranged to engage a region of the user's head overlying the occipital bone or overlying the parietal bones proximate the occipital bone;
a pair of lateral strap portions connected to the ring strap portion and being constructed and arranged to connect to respective lateral sides of the head-mounted display unit;
wherein the head-mounted display unit comprises a weight, and the ring strap portion supports at least a majority of the weight via the lateral strap portions.

In examples:
each of the lateral strap portions extends at least partially superiorly away from its respective connection to the head-mounted display unit;
the ring strap portion is structured to substantially hold an in-use shape when the head-mounted display system is not donned by a user;
the positioning and stabilising structure is configured to resist angular change between the superior transverse strap portion and the occipital strap portion when the lateral strap portions are tensioned;
a width of the occipital strap portion measured transversely to a length of the occipital strap portion is greater than a width of the superior transverse strap portion measured transversely to a length of the superior transverse strap portion;
a thickness of the ring strap portion is greater than a thickness of the lateral strap portions;
the thickness of the ring strap portion is greater than a thickness of the top strap portion;
the ring strap portion comprises a plurality of segments formed separately and joined together to form the ring strap portion;
the segments comprise a superior segment, a pair of lateral segments and an inferior segment;
the ring strap portion comprises at least a pair of hinges, each of the pair of hinges being located proximate a respective junction between the ring strap portion and a respective one of the lateral strap portions;
each of the lateral strap portions is selectively adjustable in length;
each of the lateral strap portions passes through a respective eyelet on the head-mounted display unit, is looped back and is secured to itself;
each of the lateral strap portions is secured to itself with a hook-and-loop connection;
the head-mounted display unit comprises a pair of arms extending posteriorly from respective lateral sides of the display unit housing, the lateral strap portions each being attached to a respective one of the arms;
the arms are pivotably attached to the display unit housing;
the lateral strap portions connect to the ring strap portion at respective locations which are spaced superiorly from the arms;
the occipital strap portion is constructed and arranged to be positioned at or proximate the Frankfort Horizontal plane of the user's head in use;
the positioning and stabilising structure further comprises a top strap portion connected to the superior transverse strap portion or the occipital strap portion and being constructed and arranged to connect to the head-mounted display unit;
the top strap portion connects to the head-mounted display unit at a single location;
the top strap portion is selectively adjustable in length;
the top strap portion passes through an eyelet on the head-mounted display unit, is looped back and is secured to itself;
the top strap portion is secured to itself with a hook-and-loop connection;
the ring strap portion is wider in the superior transverse strap portion at a location intersecting the sagittal plane of the user's head in use than at other locations around the ring strap portion;
the superior transverse strap portion comprises a greater width at the location intersecting the sagittal plane than at lateral portions of the superior transverse strap portion;
the superior transverse strap portion comprises an anterior edge and a posterior edge, the anterior edge being more curved than the posterior edge to form the greater width; and/or
the anterior edge curves anteriorly in lateral to medial directions and the posterior edge is substantially not curved anteriorly or posteriorly.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a band strap portion constructed and arranged to encircle the user's head in use and engage a region of the user's head overlying the frontal bone and engage a region of the user's head overlying or lying inferior to the occipital bone;
an adjustment mechanism constructed and arranged to allow the user to selectively adjust the length of the band strap portion; and
a pair of lateral strap portions connected to the band strap portion at respective lateral sides of the user's head in use and being constructed and arranged to connect to respective lateral sides of the head-mounted display unit.

In examples:
the adjustment mechanism comprises a dial adjustment mechanism comprising a dial which when turned adjusts the length of the band strap portion;
the dial is provided to the band strap portion in the region of the user's head overlying or lying inferior to the occipital bone;
the dial is aligned with the sagittal plane of the user's head in use;
the band strap portion is at least partially rigidised at the region of the user's head overlying or lying inferior to the occipital bone;
the entire band strap portion is at least partially rigidised;
the positioning and stabilising structure further comprises a top strap portion connected to the band strap portion proximate the user's forehead and constructed and arranged to connect to the head-mounted display unit;
the top strap portion is selectively adjustable in length;
the top strap portion passes through an eyelet on the head-mounted display unit, is looped back and secured to itself;
the top strap portion is secured to itself with a hook-and-loop connection;
the positioning and stabilising structure comprises a forehead pad attached to the band strap portion and is constructed and arranged to engage the user's forehead;
the head-mounted display unit comprises a pair of arms provided to respective lateral sides of the head-mounted display unit, and the lateral strap portions are attached to the arms;
the arms are pivotably attached to the head-mounted display unit;
each of the lateral strap portions is selectively adjustable in length;
each of the lateral strap portions passes through a respective eyelet provided to a respective arm, is looped back and is secured to itself;
each of the lateral strap portions is secured to itself with a hook-and-loop connection;
the positioning and stabilising structure further comprises a parietal strap portion constructed and arranged to engage a region of the user's head overlying the parietal bones;
the parietal strap portion is connected to the band strap portion proximate the lateral strap portions; and/or
the parietal strap portion is elastically extendable.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
   a band strap portion constructed and arranged to encircle the user's head in use, engage a region of the user's head overlying the frontal bone and form an occipital strap portion constructed and arranged to engage a region of the user's head overlying or lying inferior to the occipital bone;
   wherein the head-mounted display unit is pivotably attached to the band strap portion at a pair of pivot connections to enable the head-mounted display unit to pivot about an axis aligned perpendicular to the sagittal plane of the user's head in use.

In examples:
the pivot connections are located proximate the mid-coronal plane of the user's head in use;
the band strap portion comprises a pair of slots, the pivot connections being located within the slots, and the slots allowing the pivot connections to move with respect to the band strap portion along the length of the slots;
the pivot connections enable the head-mounted display unit to move at least partially anteriorly during pivoting;
the head-mounted display unit is configured to pivot between a viewing position in which the head-mounted display unit is positioned over the user's eyes and a non-viewing position in which the head-mounted display unit is positioned overlying the user's frontal bone;
during pivoting of the head-mounted display unit from the viewing position to the non-viewing position, the pivot connections move at least partially anteriorly within the slots;
the positioning and stabilising structure comprises a parietal strap portion configured to engage the user's head at a region overlying the parietal bones of the user's head in use;
the parietal strap portion is connected to the band strap portion;
the parietal strap portion is connected to the band strap portion at locations spaced anteriorly from the pivot connections;
the parietal strap portion comprises a pair of elastically extendable lateral portions proximate the band strap portion and a posterior portion being less extendable than the elastically extendable lateral portions;
the head-mounted display system further comprises a battery pack for powering the head-mounted display system;
the battery pack is attached to the occipital strap portion;
the band strap portion is adjustable in length;
the band strap portion comprises a dial adjustment mechanism comprising a rotatable dial, the dial adjustment mechanism being configured to cause a change in length of the band strap portion when the dial is rotated;
the dial adjustment mechanism is provided in the occipital strap portion of the band strap portion;
the dial is positioned in the sagittal plane of the user's head in use;
the head-mounted display system comprises a pair of battery packs mounted to the occipital strap portion, each one of the pair of battery packs located on a respective lateral side of the dial;
the band strap portion comprises an outer layer formed from a textile material;
the band strap portion comprises a rigidiser;
the band strap portion comprises a textile sleeve, the rigidiser being inside the textile sleeve;
the positioning and stabilising structure comprises a forehead pad attached to the band strap portion and configured to engage the user's forehead;
the forehead pad comprises a textile material;
the interfacing structure comprises a foam laminate material;
the foam laminate material is thermoformed;
the interfacing structure comprises a nose ridge support portion configured to engage the user's nose ridge in use;
the interfacing structure comprises a breathable textile surface;
the interfacing structure comprises a 3D textile;
the interfacing structure is formed from silicone and foam; and/or
the interfacing structure is formed from silicone.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a pair of lateral strap portions constructed and arranged to connect to respective lateral sides of the head-mounted display unit and being connected to each other posterior to the user's head to form a band strap portion partially encircling the user's head in use; and
an occipital strap portion connected to the band strap portion or the head-mounted display unit and being constructed and arranged to engage a region of the user's head overlying the occipital bone.

Another aspect of the present technology relates to a positioning and stabilising structure for a head-mounted display system, the head-mounted display system comprising a head-mounted display unit comprising a display unit housing comprising a display, the head-mounted display unit further comprising an interfacing structure connected to the display unit housing and being constructed and arranged to engage the user's face in use, the positioning and stabilising structure being constructed and arranged to hold the head-mounted display unit in an operable position on the user's head in use, the positioning and stabilising structure comprising:
a pair of lateral strap portions constructed and arranged to connect to respective lateral sides of the head-mounted display unit and being connected to each other posterior to the user's head to form a band strap portion partially encircling the user's head in use; and
an occipital strap portion connected to the band strap portion or configured to connect to the head-mounted display unit and being constructed and arranged to engage a region of the user's head overlying the occipital bone.

In examples:
the positioning and stabilising structure further comprises an adjustment mechanism constructed and arranged to allow the user to selectively adjust the length of the band strap portion;
the adjustment mechanism comprises a dial adjustment mechanism comprising a dial which when turned adjusts the length of the band strap portion;
the dial is positioned in the sagittal plane of the user's head in use;
the band strap portion engages a region of the user's head overlying the parietal bones in use;
the band strap portion is at least partially rigidised at the region of the user's head overlying the parietal bones;
the entire band strap portion is at least partially rigidised;
the lateral strap portions each lie in use on a path extending posteriorly and partially superiorly away from the head-mounted display unit towards the posterior region of the user's head;
the lateral strap portions are constructed and arranged to attach to a pair of arms provided to respective lateral sides of the head-mounted display unit;
the arms are constructed and arranged to be pivotably attached to the head-mounted display unit;
the lateral strap portions are constructed and arranged to be attached to the interfacing structure of the head-mounted display unit;
the lateral strap portions are constructed and arranged to be attached to the display unit housing of the head-mounted display unit;
the head-mounted display unit comprises a pair of side shields extending posteriorly from respective lateral sides of the head-mounted display unit past lateral portions of the interfacing structure;
each of the side shields extends posteriorly to a position proximate a respective otobasion superior of the user's head;
the occipital strap portion is constructed and arranged to be attached to the side shields;
the occipital strap portion is attached to the band strap portion;
the occipital strap portion is attached to the band strap portion proximate the head-mounted display unit;
the occipital strap portion is semi-rigid;
the occipital strap portion comprises a textile sleeve and at least one rigidiser within the textile sleeve;
the textile sleeve is elastically extendable in length to allow for size adjustment of the occipital strap portion;
the textile sleeve may comprise a knitted tube;
the occipital strap portion comprises a pair of rigidisers, each constructed and arranged to be connected to and extend posteriorly away from the head-mounted display unit, each rigidiser comprising a posterior end, the posterior ends of the rigidisers being spaced laterally apart from each other proximate a posterior surface of the user's head;
each rigidiser extends posteriorly and curves medially to follow curvature of the posterior surface of the user's head;
each rigidiser extends posteriorly and curves inferiorly and medially to follow curvature of the posterior surface of the user's head;
the textile sleeve is constrained by the rigidisers to lie on a curved path defined by curvature in each rigidiser, the textile sleeve able to stretch over and along the ridigisers to elastically extend in length;
the positioning and stabilising structure further comprises a top strap portion constructed and arranged to be connected between the band strap portion and the head-mounted display unit;
the top strap portion is aligned with the sagittal plane of the user's head;
the top strap portion is constructed and arranged to pass through an eyelet on the head-mounted display unit, loop back and be secured to itself; and/or
the top strap portion is constructed and arranged to be secured to itself with a hook-and-loop connection.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a pair of lateral strap portions constructed and arranged to connect to respective lateral sides of the head-mounted display unit and being connected to each other at a posterior location of the user's head to form a first band portion partially encircling the user's head;
a second band portion encircling the user's head, the second band portion connected to the first band portion at the posterior region and being constructed and arranged to engage the user's head at the posterior region and at a forehead region of the user's head.

In examples:
the positioning and stabilising structure comprises an adjustment mechanism constructed and arranged to allow the user to selectively adjust the length of the first band portion and the length of the second band portion simultaneously;
the adjustment mechanism comprises a dial adjustment mechanism comprising a dial which when turned adjusts the length of the first band portion and the second band portion;
the dial is positioned in the sagittal plane of the user's head in use;
the positioning and stabilising structure comprises a first adjustment mechanism constructed and arranged to allow the user to selectively adjust the length of the first band portion;
the first adjustment mechanism comprises a first dial adjustment mechanism comprising a first dial which when turned adjusts the length of the first band portion;
the positioning and stabilising structure comprises a second adjustment mechanism constructed and arranged to allow the user to selectively adjust the length of the second band portion;
the second adjustment mechanism comprises a second dial adjustment mechanism comprising a second dial which when turned adjusts the length of the second band portion;
the lateral strap portions lie in use on a path extending posteriorly and partially inferiorly away from the head-mounted display unit towards the posterior location of the user's head;
the head-mounted display unit comprises a pair of arms provided to respective lateral sides of the head-mounted display unit, and the lateral strap portions are constructed and arranged to attach to the arms;
the arms are pivotably attached to the head-mounted display unit;
the positioning and stabilising structure further comprises a top strap portion connecting between the second band portion and the head-mounted display unit;
the top strap portion is aligned with the sagittal plane of the user's head;
the top strap portion passes through an eyelet on the head-mounted display unit, is looped back and is secured to itself; and/or
the top strap portion is secured to itself with a hook-and-loop connection.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a first band portion constructed and arranged to connect to respective lateral sides of the head-mounted display unit, partially encircle the user's head and engage a posterior region of the user's head;
a second band portion constructed and arranged to encircle a portion of the user's head and engage the posterior region of the user's head and a superior region of the user's head at or proximate a coronal plane aligned with each otobasion superior of the user's head;
wherein the first band portion is formed by lateral strap portions which are in use connected to respective lateral sides of the head-mounted display unit and positioned on respective lateral sides of the user's head, and the first band portion is further formed by a posterior strap portion connected to the lateral strap portions and being constructed and arranged to engage the posterior region of the user's head in use;
wherein the second band portion is formed by the posterior strap portion and a superior transverse strap portion connected to the posterior strap portion and constructed and arranged to engage the user's head at or proximate the coronal plane aligned with each otobasion superior.

In examples:
the second band portion is wider at the superior region of the user's head than at the posterior region;
the lateral strap portions and posterior strap portion are integrally formed with each other and the superior transverse strap portion comprises ends attached to and extending superiorly and anteriorly from the first band portion at the posterior region on respective lateral sides of the user's head;
the superior transverse strap portion and the posterior strap portion are integrally formed and the lateral strap portions are each attached to and extend anteriorly from the second band portion proximate to the posterior region of the user's head on respective lateral sides of the user's head;
the lateral strap portions lie in use on a path extending posteriorly and partially inferiorly away from the head-mounted display unit towards the posterior region of the user's head;
each of the lateral strap portions is selectively adjustable in length;
each of the lateral strap portions passes through a respective eyelet on the head-mounted display unit, is looped back and is secured to itself;
each of the lateral strap portions is secured to itself with a hook-and-loop connection;
the head-mounted display unit comprises a pair of arms provided to respective lateral sides of the head-mounted display unit, and the lateral strap portions are constructed and arranged to attach to the arms;
the arms are pivotably attached to the head-mounted display unit;
the positioning and stabilising structure further comprises a top strap portion connecting between the second band portion and the head-mounted display unit;
the top strap portion is aligned with the sagittal plane of the user's head;
the top strap portion passes through an eyelet on the head-mounted display unit, is looped back and is secured to itself; and/or
the top strap portion is secured to itself with a hook-and-loop connection.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a band strap portion constructed and arranged to encircle a portion of the user's head, the band strap portion formed by a posterior strap portion constructed and arranged to engage the posterior region of the user's head and a superior transverse strap portion constructed and arranged to engage a superior region of the user's head at or proximate a coronal plane aligned with each otobasion superior of the user's head;
a pair of lateral strap portions connecting between the band strap portion and respective lateral sides of the head-mounted display unit, the lateral strap portions lying in use on a path extending posteriorly away from the head-mounted display unit and curving superiorly to connect to the band strap portion at or proximate the superior transverse strap portion, the lateral strap portions being rigidised.

In examples:
the superior transverse strap portion and the posterior strap portion are integrally formed;
the posterior strap portion is constructed and arranged to overlie the occipital bone of the user's head in use;
the length of the band strap portion is selectively adjustable;
the band strap portion comprises a pair of ends connected to each other in use, one of the pair of ends comprising an eyelet and the other of the pair of ends being passed through the eyelet, looped back and secured to itself;
the positioning and stabilising structure comprises a counterweight attached to the posterior strap portion;
the head-mounted display unit comprises a pair of arms provided to respective lateral sides of the head-mounted display unit, and the lateral strap portions are constructed and arranged to attach to the arms;
the arms are pivotably attached to the head-mounted display unit;
the positioning and stabilising structure further comprises a top strap portion connecting between the superior transverse strap portion and the head-mounted display unit;
the top strap portion is aligned with the sagittal plane of the user's head;
the top strap portion passes through an eyelet on the head-mounted display unit, is looped back and is secured to itself; and/or
the top strap portion is secured to itself with a hook-and-loop connection.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a superior transverse strap portion constructed and arranged to engage a superior portion of the users head in use;
an occipital strap portion constructed and arranged to engage a region of the user's head overlying the occipital bone in use;
a pair of lateral strap portions each connected to a respective junction of the superior transverse strap portion and the occipital strap portion and each constructed and arranged to connect to a respective lateral side of the head-mounted display unit;
wherein each of the lateral strap portions is rigidised.

Another aspect of the present technology relates to a positioning and stabilising structure for a head-mounted display system, the head-mounted display system comprising a head-mounted display unit comprising a display unit housing comprising a display, the head-mounted display unit further comprising an interfacing structure connected to the display unit housing and being constructed and arranged to engage the user's face in use, the positioning and stabilising structure being constructed and arranged to hold the head-mounted display unit in an operable position on the user's head in use, the positioning and stabilising structure comprising:
a superior transverse strap portion constructed and arranged to engage a superior portion of the users head in use;
an occipital strap portion constructed and arranged to engage a region of the user's head overlying the occipital bone in use;
a pair of lateral strap portions each connected to a respective junction of the superior transverse strap portion and the occipital strap portion and each constructed and arranged to connect to a respective lateral side of the head-mounted display unit;
wherein each of the lateral strap portions is rigidised.

In examples:
the superior transverse strap portion is in use substantially aligned with a coronal plane of the user's head aligned with each otobasion superior of the user's head;
the superior transverse strap portion is wider at the sagittal plane of the user's head than proximate the junctions with the occipital strap portion;
the lateral strap portions and the superior transverse strap portion are integrally formed;
portions of the superior transverse strap portion proximate respective lateral strap portions are rigidised;
the superior transverse strap portion is rigidised along its entire length;
the positioning and stabilising structure comprises a single rigidiser extending from one lateral strap portion through the superior transverse strap portion and into the other lateral strap portion;
portions of the occipital strap portion proximate respective lateral strap portions are rigidised;
the single rigidiser comprises posteriorly projecting portions extending into respective ends of the occipital strap portion;
the occipital strap portion comprises an occipital strap connector at one end of the occipital strap portion constructed and arranged to releaseably attach to a occipital strap connection portion at or proximate one of the junctions of the occipital strap portion and the superior transverse strap portion;
the occipital strap connector is constructed and arranged to magnetically attach to the occipital strap connection portion;
the occipital strap portion is selectively adjustable in length;
the occipital strap portion passes through an eyelet on the occipital strap connector, is looped back and is secured to itself;
the occipital strap portion is secured to itself with a hook-and-loop connection;
each of the lateral strap portions comprises a superior transverse strap connection portion connected to the superior transverse strap portion and an occipital strap connection portion connected to the occipital strap portion;
each of the superior transverse strap portion and the occipital strap portion are selectively adjustable in length simultaneously;
each of the lateral strap portions is selectively adjustable in length;
each of the lateral strap portions passes through a respective eyelet on the head-mounted display unit, is looped back and is secured to itself;
each of the lateral strap portions is secured to itself with a hook-and-loop connection;
the lateral strap portions are each constructed and arranged to attach to a respective one of a pair of arms extending posteriorly from respective lateral sides of the display unit housing;
the arms are constructed and arranged to be pivotably attached to the display unit housing;
the positioning and stabilising structure further comprises a top strap portion connected to the superior transverse strap portion and being constructed and arranged to connect to the head-mounted display unit;
the top strap portion is selectively adjustable in length;
the top strap portion is constructed and arranged to connect to the head-mounted display unit at a single location;
the top strap portion is constructed and arranged to pass through an eyelet on the head-mounted display unit, loop back and be secured to itself; and/or
the top strap portion is constructed and arranged to be secured to itself with a hook-and-loop connection.

Another aspect of the present technology relates to a head-mounted display system, comprising:
a head-mounted display unit comprising:
   a display unit housing comprising a display; and
   an interfacing structure connected to the display unit housing and constructed and arranged to engage the user's face in use; and
a positioning and stabilising structure constructed and arranged to hold the head-mounted display unit in an operable position on the user's head in use, the positioning and stabilising structure comprising:
a first band portion constructed and arranged to connect to respective lateral sides of the head-mounted display unit, partially encircle the user's head and engage a posterior region of the user's head in use;
a second band portion constructed and arranged to connect to respective lateral sides of the head-mounted display unit and engage a superior region of the user's head in use.

In examples:
the second band portion is wider at the superior region of the user's head than at the posterior region;
the first band portion comprises a semi-rigid portion constructed and arranged to engage the posterior region of the user's head in use;
the first band portion is wider at the posterior region of the user's head than at lateral regions of the user's head;
the second band portion lies on a path extending posteriorly from each lateral side of the head-mounted display unit and curving superiorly into a superior transverse strap portion constructed and arranged to engage the superior region of the user's head;
the second band portion comprises a pair of substantially rigid portions at the respective connections between the second band portion and the lateral sides of the head-mounted display unit;
the substantially rigid portions extend posteriorly from each lateral side of the head-mounted display unit and curve superiorly;
the first band portion is selectively adjustable in length;
the second band portion is selectively adjustable in length;
the head-mounted display unit comprises a pair of arms extending posteriorly from respective lateral sides of the display unit housing;
the first band portion is attached to the arms and the second band portion is connected to the first band portion proximate the arms;
the second band portion is attached to the arms and the first band portion is connected to the second band portion proximate the arms;
the arms are pivotably attached to the display unit housing;
the positioning and stabilising structure further comprises a top strap portion connected to the second band portion and constructed and arranged to connect to the head-mounted display unit;
the top strap portion is selectively adjustable in length;
the top strap portion connects to the head-mounted display unit at a single location;
the top strap portion passes through an eyelet on the head-mounted display unit, is looped back and is secured to itself; and/or
the top strap portion is secured to itself with a hook-and-loop connection.

In examples of any of the above aspects:
the interfacing structure comprises a cushion and a face engaging flange constructed and arranged to be provided around a periphery of an eye region of the user's face and configured to engage the user's face in use, the face engaging flange being flexible and resilient, the face engaging flange at least partially covering the cushion; and/or
the interfacing structure comprises a pair of cheek portions configured to engage the user's cheeks in use, a forehead portion configured to engage the user's forehead in use, and a pair of sphenoid portions located on respective lateral sides of the interfacing structure connecting between the forehead portion and the cheek portions and configured to engage the user's head proximate the sphenoid bone.

Another form of the present technology comprises a head mounted display system for a person comprising:
a head-mounted display unit comprising a display;
a control system for operation of the head-mounted display system; and
a positioning and stabilizing structure configured to configured to hold the head-mounted display unit anterior to a user's eyes such that the display is viewable by the user in use. The positioning and stabilising structure may be according any one of the above aspects.

The head-mounted display system may be helmet mounted, may be configured for virtual reality display, may be configured for augmented reality display, may be configured for mixed reality display.

In some examples: a) the head mounted display apparatus further comprises a light shield; b) the light shield is constructed and arranged to substantially obstruct in use the receipt of ambient light upon an eye region of the person; c) the light shield is configured for use in virtual reality display; d) the head-mounted display system comprises an interfacing structure constructed and arranged to contact in use an eye region of the person's face; e) the interfacing structure is constructed from foam, silicone, and/or gel; f) the interfacing structure is constructed from a light absorbing material; and/or g) the interfacing structure is configured to function as a light shield.

In some examples: a) the head mounted display apparatus further comprises a sound system; b) a left ear transducer; and/or c) a right ear transducer.

In some examples: a) the head-mounted display unit comprises a binocular display unit; and/or b) the positioning and stabilizing structure is configured to maintain the binocular display unit in an operation position in use.

In some examples: a) the control system comprises a visual display controller and at least one battery; b) the at least one battery includes a first battery and a second battery; c) the first battery is a lower power system battery configured to power an RT clock; d) the second battery is a main battery; e) a battery support configured to retain the battery; f) the battery support is connected to the positioning and stabilizing structure using a tether; g) an orientation sensor configured to sense the orientation of the person's head in use; and/or h) a control support system.

In some examples: a) the positioning and stabilising structure comprises a frontal support portion configured to contact a region overlying a frontal bone of the person's head; and/or (b) the positioning and stabilising structure comprises a length adjustment mechanism for adjusting a length of a portion of the positioning and stabilising structure.

Another aspect of one form of the present technology is a positioning and stabilizing structure that is constructed with a shape which is complementary to that of an intended wearer.

Another aspect of one form of the present technology is an interfacing structure that is constructed with a shape which is complementary to that of an intended wearer.

An aspect of one form of the present technology is a method of manufacturing apparatus.

An aspect of certain forms of the present technology is a positioning and stabilizing structure that is easy to use, e.g., by a person who has limited dexterity, vision or by a person with limited experience in using a head-mounted display.

An aspect of certain forms of the present technology is an interfacing structure that is easy to use, e.g., by a person who has limited dexterity, vision or by a person with limited experience in using a head-mounted display.

The methods, systems, devices and apparatus described may be implemented so as to improve the functionality of a head-mounted display, such as an electronic display or computer. Moreover, the described methods, systems, devices and apparatus can provide improvements in the technological field of virtual reality, augmented reality, and/or mixed reality.

Of course, portions of the aspects may form sub-aspects of the present technology. Also, various ones of the sub-aspects and/or aspects may be combined in various manners and also constitute additional aspects or sub-aspects of the present technology.

Other features of the technology will be apparent from consideration of the information contained in the following detailed description, abstract, drawings and claims.

### 4 BRIEF DESCRIPTION OF THE DRAWINGS

The present technology is illustrated by way of example, and not by way of limitation, in the figures of the accompanying drawings, in which like reference numerals refer to similar elements including:

### 4.1 Head-Mounted Display Systems

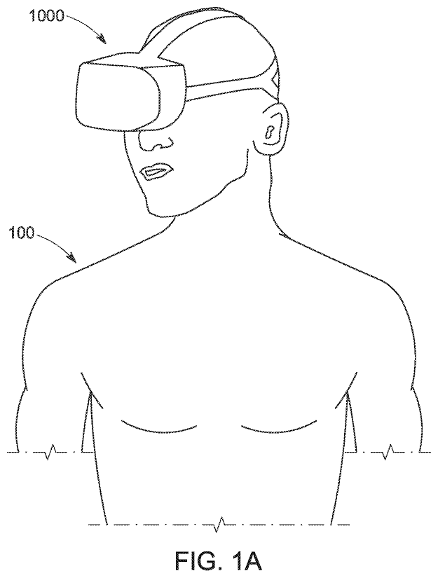

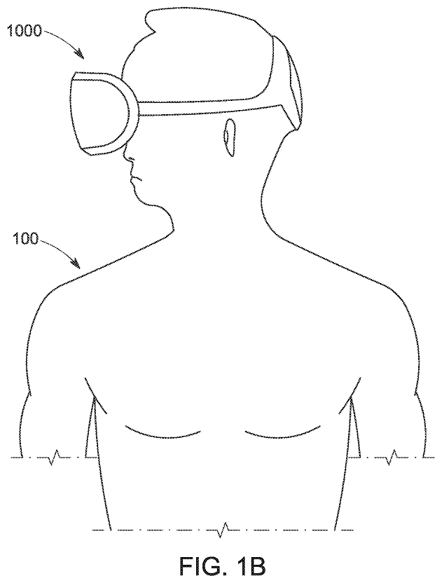

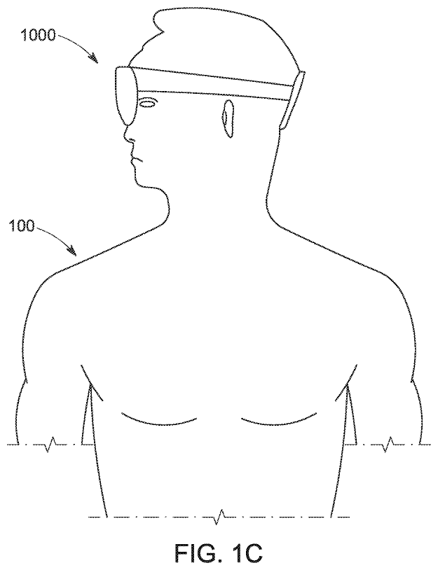

FIG. 1A shows a system including a user 100 wearing a head-mounted display system 1000, in the form of a face-mounted, virtual reality (VR) headset, displaying various images to the user 100. The user is standing while wearing the head-mounted display system 1000.

FIG. 1B shows a system including a user 100 wearing a head-mounted display system 1000, in the form of a floating virtual reality (VR) headset, displaying various images to the user. The user is sitting while wearing the display interface 100.

FIG. 1C shows a system including a user 100 wearing a head-mounted display system 1000, in the form of a floating augmented reality (AR) headset, displaying various images to the user. The user is standing while wearing the head-mounted display system 1000.

### 4.2 Display System and Facial Anatomy

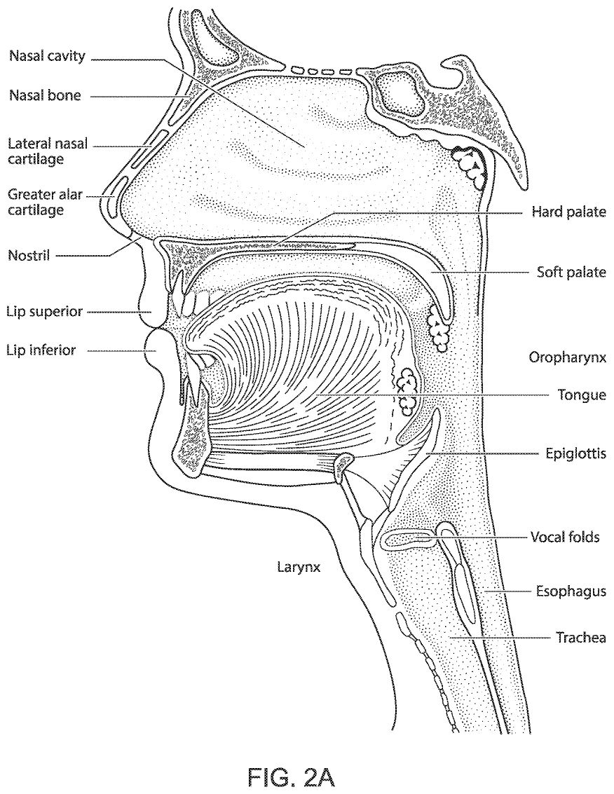

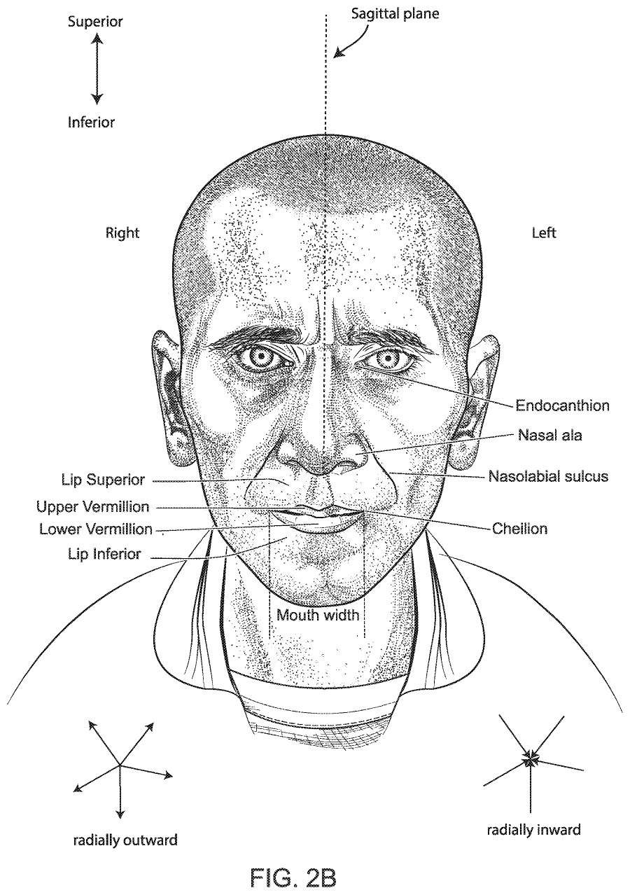

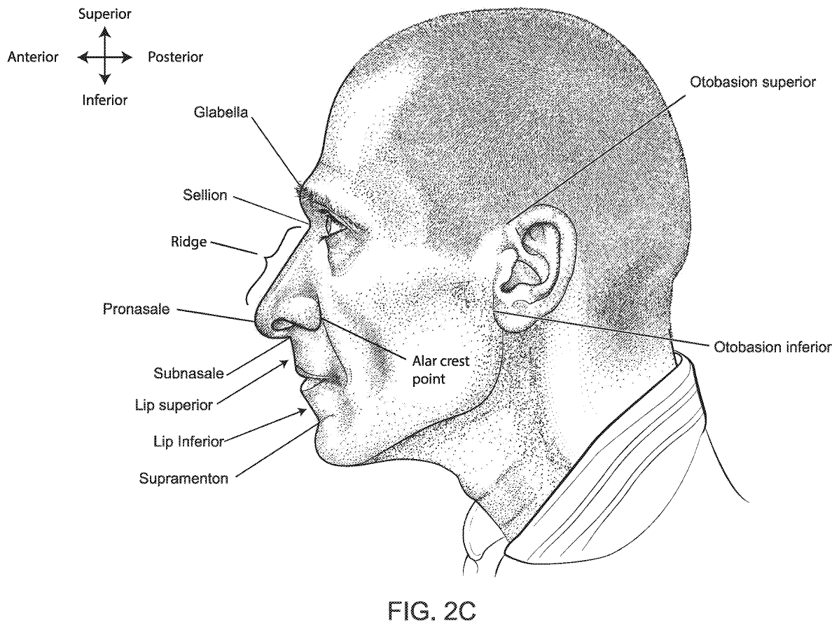

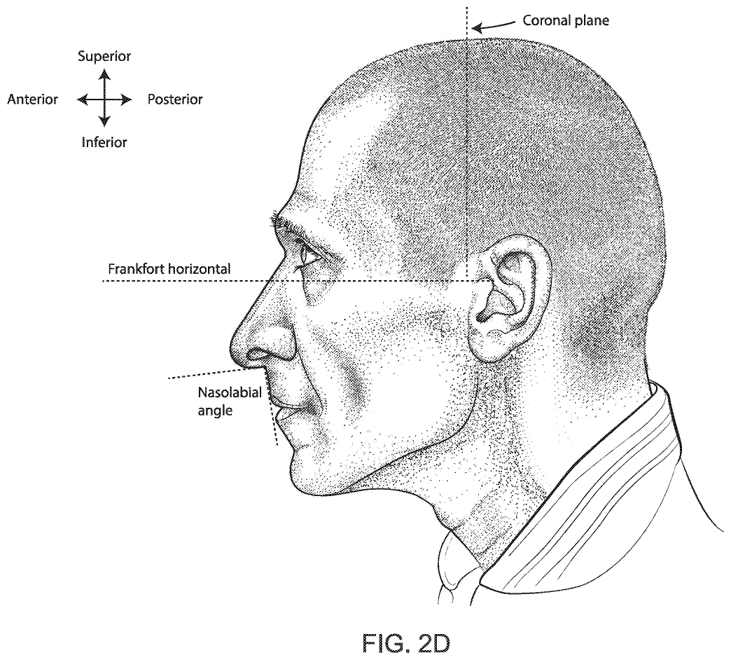

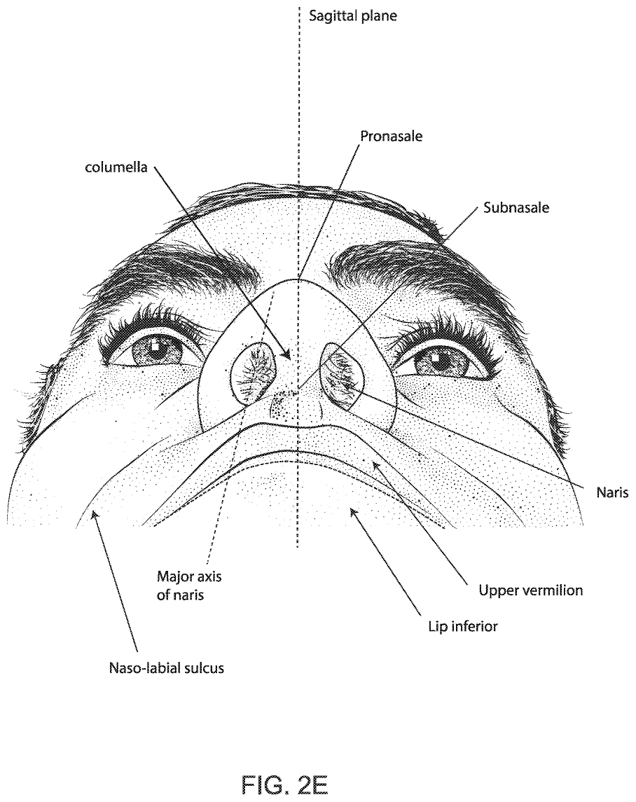

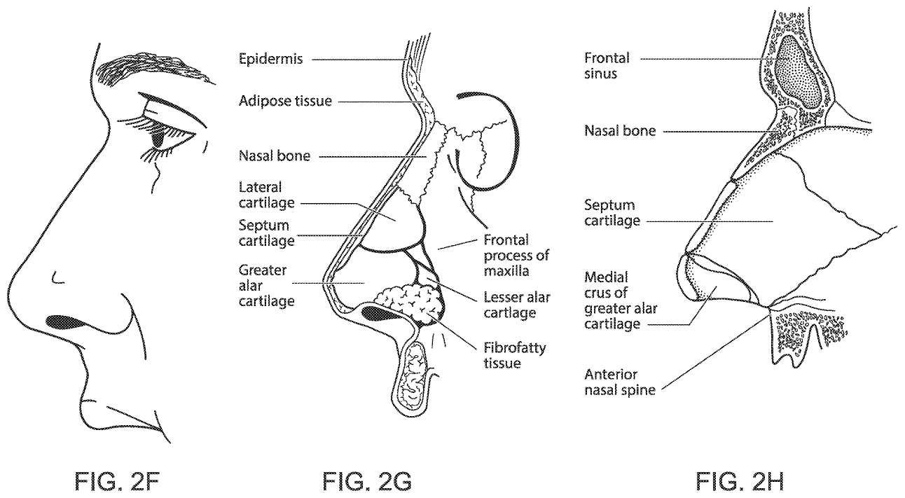

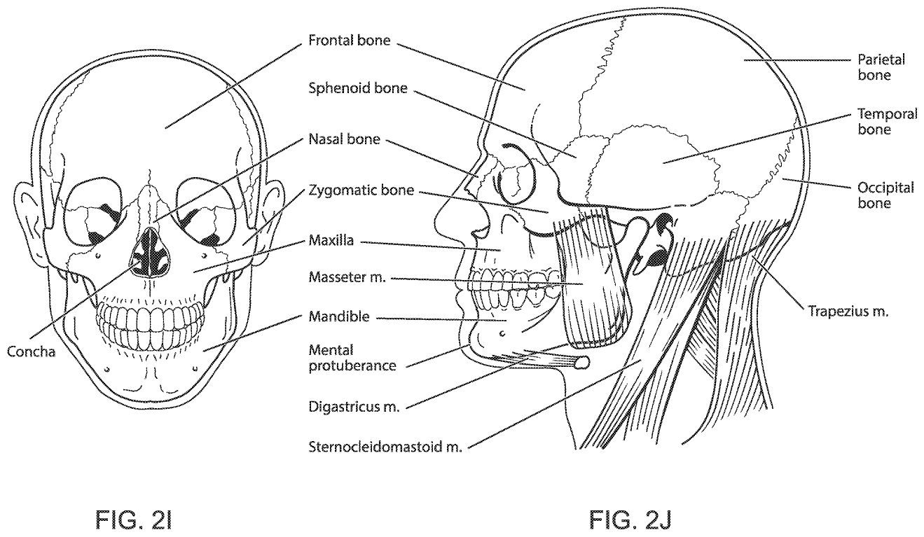

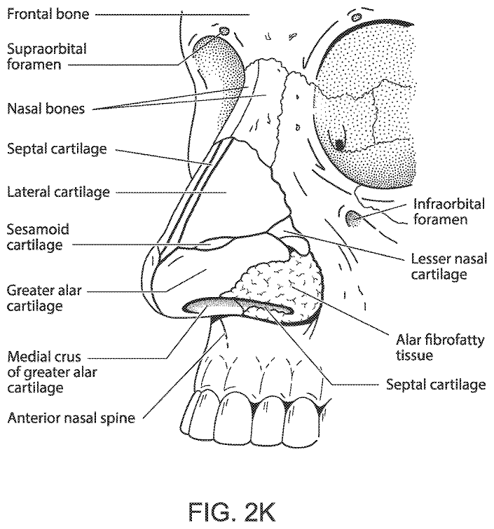

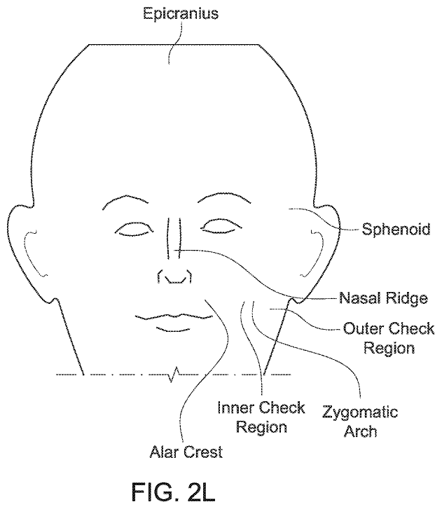

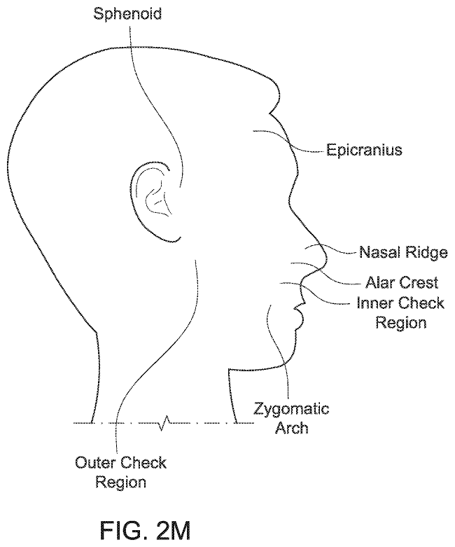

FIG. 2A shows a view of a human upper airway including the nasal cavity, nasal bone, lateral nasal cartilage, greater alar cartilage, nostril, lip superior, lip inferior, larynx, hard palate, soft palate, oropharynx, tongue, epiglottis, vocal folds, oesophagus and trachea.

FIG. 2B is a front view of a face with several features of surface anatomy identified including the lip superior, upper vermilion, lower vermilion, lip inferior, mouth width, endocanthion, a nasal ala, nasolabial sulcus and cheilion. Also indicated are the directions superior, inferior, radially inward and radially outward.

FIG. 2C is a side view of a head with several features of surface anatomy identified including glabella, sellion, pronasale, subnasale, lip superior, lip inferior, supramenton, nasal ridge, alar crest point, otobasion superior and otobasion inferior. Also indicated are the directions superior & inferior, and anterior & posterior.

FIG. 2D is a further side view of a head. The approximate locations of the Frankfort horizontal and nasolabial angle are indicated. The coronal plane is also indicated.

FIG. 2E shows a base view of a nose with several features identified including naso-labial sulcus, lip inferior, upper Vermilion, naris, subnasale, columella, pronasale, the major axis of a naris and the midsagittal plane.

FIG. 2F shows a side view of the superficial features of a nose.

FIG. 2G shows subcutaneal structures of the nose, including lateral cartilage, septum cartilage, greater alar cartilage, lesser alar cartilage, sesamoid cartilage, nasal bone, epidermis, adipose tissue, frontal process of the maxilla and fibrofatty tissue.

FIG. 2H shows a medial dissection of a nose, approximately several millimeters from the midsagittal plane, amongst other things showing the septum cartilage and medial crus of greater alar cartilage.

FIG. 2I shows a front view of the bones of a skull including the frontal, nasal and zygomatic bones. Nasal concha are indicated, as are the maxilla, and mandible.

FIG. 2J shows a lateral view of a skull with the outline of the surface of a head, as well as several muscles. The following bones are shown: frontal, sphenoid, nasal, zygomatic, maxilla, mandible, parietal, temporal and occipital. The mental protuberance is indicated. The following muscles are shown: digastricus, masseter, sternocleidomastoideo trapezius.

FIG. 2K shows an anterolateral view of a nose. The following bones are shown: frontal, supraorbital foramen, nasal, septal cartilage, lateral cartilage, orbit and infraorbital foramen.

FIG. 2L shows another front view of the face with several features of surface anatomy identified including the epicranius, the sphenoid, the nasal ridge, the outer and inner cheek regions, the zygomatic arch, and the alar crest.

FIG. 2M shows another side view of the face with several features of surface anatomy identified including the epicranius, the sphenoid, the nasal ridge, the outer and inner cheek regions, the zygomatic arch, and the alar crest.

### 4.3 Shape of Structures

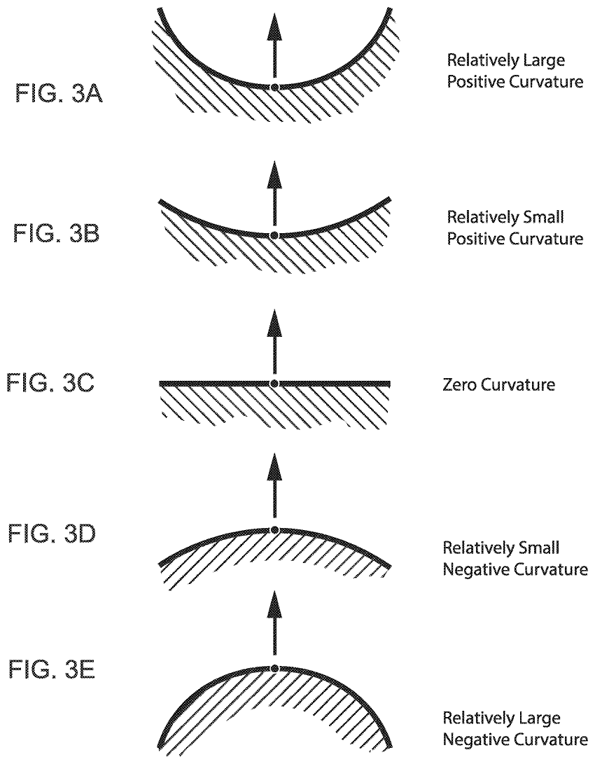

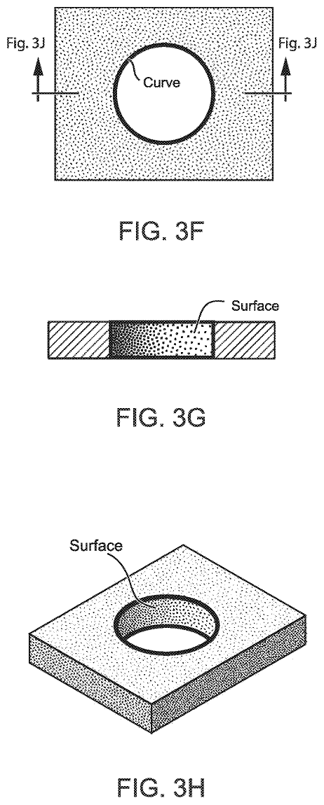

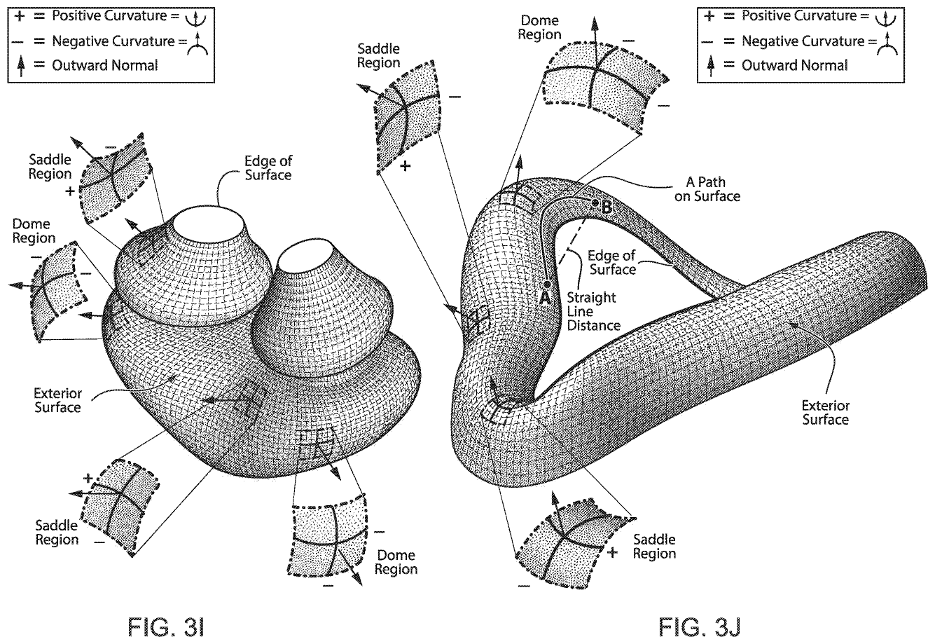

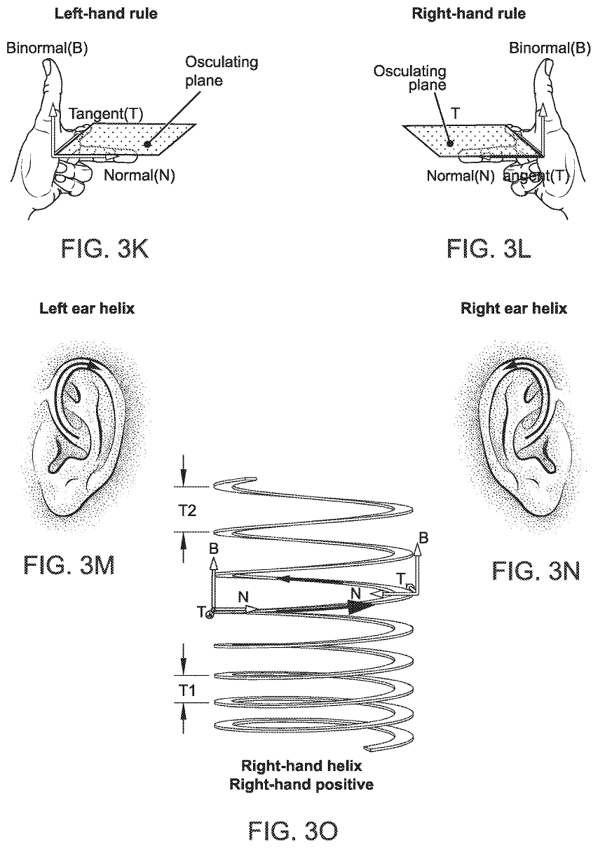

FIG. 3A shows a schematic of a cross-section through a structure at a point. An outward normal at the point is indicated. The curvature at the point has a positive sign, and a relatively large magnitude when compared to the magnitude of the curvature shown in FIG. 3B.

FIG. 3B shows a schematic of a cross-section through a structure at a point. An outward normal at the point is indicated. The curvature at the point has a positive sign, and a relatively small magnitude when compared to the magnitude of the curvature shown in FIG. 3A.

FIG. 3C shows a schematic of a cross-section through a structure at a point. An outward normal at the point is indicated. The curvature at the point has a value of zero.

FIG. 3D shows a schematic of a cross-section through a structure at a point. An outward normal at the point is indicated. The curvature at the point has a negative sign, and a relatively small magnitude when compared to the magnitude of the curvature shown in FIG. 3E.

FIG. 3E shows a schematic of a cross-section through a structure at a point. An outward normal at the point is indicated. The curvature at the point has a negative sign, and a relatively large magnitude when compared to the magnitude of the curvature shown in FIG. 3D.

FIG. 3F shows the surface of a structure, with a one dimensional hole in the surface. The illustrated plane curve forms the boundary of a one dimensional hole.

FIG. 3G shows a cross-section through the structure of FIG. 3F. The illustrated surface bounds a two dimensional hole in the structure of FIG. 3F.

FIG. 3H shows a perspective view of the structure of FIG. 3F, including the two dimensional hole and the one dimensional hole. Also shown is the surface that bounds a two dimensional hole in the structure of FIG. 3F.

FIGS. 3I-3J shows a seal forming structure. An exterior surface of the cushion is indicated. An edge of the surface is indicated. A path on the surface between points A and B is indicated. A straight-line distance between A and B is indicated. Two saddle regions and a dome region are indicated.

FIG. 3K illustrates a left-hand rule.

FIG. 3L illustrates a right-hand rule.

FIG. 3M shows a left ear, including the left ear helix.

FIG. 3N shows a right ear, including the right ear helix.

FIG. 3O shows a right-hand helix.

### 4.4 Head-Mounted Virtual Reality Display

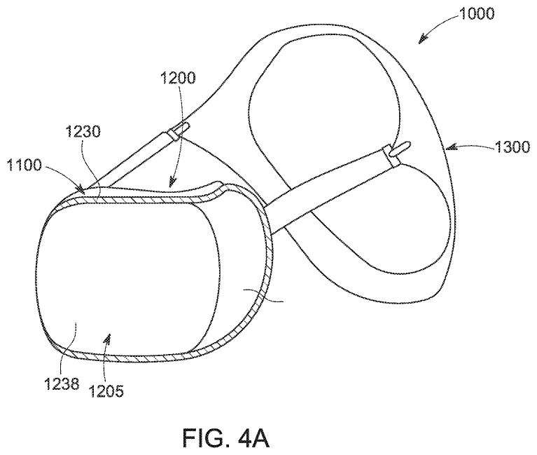

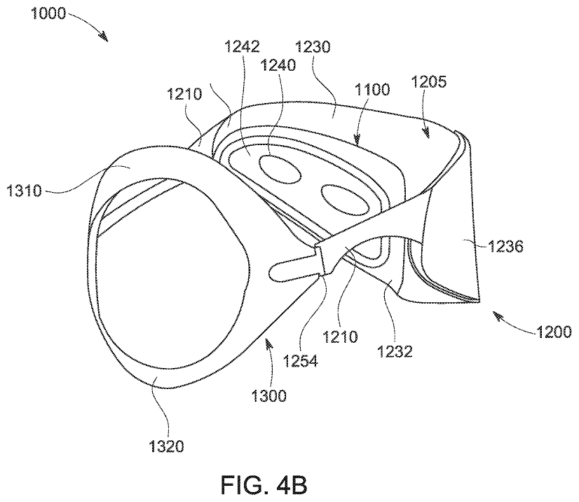

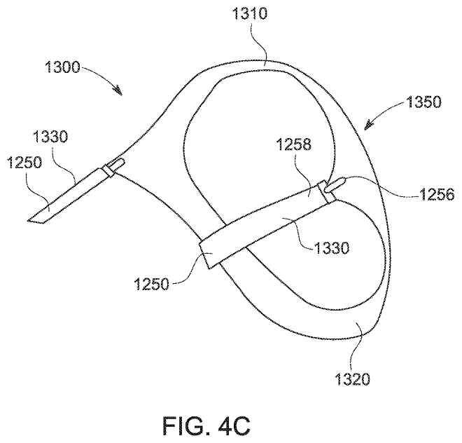

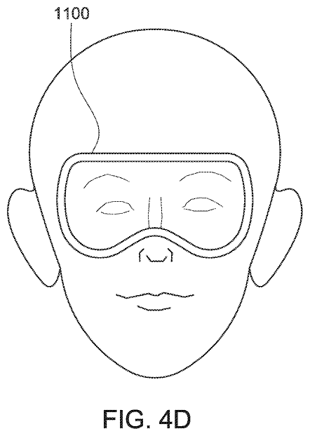

FIG. 4A shows a front perspective view of a head-mounted display interface in accordance with one form of the present technology.

FIG. 4B shows a rear perspective view of the head-mounted display of FIG. 4A.

FIG. 4C shows a perspective view of a positioning and stabilizing structure used with the head-mounted display of FIG. 4A.

FIG. 4D shows a front view of a user's face, illustrating a location of an interfacing structure, in use.

### 4.5 Head-Mounted Augmented Reality Display

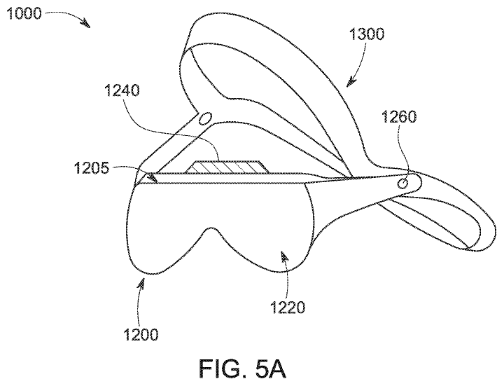

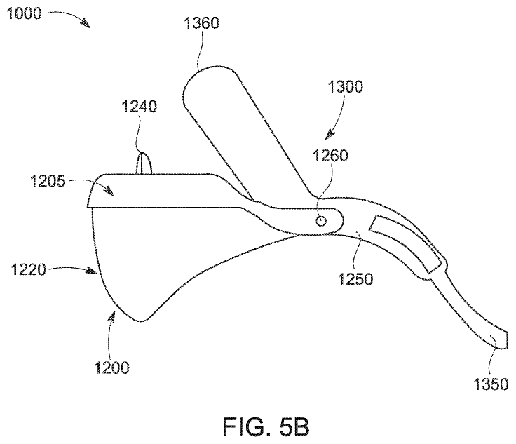

FIG. 5A shows a front perspective view of a head-mounted display interface in accordance with one form of the present technology.

FIG. 5B shows a side view of the head-mounted display interface of FIG. 5A.

### 4.6 Controls

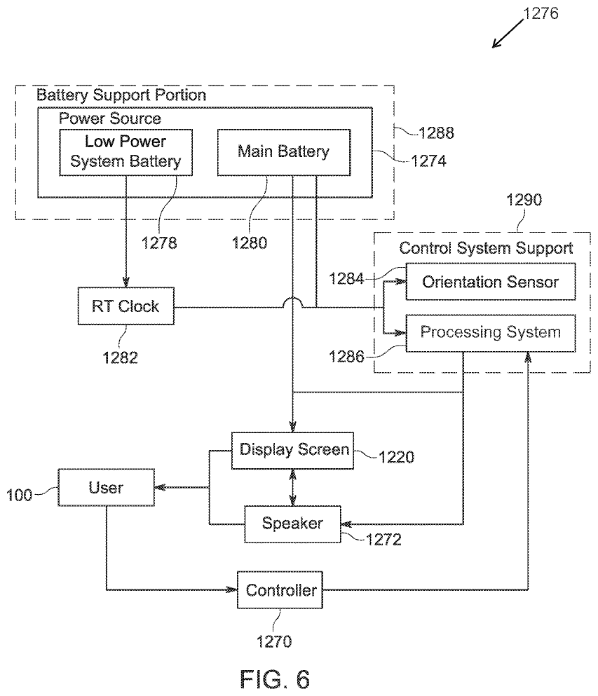

FIG. 6 shows a schematic view of a control system of one form of the present technology.

### 4.7 Positioning and Stabilising Structures

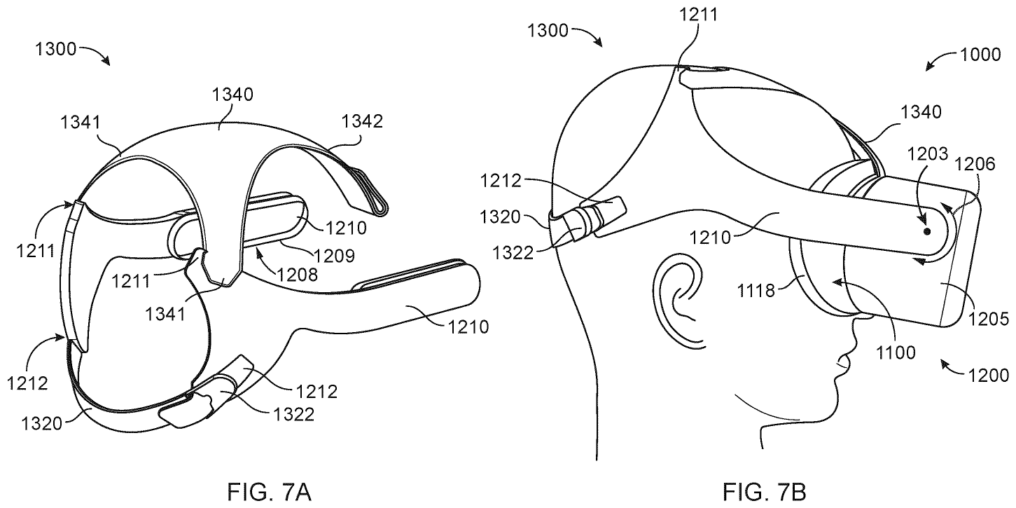

FIG. 7A is posterolateral perspective view of a positioning and stabilising structure according to an example of the present technology.

FIG. 7B is a lateral view of a head-mounted display system comprising the positioning and stabilising structure of FIG. 7A worn by a user.

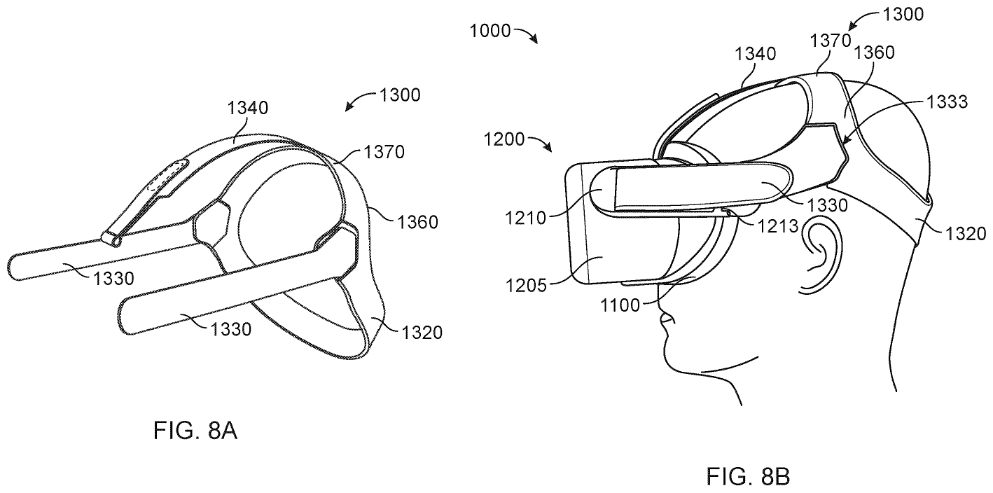

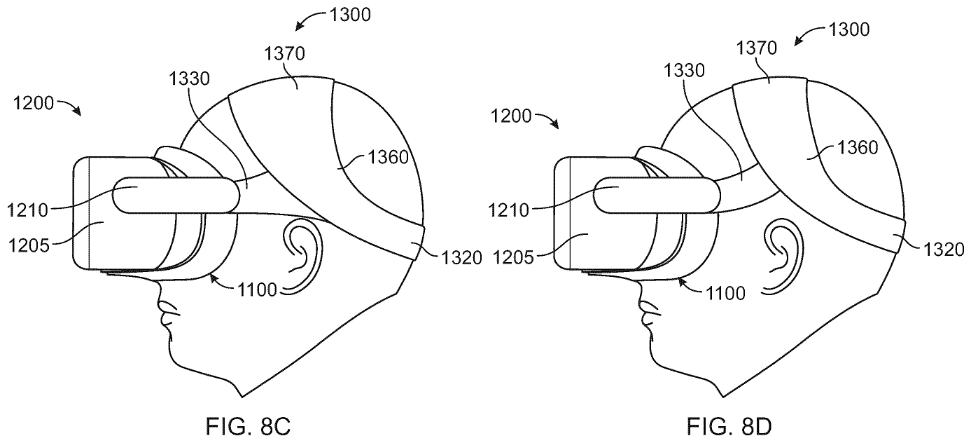

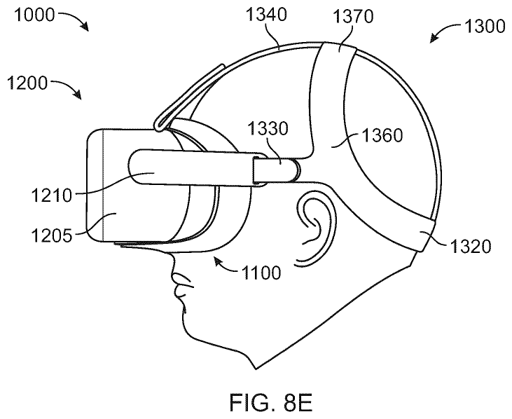

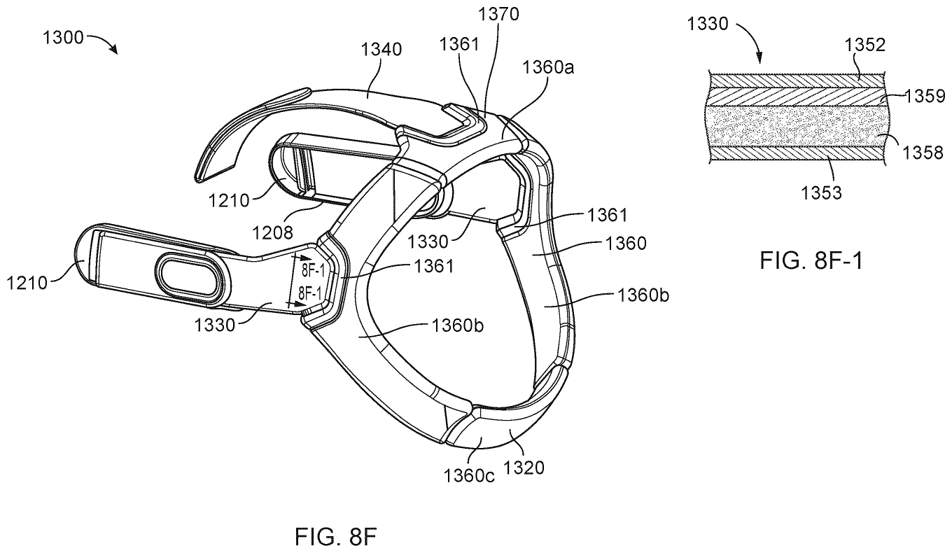

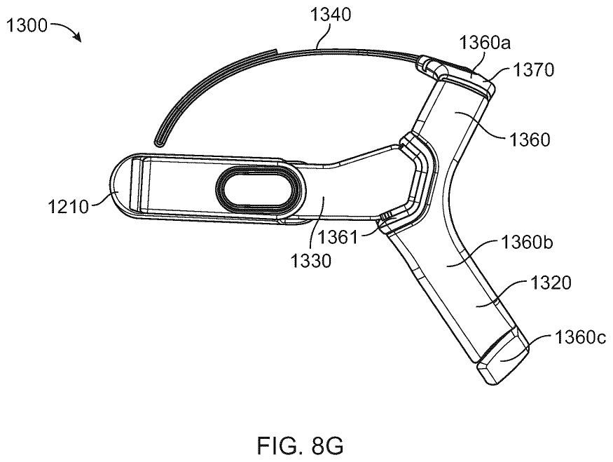

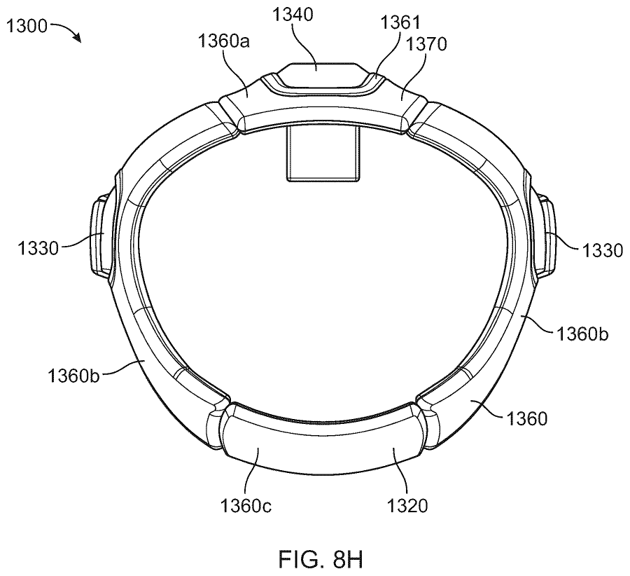

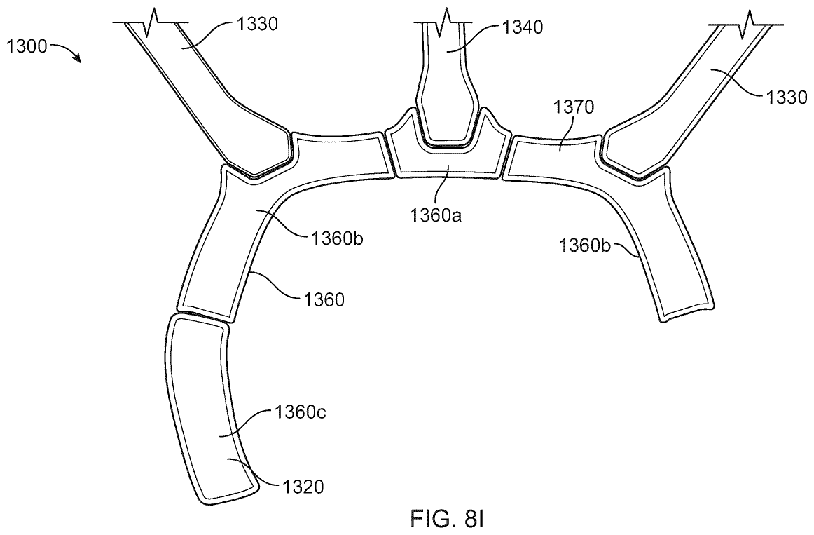

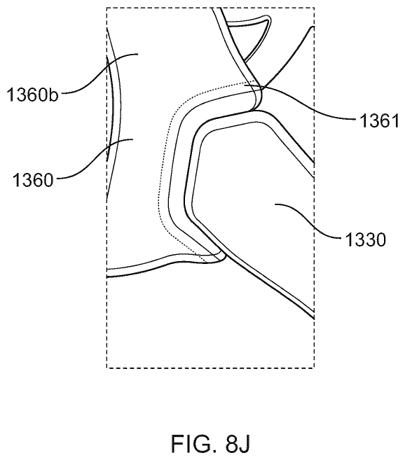

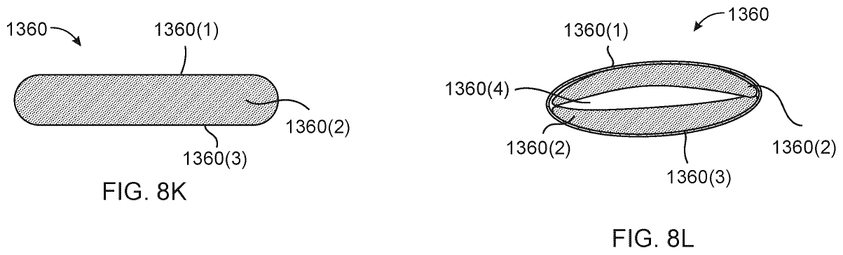

FIG. 8A is an anterolateral view of a positioning and stabilising structure according to another example of the present technology.

FIG. 8B is a lateral view of a head-mounted display system comprising the positioning and stabilising structure of FIG. 8A worn by a user.

FIG. 8C is a lateral view of a head-mounted display system comprising a positioning and stabilising structure according to another example of the present technology worn by a user.

FIG. 8D is a lateral view of a head-mounted display system comprising a positioning and stabilising structure according to another example of the present technology worn by a user.

FIG. 8E is a lateral view of a head-mounted display system comprising a positioning and stabilising structure according to another example of the present technology worn by a user.

FIG. 8F is a posterolateral perspective view of a positioning and stabilising structure according to another example of the present technology.

FIG. 8F-1 is a cross-sectional view along the line 8F-1-8F-1 in FIG. 8F.

FIG. 8G is a lateral view of the positioning and stabilising structure of FIG. 8F.

FIG. 8H is a posterior view of the positioning and stabilising structure of FIG. 8F.

FIG. 8I is a plan view of the positioning and stabilising structure of FIG. 8F in a partially assembled state.

FIG. 8J is a detail view of a joint of the positioning and stabilising structure of FIG. 8F.

FIG. 8K is a cross section view of a strap portion of a positioning and stabilising structure according to another example of the present technology.

FIG. 8L is a cross section view of a strap portion of a positioning and stabilising structure according to another example of the present technology.

FIG. 8M is a perspective view of an arm of a head-mounted display system according to another example of the present technology.

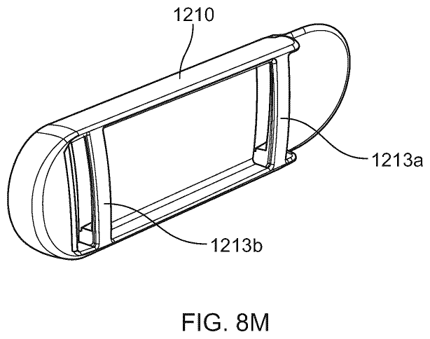

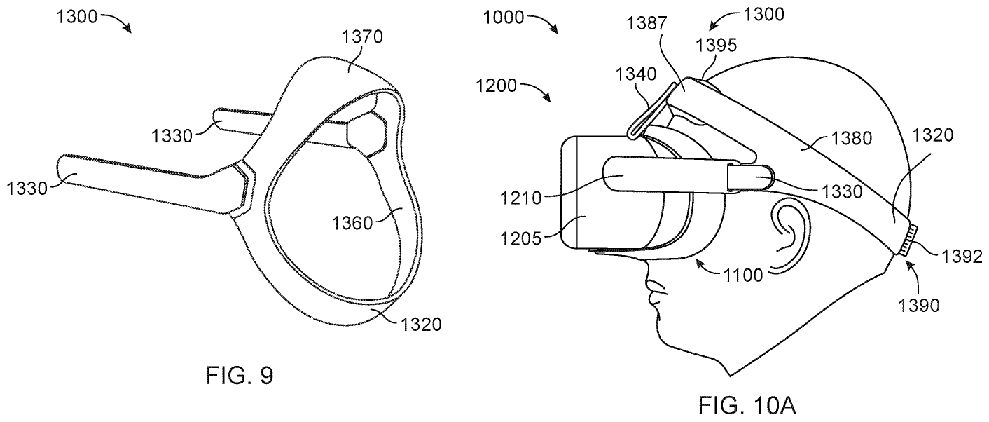

FIG. 9 is a posterolateral view of a positioning and stabilising structure according to another example of the present technology.

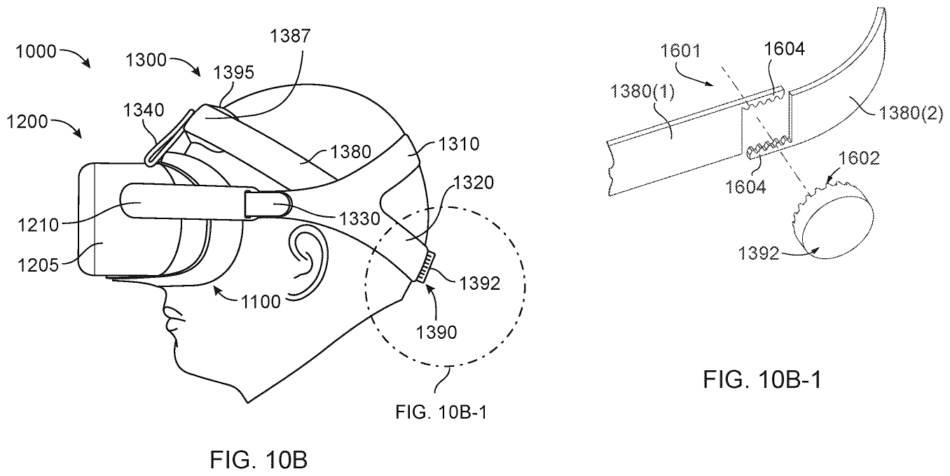

FIG. 10A is a lateral view of a head-mounted display system comprising a positioning and stabilising structure according to another example of the present technology worn by a user.

FIG. 10B is a lateral view of a head-mounted display system comprising a positioning and stabilising structure according to another example of the present technology worn by a user.

FIG. 10B-1 is an enlarged detail view taken from FIG. 10B.

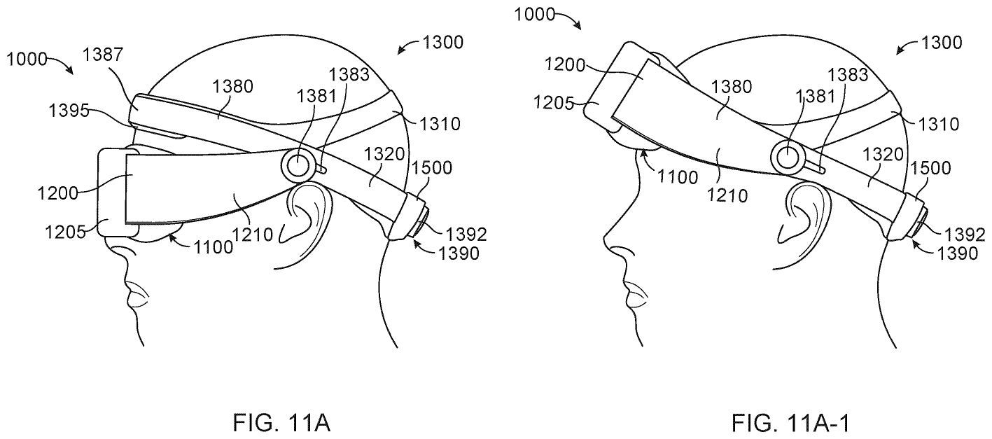

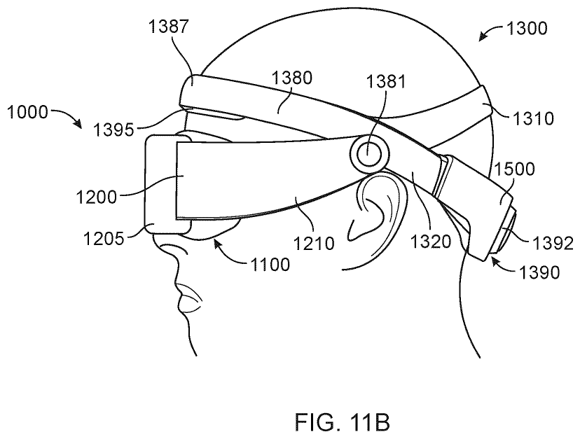

FIG. 11A is a lateral view of a head-mounted display system, in a viewing position, comprising a positioning and stabilising structure according to another example of the present technology worn by a user.

FIG. 11A-1 is a lateral view of a head-mounted display system, in a non-viewing position, comprising a positioning and stabilising structure according to the example in FIG. 11A.

FIG. 11B is a lateral view of a head-mounted display system comprising a positioning and stabilising structure according to another example of the present technology worn by a user.

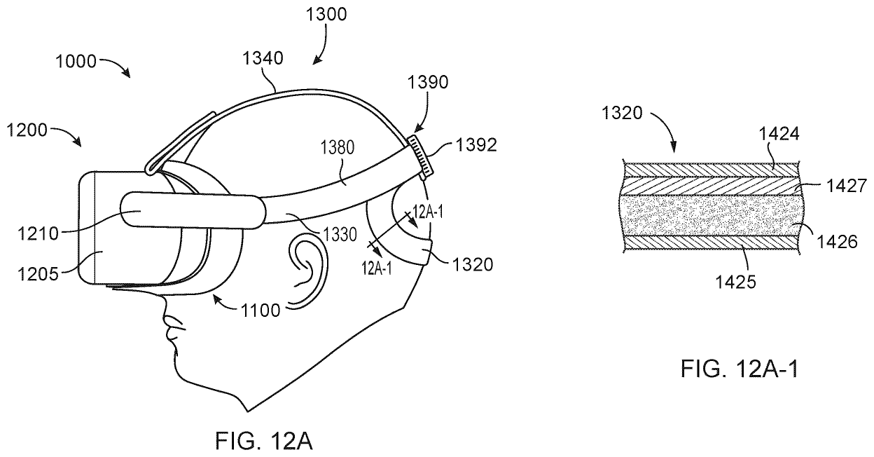

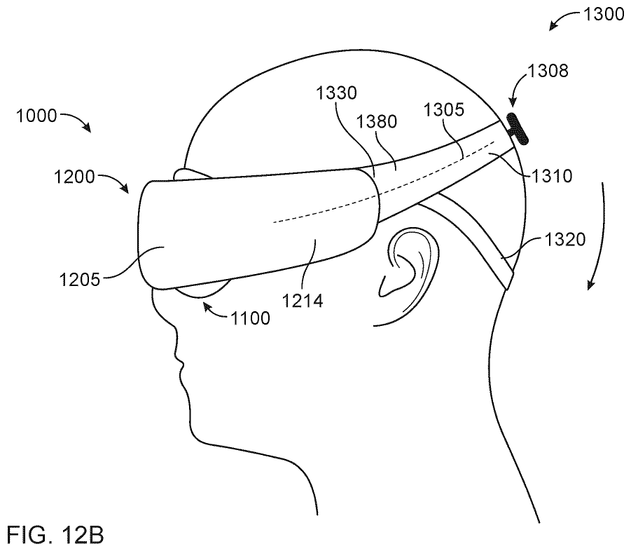

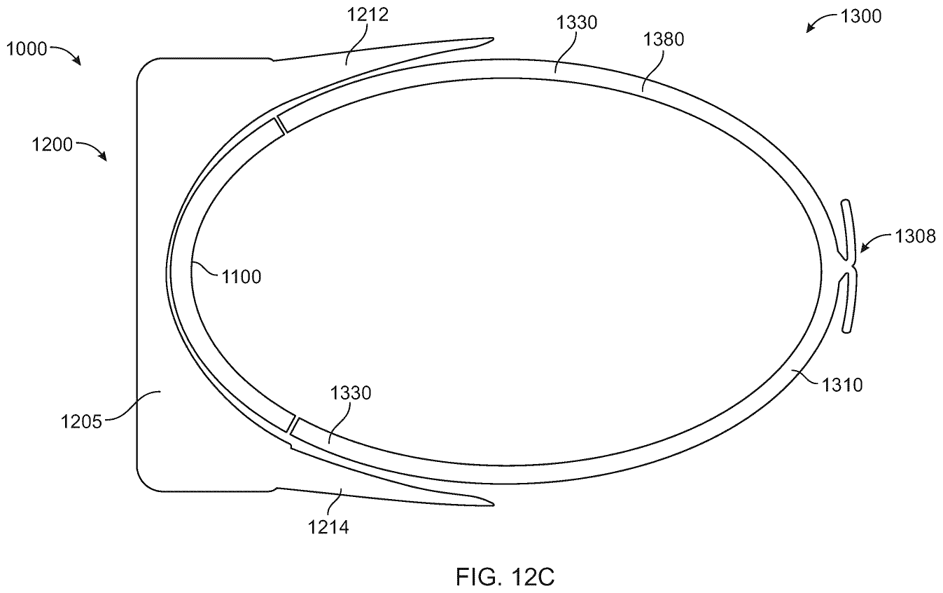

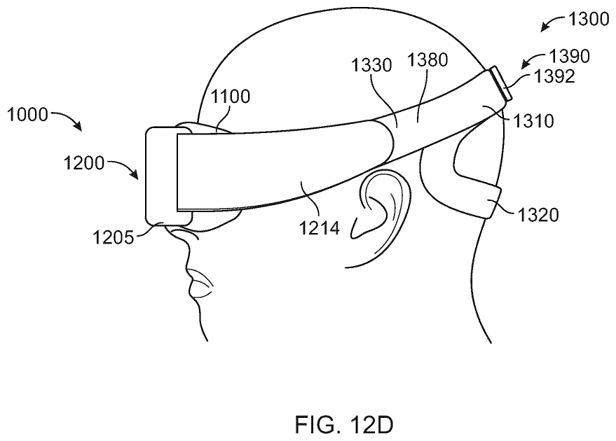

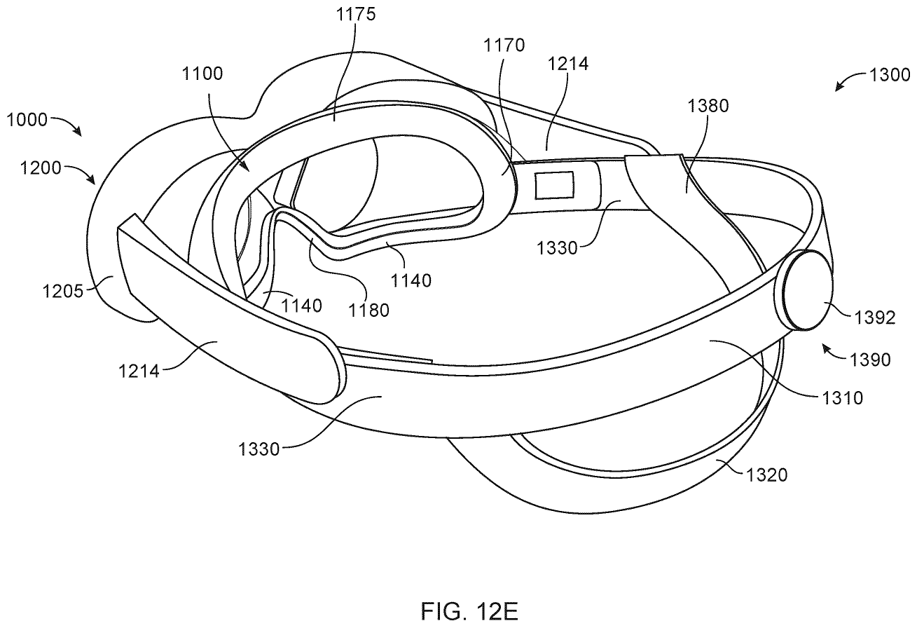

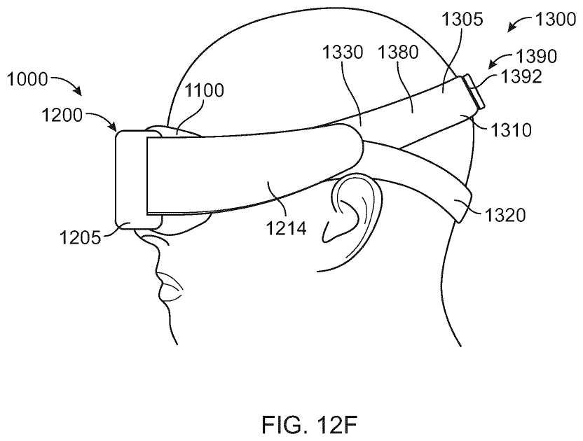

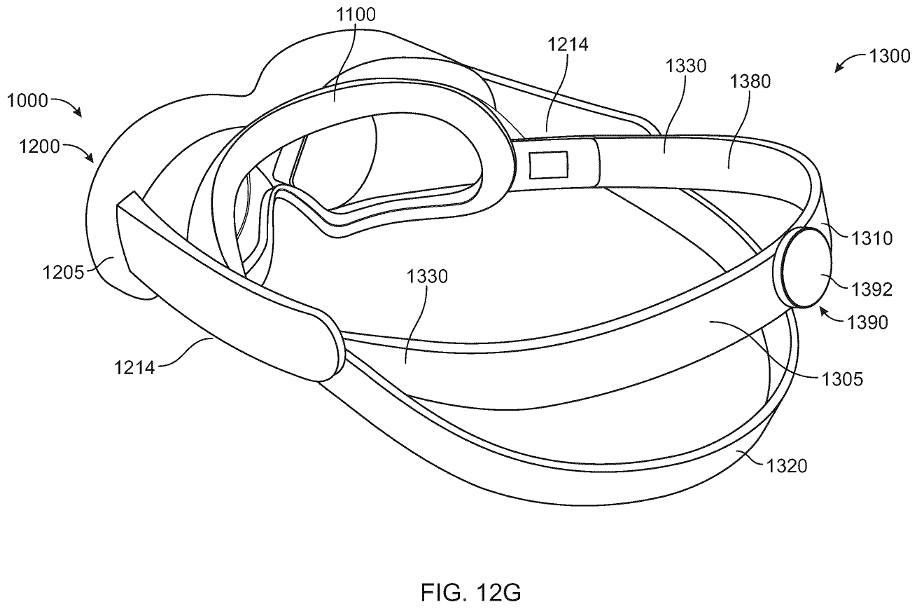

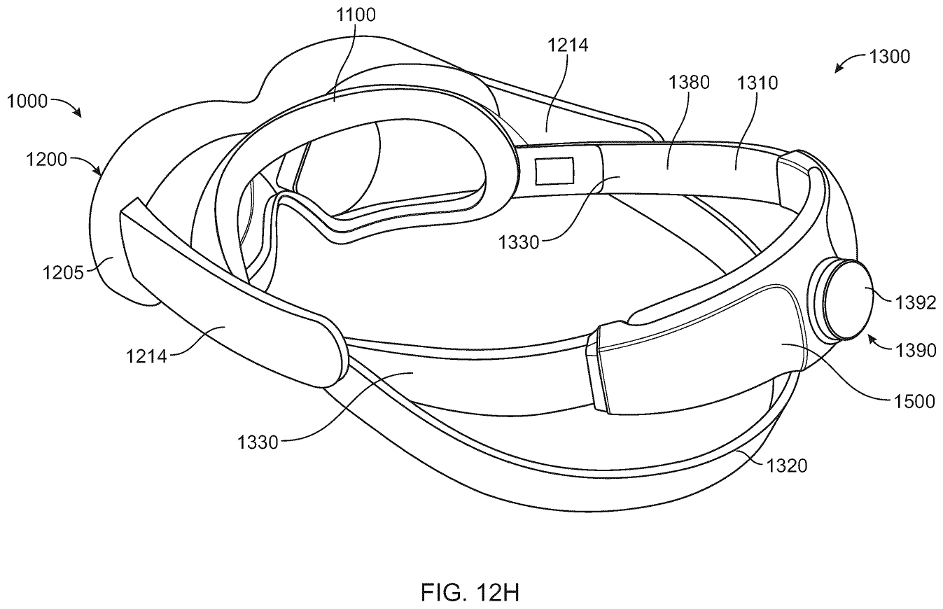

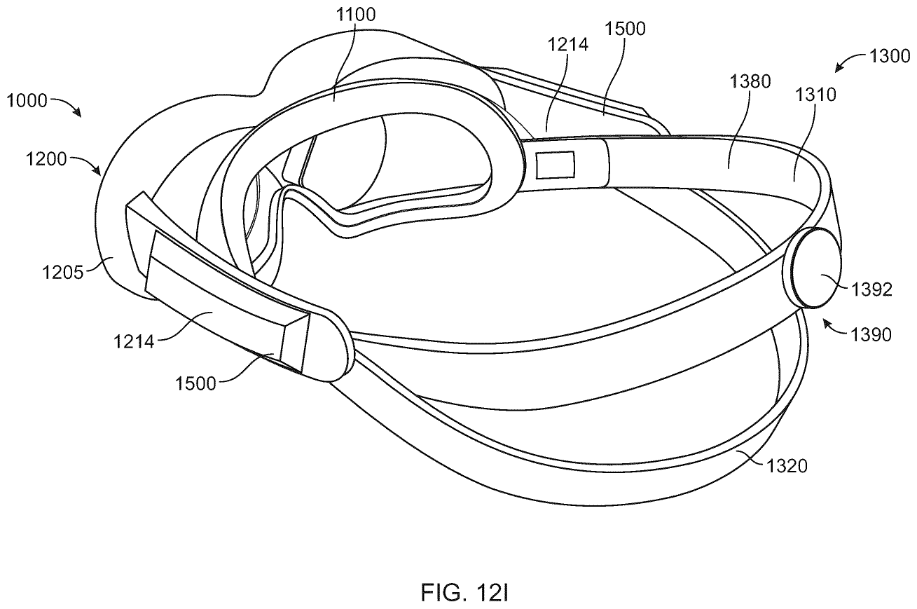

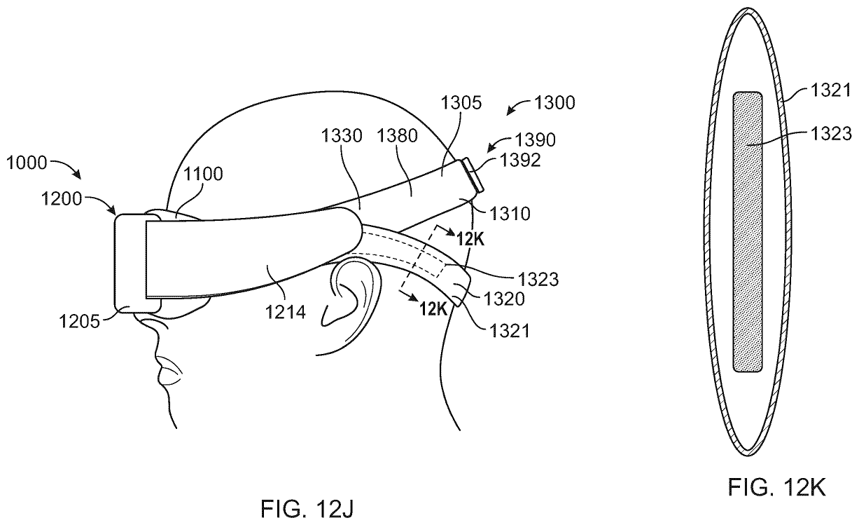

FIG. 12A is a lateral view of a head-mounted display system comprising a positioning and stabilising structure according to another example of the present technology worn by a user.

FIG. 12A-1 is a cross-sectional view along the line 12A-1-12A-1 in FIG. 12A.

FIG. 12B is a schematic side view of a head-mounted display system comprising a positioning and stabilising structure according to another example of the present technology worn by a user.

FIG. 12C is a schematic plan view of the head-mounted display system shown in FIG. 12B.

FIG. 12D is a lateral view of a head-mounted display system comprising a positioning and stabilising structure according to another example of the present technology worn by a user.

FIG. 12E is a perspective view of a head-mounted display system comprising a positioning and stabilising structure according to another example of the present technology.

FIG. 12F is a lateral view of a head-mounted display system comprising a positioning and stabilising structure according to another example of the present technology worn by a user.

FIG. 12G is a perspective view of the head-mounted display system shown in FIG. 12F.

FIG. 12H is a perspective view of a head-mounted display system comprising a positioning and stabilising structure according to another example of the present technology.

FIG. 12I is a perspective view of a head-mounted display system comprising a positioning and stabilising structure according to another example of the present technology.

FIG. 12J is a lateral view of a head-mounted display system comprising a positioning and stabilising structure according to another example of the present technology.

FIG. 12K is a schematic cross section view through line 12K-12K shown in FIG. 12J.

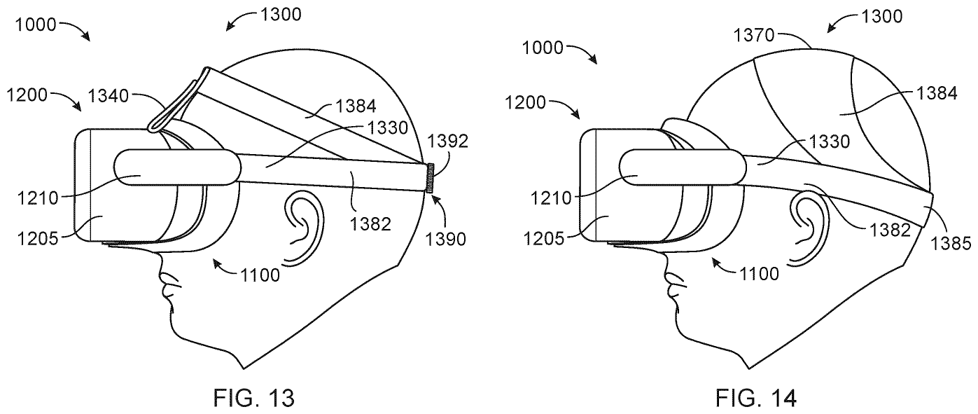

FIG. 13 is a lateral view of a head-mounted display system comprising a positioning and stabilising structure according to another example of the present technology worn by a user.

FIG. 14 is a lateral view of a head-mounted display system comprising a positioning and stabilising structure according to another example of the present technology worn by a user.

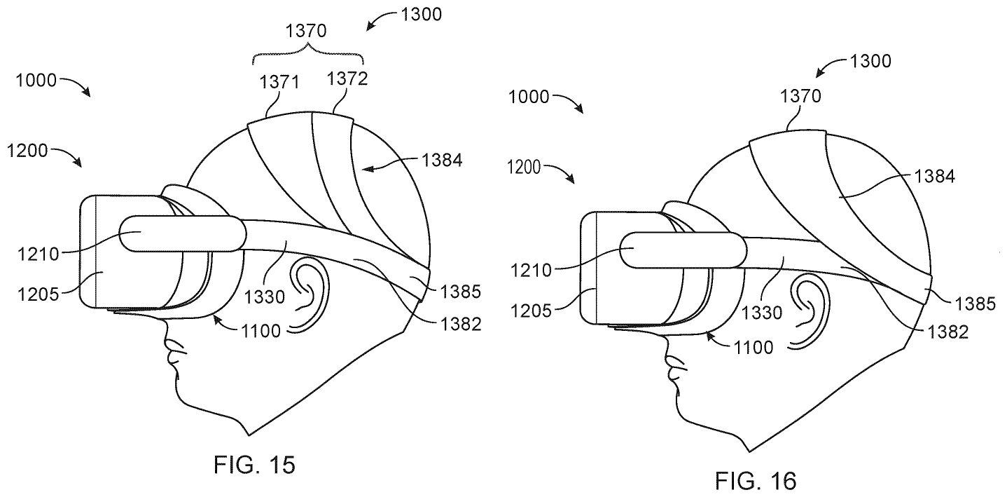

FIG. 15 is a lateral view of a head-mounted display system comprising a positioning and stabilising structure according to another example of the present technology worn by a user.

FIG. 16 is a lateral view of a head-mounted display system comprising a positioning and stabilising structure according to another example of the present technology worn by a user.

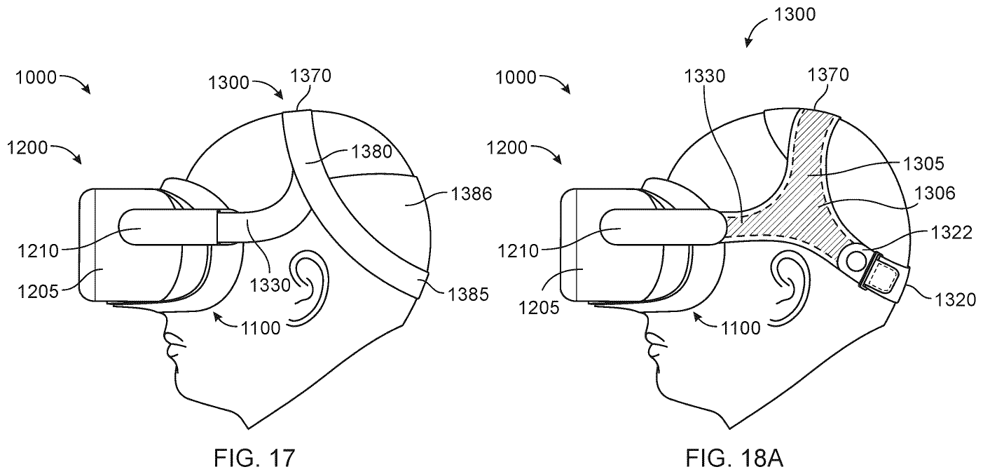

FIG. 17 is a lateral view of a head-mounted display system comprising a positioning and stabilising structure according to another example of the present technology worn by a user.

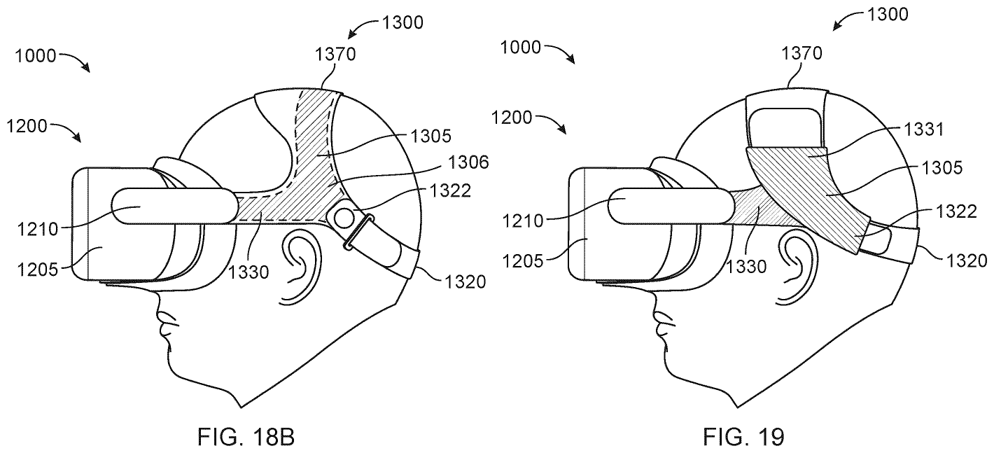

FIG. 18A is a lateral view of a head-mounted display system comprising a positioning and stabilising structure according to another example of the present technology worn by a user.

FIG. 18B is a lateral view of a head-mounted display system comprising a positioning and stabilising structure according to another example of the present technology worn by a user.

FIG. 19 is a lateral view of a head-mounted display system comprising a positioning and stabilising structure according to another example of the present technology worn by a user.

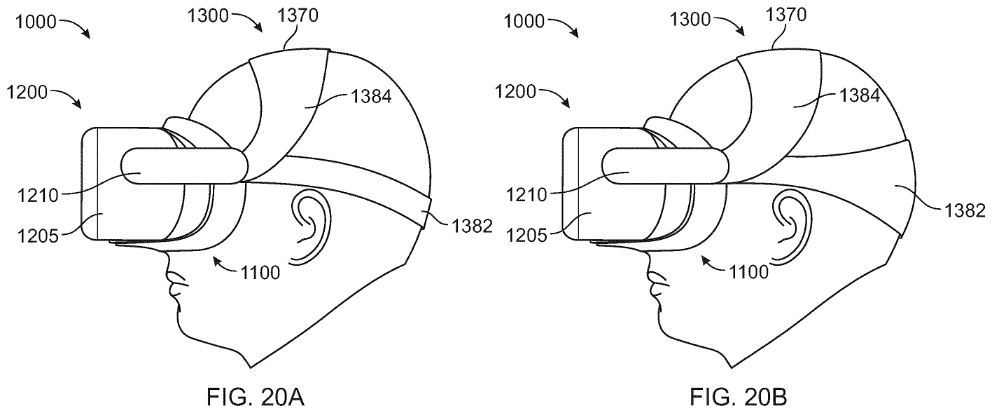

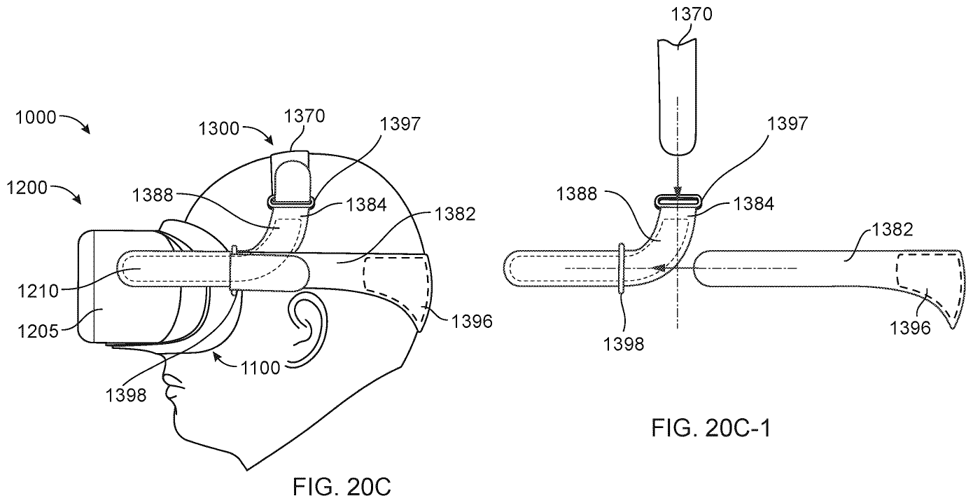

FIG. 20A is a lateral view of a head-mounted display system comprising a positioning and stabilising structure according to another example of the present technology worn by a user.

FIG. 20B is a lateral view of a head-mounted display system comprising a positioning and stabilising structure according to another example of the present technology worn by a user.

FIG. 20C is a lateral view of a head-mounted display system comprising a positioning and stabilising structure according to another example of the present technology worn by a user.

FIG. 20C-1 is a schematic illustration of a portion of the positioning and stabilising structure according to FIG. 20C.

### 5 DETAILED DESCRIPTION OF EXAMPLES OF THE TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further example.

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

### 5.1 Immersive Technologies

Immersive technologies may present a user with a combination of a virtual environment and the user's physical environment, or the real world. The user may interact with the resulting immersive or combined reality.

The device immerses the user by augmenting or replacing stimuli associated with one of the user's five senses with a virtual stimuli. Typically this is a virtual stimuli, although there could be additional stimuli that augment or replace stimuli associated with one of the additional four senses.

In some forms, a particular immersive technology may present a user with a combination of a virtual environment and the user's environment. At least a portion of the resulting environment may include a virtual environment. In some examples, the entire resulting environment may be a virtual environment (e.g., meaning the user's environment may be block from view or otherwise obstructed). In other forms, at least a portion of the user's physical environment may still be visually observable.

In some forms, the user may use different types of immersive technologies, which may include, but are not limited to, virtual reality (VR), augmented reality (AR), or mixed reality (MR). Each type of immersive technology may present the user with a different environment and/or a different way to interact with the environment.

In some forms, a display system may be used with each type of immersive technology. A display screen of the display system may provide a virtual environment component to the combination environment (i.e., the combination of the virtual and user's environments). In certain forms, the display screen may be an electronic screen.

In at least some types of immersive technologies (e.g., VR, AR, MR, etc.), positioning and stabilizing the electronic screen may be useful in operating a respective device. For example, the user may desire the electronic screen to be positioned close enough to their eyes to allow for easy viewing, but far enough away so as not to cause discomfort. Additionally, the electronic screen may need to be spaced far enough away so that users may simultaneously wear corrective lenses, like glasses. In addition, users may seek to maintain the orientation of the electronic screen relative to their eyes. In other words, users who walk, or otherwise move, while using these devices may not want the device to bounce or otherwise move on their head (e.g., particularly relative to their eyes), as this may cause dizziness and/or discomfort to the user. Therefore, these devices may be supported snuggly against the user's head in order to limit relative movement between the user's eyes and the device.

In one form, the present technology comprises a method for using a VR device comprising supporting the device on the user's head proximate to at least one of the user's eyes, and within the user's line of sight.

In certain examples of the present technology, a head-mounted display unit is supported in front of both of the user's eyes in order to block, obstruct, and/or limit ambient light from reaching the user's eyes.

Any features disclosed below in the context of a device configured for VR are to be understood as being applicable to devices configured for AR, unless the context clearly requires otherwise. Likewise features disclosed below in the context of a device configured for AR are to be understood as being applicable to devices configured for VR, unless the context clearly requires otherwise. For the avoidance of doubt, a feature disclosed in the context of a device that does not have a transparent display, through which the user can view the real world, is to be understood as being applicable to a device having such a transparent display unless the context clearly requires otherwise. Likewise a feature disclosed in the context of a device that has a transparent display, through which the real-world can be viewed, is to be understood to be applicable to a device in which the display is electronic and through which the real-world cannot be viewed directly through a transparent material.

### 5.2 Virtual Reality Display System

As shown in FIGS. 4A and 4B, a display apparatus, display system, display interface or head-mounted display system 1000 in accordance with one aspect of the present technology comprises the following functional aspects: an interfacing structure 1100, a head-mounted display unit 1200, and a positioning and stabilizing structure 1300. In some forms, a functional aspect may provide one or more physical components. In some forms, one or more physical components may provide one or more functional aspects. The head-mounted display unit 1200 may comprise a display. In use, the head-mounted display unit 1200 is arranged to be positioned proximate and anterior to the user's eyes, so as to allow the user to view the display.

In other aspects, the head-mounted display system 1000 may also include a display unit housing 1205, an optical lens 1240, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.2.1 Head-Mounted Display Unit

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, an interfacing structure 1100, and/or an optical lens 1240. These components may be permanently assembled in a single head-mounted display unit 1200, or they may be separable and selectively connected by the user to form the head-mounted display unit 1200. Additionally, the display screen 1220, the display unit housing 1205, the interfacing structure 1100, and/or the optical lens 1240 may be included in the head-mounted display system 1000, but may not be part of the head-mounted display unit 1200.

### 5.2.1.1 Display Screen

Some forms of the head-mounted display unit 1200 include a display, for example a display screen—not shown in FIG. 4B, but provided within the display housing 1205. The display screen may include electrical components that provide an observable output to the user.

In one form of the present technology, a display screen provides an optical output observable by the user. The optical output allows the user to observe a virtual environment and/or a virtual object.

The display screen may be positioned proximate to the user's eyes, in order to allow the user to view the display screen. For example, the display screen may be positioned anterior to the user's eyes. The display screen can output computer generated images and/or a virtual environment.

In some forms, the display screen is an electronic display. The display screen may be a liquid crystal display (LCD), or a light emitting diode (LED) screen.

In certain forms, the display screen may include a backlight, which may assist in illuminating the display screen. This may be particularly beneficial when the display screen is viewed in a dark environment.

In some forms, the display screen may extend wider a distance between the user's pupils. The display screen may also be wider than a distance between the user's cheeks.

In some forms, the display screen may display at least one image that is observable by the user. For example, the display screen may display images that change based on predetermined conditions (e.g., passage of time, movement of the user, input from the user, etc.).

In certain forms, portions of the display screen may be visible to only one of the user's eyes. In other words, a portion of the display screen may be positioned proximate and anterior to only one of the user's eyes (e.g., the right eye), and is blocked from view from the other eye (e.g., the left eye).

In one example, the display screen may be divided into two sides (e.g., a left side and a right side), and may display two images at a time (e.g., one image on either side).

Each side of the display screen may display a similar image. In some examples, the images may be identical, while in other examples, the images may be slightly different.

Together, the two images on the display screen may form a binocular display, which may provide the user with a more realistic VR experience. In other words, the user's brain may process the two images from the display screen 1220 together as a single image. Providing two (e.g., un-identical) images may allow the user to view virtual objects on their periphery, and expand their field of view in the virtual environment.

In certain forms, the display screen may be positioned in order to be visible by both of the user's eyes. The display screen may output a single image at a time, which is viewable by both eyes. This may simplify the processing as compared to the multi-image display screen.

### 5.2.1.2 Display Housing

In some forms of the present technology as shown in FIGS. 4A and 4B, a display unit housing 1205 provides a support structure for the display screen, in order to maintain a position of at least some of the components of the display screen relative to one another, and may additionally protect the display screen and/or other components of the head-mounted display unit 1200. The display unit housing 1205 may be constructed from a material suitable to provide protection from impact forces to the display screen. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic.

In certain forms, the rigid or semi-rigid material may be at least partially covered with a soft and/or flexible material (e.g., a textile, silicone, etc.). This may improve biocompatibility and/or user comfort because the at least a portion of the display unit housing 1205 that the user engages (e.g., grabs with their hands) includes the soft and/or flexible material.

A display unit housing 1205 in accordance with other forms of the present technology may be constructed from a soft, flexible, resilient material, such as silicone rubber.

In some forms, the display unit housing 1205 may have a substantially rectangular or substantially elliptical profile. The display unit housing 1205 may have a three-dimensional shape with the substantially rectangular or substantially elliptical profile.

In certain forms, the display unit housing 1205 may include a superior face 1230, an inferior face 1232, a lateral left face 1234, a lateral right face 1236, and an anterior face 1238. The display screen 1220 may be held within the faces in use.

In certain forms, the superior face 1230 and the inferior face 1232 may have substantially the same shape.

In one form, the superior face 1230 and the inferior face 1232 may be substantially flat, and extend along parallel planes (e.g., substantially parallel to the Frankfort horizontal in use).

In certain forms, the lateral left face 1234 and the lateral right face 1236 may have substantially the same shape.

In one form, the lateral left face 1234 and the lateral right face 1236 may be curved and/or rounded between the superior and inferior faces 1230, 1232. The rounded and/or curved faces 1234, 1236 may be more comfortable for a user to grab and hold while donning and/or doffing the head-mounted display system 1000.

In certain forms, the anterior face 1238 may extend between the superior and inferior faces 1230, 1232. The anterior face 1238 may form the anterior most portion of the head-mounted display system 1000.

In one form, the anterior face 1238 may be a substantially planar surface, and may be substantially parallel to the coronal plane, while the head-mounted display system 1000 is worn by the user.

In one form, the anterior face 1238 may not have a corresponding opposite face (e.g., a posterior face) with substantially the same shape as the anterior face 1238. The posterior portion of the display unit housing 1205 may be at least partially open (e.g., recessed in the anterior direction) in order to receive the user's face.

In some forms, the display screen is permanently integrated into the head-mounted display system 1000. The display screen may be a device usable only as a part of the head-mounted display system 1000.

In some forms, the display unit housing 1205 may enclose the display screen, which may protect the display screen and/or limit user interference (e.g., moving and/or breaking) with the components of the display screen.

In certain forms, the display screen may be substantially sealed within the display unit housing 1205, in order to limit the collection of dirt or other debris on the surface of the display screen, which could negatively affect the user's ability to view an image output by the display screen. The user may not be required to break the seal and access the display screen, since the display screen is not removable from the display unit housing 1205.

In some forms, the display screen is removably integrated into the head-mounted display system 1000. The display screen may be a device usable independently of the head-mounted display system 1000 as a whole. For example, the display screen may be provided on a smart phone, or other portable electronic device.

In some forms, the display unit housing 1205 may include a compartment. A portion of the display screen may be removably receivable within the compartment. For example, the user may removably position the display screen in the compartment. This may be useful if the display screen performs additional functions outside of the head-mounted display unit 1200 (e.g., is a portable electronic device like a cell phone). Additionally, removing the display screen from the display unit housing 1205 may assist the user in cleaning and/or replacing the display screen.

Certain forms of the display housing include an opening to the compartment, allowing the user to more easily insert and remove the display screen from the compartment. The display screen may be retained within the compartment via a frictional engagement.

In certain forms, a cover may selectively cover the compartment, and may provide additional protection and/or security to the display screen 1220 while positioned within the compartment.

In certain forms, the compartment may open on the superior face. The display screen may be inserted into the compartment in a substantially vertical direction while the display interface 1000 is worn by the user.

### 5.2.1.3 Interfacing Structure

As shown in FIGS. 4A and 4B, some forms of the present technology include an interfacing structure 1100 is positioned and/or arranged in order to conform to a shape of a user's face, and may provide the user with added comfort while wearing and/or using the head-mounted display system 1000.

In some forms, the interfacing structure 1100 is coupled to a surface of the display unit housing 1205.

In some forms, the interfacing structure 1100 may extent at least partially around the display unit housing 1205, and may form a viewing opening. The viewing opening may at least partially receive the user's face in use. Specifically, the user's eyes may be received within the viewing opening formed by the interfacing structure 1100.

In some forms, the interfacing structure 1100 in accordance with the present technology may be constructed from a biocompatible material.

In some forms, the interfacing structure 1100 in accordance with the present technology may be constructed from a soft, flexible, and/or resilient material.

In certain forms, the interfacing structure 1100 in accordance with the present technology may be constructed from silicone rubber and/or foam.

In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000.

In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 may comprise a single element. In some embodiments the interfacing structure 1100 may be designed for mass manufacture. For example, the interfacing structure 1100 may be designed to comfortably fit a wide range of different face shapes and sizes.

In some forms, the interfacing structure 1100 may include different elements that overlay different regions of the user's face. The different portions of the interfacing structure 1100 may be constructed from different materials, and provide the user with different textures and/or cushioning at different regions.

### 5.2.1.3.1 Light Shield

Some forms of the head-mounted display system 1000 may include a light shield that may be constructed from an opaque material and can block ambient light from reaching the user's eyes. The light shield may be part of the interfacing structure 1100 or may be a separate element. In some examples the interfacing structure 1100 may form a light shield by shielding the user's eyes from ambient light, in addition to providing a comfortable contacting portion for contact between the head-mounted display 1200 and the user's face. In some examples a light shield may be formed from multiple components working together to block ambient light.

In certain forms, the light shield can obstruct ambient light from reaching an eye region, which may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween.

In one form, the light shield may not contact the user's face around its entire perimeter. For example, the light shield may be spaced from the user's nasal rigid. The width of this spacing may be substantially small, so as to substantially limit the ingress of ambient light. However, the user's nasal ridge may be sensitive and easily irritated. Thus, avoiding direct contact with the user's nasal ridge may improve user comfort while wearing the head-mounted display system 1000.

In certain forms, the light shield may be a portion of the display unit housing 1205, and may be integrally or removably coupled to the display unit housing 1205. In one form, if the display unit housing 1205 is usable with a display screen outputting AR or MR, and VR, the light shield may be removable from the display unit housing 1205, and only coupled to the display unit housing 1205 while using VR.

### 5.2.1.3.1.1 Seal-Forming Structure

As shown in FIG. 4D, in one form of the present technology, the interfacing structure 1100 acts as a seal-forming structure, and provides a target seal-forming region. The target seal-forming region is a region on the seal-forming structure where sealing may occur. The region where sealing actually occurs—the actual sealing surface—may change within a given session, from day to day, and from user to user, depending on a range of factors including but not limited to, where the display unit housing 1205 is placed on the face, tension in the positioning and stabilizing structure 1300, and/or the shape of a user's face.

In one form the target seal-forming region is located on an outside surface of the interfacing structure 1100.

In some forms, the light shield may form the seal-forming structure and seal against the user's face.

In certain forms, the entire perimeter of the light shield or interfacing structure 1100 may seal against the user's skin, and can block ambient light from reaching an eye region. The eye region may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween.

When acting as a seal-forming structure, the light shield or interfacing structure 1100 may contact sensitive areas the user's face, like the user's nasal ridge. This contact may entirely prevent the ingress of ambient light. Sealing around the entire perimeter of the display unit housing 1205 may improve performance of the head-mounted display system 1000. Additionally, biocompatible materials may be selected so that direct contact with the user's nasal ridge does not significantly reduce user comfort while wearing the head-mounted display system 1000.

In certain forms of the present technology, a system is provided comprising more than one interfacing structure 1100, each being configured to correspond to a different size and/or shape range. For example the system may comprise one form of interfacing structure 1100 suitable for a large sized head, but not a small sized head and another suitable for a small sized head, but not a large sized head. The different interfacing structures 1100 may be removable and replaceable so that different users with different sized heads may use the same head-mounted display system 1000.

In some forms, the seal-forming structure may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween. This defined region may be an eye region.

In certain forms, this may seal around the user's eyes. The seal created by the seal-forming structure or interfacing structure 1100 may create a light seal, in order to limit ambient light from reaching the user's eyes.

### 5.2.1.3.2 Material Biocompatibility

Biocompatible materials are considered to be materials that undergo a full evaluation of their biological responses, relevant to their safety in use, according to ISO 10993-1 standard. The evaluation considers the nature and duration of anticipated contact with human tissues when in-use. In some forms of the present technology, the materials utilised in the positioning and stabilizing structure and interfacing structure may undergo at least some of the following biocompatibility tests: Cytotoxicity—Elution Test (MeM Extract): ANSI/AAMI/ISO 10993-5; Skin Sensitisation: ISO 10993-10; Irritation: ISO 10993-10; Genotoxicity—Bacterial Mutagenicity Test: ISO 10993-3; Implantation: ISO 10993-6.

### 5.2.1.4 Optical Lenses

As shown in FIG. 4B, at least one lens 1240 may be disposed between the user's eyes and the display screen 1220. The user may view an image provided by the display screen 1220 through the lens 1240. The at least one lens 1240 may assist in spacing the display screen 1220 away from the user's face to limit eye strain. The at least one lens 1240 may also assist in better observing the image being displayed by the display screen 1220.

In some forms, the lenses 1240 are Fresnel lenses.

In some forms, the lens 1240 may have a substantially frustoconical shape. A wider end of the lens 1240 may be disposed proximate to the display screen 1220, and a narrower end of the lens 1240 may be disposed proximate to the user's eyes, in use.

In some forms, the lens 1240 may have a substantially cylindrical shape, and may have substantially the same width proximate to the display screen 1220, and proximate to the user's eyes, in use.

In some forms, the at least one lens 1240 may also magnify the image of the display screen 1220, in order to assist the user in viewing the image.

In some forms, the head-mounted display system 1000 includes two lenses 1240 (e.g., binocular display), one for each of the user's eyes. In other words, each of the user's eyes may look through a separate lens positioned anterior to the respective pupil. Each of the lenses 1240 may be identical, although in some examples, one lens 1240 may be different than the other lens 1240 (e.g., have a different magnification).

In certain forms, the display screen 1220 may output two images simultaneously. Each of the user's eyes may be able to see only one of the two images. The images may be displayed side-by-side on the display screen 1220. Each lens 1240 permits each eye to observe only the image proximate to the respective eye. The user may observe these two images together as a single image.

In some forms, the posterior perimeter of each lens 1240 may be approximately the size of the user's orbit. The posterior perimeter may be slightly larger than the size of the user's orbit in order to ensure that the user's entire eye can see into the respective lens 1240. For example, the outer edge of the each lens 1240 may be aligned with the user's frontal bone in the superior direction (e.g., proximate the user's eyebrow), and may be aligned with the user's maxilla in the inferior direction (e.g., proximate the outer cheek region).

The positioning and/or sizing of the lenses 1240 may allow the user to have approximately 360° of peripheral vision in the virtual environment, in order to closely simulate the physical environment.

In some forms, the head-mounted display system 1000 includes a single lens 1240 (e.g., monocular display). The lens 1240 may be positioned anterior to both eyes (e.g., so that both eyes view the image from the display screen 1220 through the lens 1240), or may be positioned anterior to only one eye (e.g., when the image from the displace screen 1220 is viewable by only one eye).

### 5.2.1.4.1 Lens Mounting

The lenses 1240 may be coupled to a spacer positioned proximate to the display screen 1220 (e.g., between the display screen 1220 and the interfacing structure 1100), so that the lenses 1240 are not in direct contact with the display screen 1220 (e.g., in order to limit the lenses 1240 from scratching the display screen 1220).

For example, the lenses 1240 may be recessed relative to the interfacing structure 1100 so that the lenses 1240 are disposed within the viewing opening. In use, each of the user's eyes are aligned with the respective lens 1240 while the user's face is received within the viewing opening (e.g., an operational position).

In some forms, the anterior perimeter of each lens 1240 may encompass approximately half of the display screen 1220. A substantially small gap may exist between the two lenses 1240 along a center line of the display screen 1220. This may allow a user looking through both lenses 1240 to be able to view substantially the entire display screen 1220, and all of the images being output to the user.

In certain forms, the center of the display screen 1220 (e.g., along the center line between the two lenses 1240) may not output an image. For example, in a binocular display (e.g., where each side of the display screen 1220 outputs substantially the same image), each image may be spaced apart on the display screen 1220. This may allow two lenses 1240 to be positioned in close proximity to the display screen 1220, while allowing the user to view the entirety of the image displayed on the display screen 1220.

In some forms, a protective layer 1242 may be formed around at least a portion of the lenses 1240. In use, the protective layer 1242 may be positioned between the user's face and the display screen 1220.

In some forms, a portion of each lens 1240 may project through the protective layer 1242 in the posterior direction. For example, the narrow end of each lens 1240 may project more posterior than the protective layer 1242 in use.

In some forms, the protective layer 1242 may be opaque so that light from the display screen 1220 is unable to pass through. Additionally, the user may be unable to view the display screen 1220 without looking through the lenses 1240.

In some forms, the protective layer 1242 may be non-planar, and may include contours that substantially match contours of the user's face. For example, a portion of the protective layer 1242 may be recessed in the anterior direction in order to accommodate the user's nose.

In certain forms, the user may not contact the protective layer 1242 while wearing the head-mounted display system 1000. This may assist in reducing irritation from additional contact with the user's face (e.g., against the sensitive nasal ridge region).

### 5.2.1.4.2 Corrective Lenses

In some examples, additional lenses may be coupled to the lenses 1240 so that the user looks through both the lens 1240 and the additional lens in order to view the image output by the display screen 1220.

In some forms, the additional lenses are more posterior than the lenses 1240, in use. Thus, the additional lenses are positioned closer to the user's eyes, and the user looks through the additional lenses before looking through the lenses 1240.

In some forms, the additional lenses may have a different magnification than the lenses 1240.

In some forms, the additional lenses, may be prescription strength lenses. The additional lenses may allow a user to view the display screen 1220 without glasses, which may be uncomfortable to wear while using the head-mounted display system 1000. The additional lenses may be removable so that users that do not require the additional lenses may still clearly view the display screen 1220.

### 5.2.2 Positioning and Stabilizing Structure

As shown in FIGS. 4A and 4B, the display screen 1220 and/or the display unit housing 1205 of the head-mounted display system 1000 of the present technology may be held in position in use by the positioning and stabilizing structure 1300.

To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e., speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205.

In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side.

In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g., resiliently extensible. For example the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

In one form of the present technology, the positioning and stabilizing structure 1300 comprises a first tie, the first tie being constructed and arranged so that in use at least a portion of an inferior edge thereof passes superior to an otobasion superior of the user's head and overlays a portion of a parietal bone without overlaying the occipital bone.

In one form of the present technology, the positioning and stabilizing structure 1300 includes a second tie, the second tie being constructed and arranged so that in use at least a portion of a superior edge thereof passes inferior to an otobasion inferior of the user's head and overlays or lies inferior to the occipital bone of the user's head.

In one form of the present technology, the positioning and stabilizing structure 1300 includes a third tie that is constructed and arranged to interconnect the first tie and the second tie to reduce a tendency of the first tie and the second tie to move apart from one another.

In certain forms of the present technology, a positioning and stabilizing structure 1300 comprises a strap that is bendable and e.g., non-rigid. An advantage of this aspect is that the strap is more comfortable against a user's head.

In certain forms of the present technology, a positioning and stabilizing structure 1300 comprises a strap constructed to be breathable to allow moisture vapour to be transmitted through the strap,

In certain forms of the present technology, a system is provided comprising more than one positioning and stabilizing structure 1300, each being configured to provide a retaining force to correspond to a different size and/or shape range. For example the system may comprise one form of positioning and stabilizing structure 1300 suitable for a large sized head, but not a small sized head, and another. Suitable for a small sized head, but not a large sized head.

In some forms, the positioning and stabilizing structure 1300 may include cushioning material (e.g., a foam pad) for contacting the user's skin. The cushioning material may provide added wearability to the positioning and stabilizing structure 1300, particularly if positioning and stabilizing structure 1300 is constructed from a rigid or semi-rigid material.

### 5.2.2.1 Temporal Connectors

As shown in FIG. 4C, some forms of the head-mounted display system 1000 or positioning and stabilizing structure 1300 include temporal connectors 1250, each of which may overlay a respective one of the user's temporal bones in use. A portion of the temporal connectors 1250, in-use, are in contact with a region of the user's head proximal to the otobasion superior, i.e., above each of the user's ears. In some examples, temporal connectors are strap portions of a positioning and stabilising structure 1300. In other examples, temporal connectors are arms of a head-mounted display unit 1200. In some examples a temporal connector of a head-mounted display system 1000 may be formed partially by a strap portion (e.g., a lateral strap portion 1330) of a positioning and stabilising structure 1300 and partially by an arm 1210 of a head-mounted display unit 1200.

The temporal connectors 1250 may be lateral portions of the positioning and stabilizing structure 1300, as each temporal connector 1250 is positioned on either the left or the right side of the user's head.

In some forms, the temporal connectors 1250 may extend in an anterior-posterior direction, and may be substantially parallel to the sagittal plane.

In some forms, the temporal connectors 1250 may be coupled to the display unit housing 1205. For example, the temporal connectors 1250 may be connected to lateral sides of the display unit housing 1205. For example, each temporal connector 1250 may be coupled to a respective one of the lateral left face 1234 and the lateral right face 1236.

In certain forms, the temporal connectors 1250 may be pivotally connected to the display unit housing 1205, and may provide relative rotation between each temporal connector 1250, and the display unit housing 1205.

In certain forms, the temporal connectors 1250 may be removably connected to the display unit housing 1205 (e.g., via a magnet, a mechanical fastener, hook and loop material, etc.).

In some forms, the temporal connectors 1250 may be arranged in-use to run generally along or parallel to the Frankfort Horizontal plane of the head and superior to the zygomatic bone (e.g., above the user's cheek bone).

In some forms, the temporal connectors 1250 may be positioned against the user's head similar to arms of eye-glasses, and be positioned more superior than the anti-helix of each respective ear.

In some forms, the temporal connectors 1250 may have a generally elongate and flat configuration. In other words, each temporal connector 1250 is far longer and wider (direction from top to bottom in the paper plane) than thick (direction into the paper plane).

In some forms, the temporal connectors 1250 may each have a three-dimensional shape which has curvature in all three axes (X, Y and Z). Although the thickness of each temporal connector 1250 may be substantially uniform, its height varies throughout its length. The purpose of the shape and dimension of each temporal connector 1250 is to conform closely to the head of the user in order to remain unobtrusive and maintain a low profile (e.g., not appear overly bulky).

In some forms, the temporal connectors 1250 may be constructed from a rigid or semi-rigid material, which may include plastic, hytrel (thermoplastic polyester elastomer), or another similar material. The rigid or semi-rigid material may be self-supporting and/or able to hold its shape without being worn. This can make it more intuitive or obvious for users to understand how to use the positioning and stabilizing structure 1300 and may contrast with a positioning and stabilizing structure 1300 that is entirely floppy and does not retain a shape. Maintaining the temporal connectors 1250 in the in-use state prior to use may prevent or limit distortion whilst the user is donning the positioning and stabilizing structure 1300 and allow a user to quickly fit or wear the head-mounted display system 1000.

In certain forms, the temporal connectors 1250 may be rigidizers, which may allow for a more effective (e.g., direct) translation of tension through the temporal connectors 1250 because rigidizers limit the magnitude of elongation or deformation of the arm while in-use.

In certain forms, the positioning and stabilizing structure 1300 may be designed so that the positioning and stabilizing structure 1300 springs ‘out of the box’ and generally into its in-use configuration. In addition, the positioning and stabilizing structure 1300 may be arranged to hold its in-use shape once out of the box (e.g., because rigidizers may be formed to maintain the shape of some or part of the positioning and stabilizing structure 1300). Advantageously, the orientation of the positioning and stabilizing structure 1300 is made clear to the user as the shape of the positioning and stabilizing structure 1300 is generally curved much like the rear portion of the user's head. That is, the positioning and stabilizing structure 1300 is generally dome shaped.

In certain forms, a flexible and/or resilient material may be disposed around the rigid or semi-rigid material of the temporal connectors 1250. The flexible material may be more comfortable against the user's head, in order to improve wearability and provide soft contact with the user's face. In one form, the flexible material is a textile sleeve at is permanently or removably coupled to each temporal connector 1250.

In one form, a textile may be over-moulded onto at least one side of the rigidizer. In one form, the rigidizer may be formed separately to the resilient component and then a sock of user contacting material (e.g., Breath-O-Prene™) may be wrapped or slid over the rigidizer. In alternative forms, the user contacting material may be provided to the rigidizer by adhesive, ultrasonic welding, sewing, hook and loop material, and/or stud connectors.

In some forms, the user contacting material may be on both sides of the rigidizer, or alternatively may only be on the user contacting side (e.g., the user contacting side) of the rigidizer to reduce bulk and cost of materials.

In some forms, the temporal connectors 1250 are constructed from a flexible material (e.g., a textile), which may be comfortable against the user's skin, and may not require an added layer to increase comfort.

### 5.2.2.2 Posterior Support Portion

As shown in FIG. 4C, some forms of the positioning and stabilizing structure 1300 may include a posterior support portion 1350 for assisting in supporting the display screen 1220 and/or the display unit housing 1205 (shown in FIG. 4B) proximate to the user's eyes. The posterior support portion 1350 may assist in anchoring the display screen and/or the display unit housing 1205 to the user's head in order to appropriately orient the display screen proximate to the user's eyes.

In some forms, the posterior support portion 1350 may be coupled to the display unit housing 1205 via the temporal connectors 1250.

In certain forms, the temporal connectors 1250 may be directly coupled to the display unit housing 1205 and to the posterior support portion 1350.

In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use.

In some forms, the posterior support portion 1350 may be a posterior portion of the positioning and stabilizing structure 1300. The posterior support portion 1350 may provide an anchoring force directed at least partially in the anterior direction.

In certain forms, the posterior support portion 1350 is the inferior-most portion of the positioning and stabilizing structure 1300. For example, the posterior support portion 1350 may contact a region of the user's head between the occipital bone and the trapezius muscle. The posterior support portion 1350 may hook against an inferior edge of the occipital bone (e.g., the occiput). The posterior support portion 1350 may provide a force directed in the superior direction and/or the anterior direction in order to maintain contact with the user's occiput.

In certain forms, the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205.

In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

### 5.2.2.3 Forehead Support

Some forms of the positioning and stabilizing structure 1300 may include a forehead support or frontal support portion 1360 configured to contact the user's head superior to the user's eyes, while in use. The positioning and stabilising structure 1300 shown in FIG. 5B includes a forehead support 1360. In some examples the positioning and stabilising structure 1300 shown in FIG. 4A may include a forehead support 1360. The forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205.

In some forms, the forehead support 1360 can be adjusted to allow the positioning and stabilizing structure 1300 to accommodate the shape and/or configuration of a user's face.

In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205.

In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support or posterior support portion that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

### 5.2.2.4 Adjustable Straps

As shown in FIG. 4C, portions of the positioning and stabilizing structure 1300 may be adjustable, in order to impart a selective tensile force on the display screen 1220 and/or the display unit housing 1205 in order to secure a position of the display screen 1220 and/or the display unit housing 1205.

In some forms, the display unit housing 1205 may include at least one loop or eyelet 1254 (as shown in FIG. 4B), and at least one of the temporal connectors 1250 may be threaded through that loop, and doubled back on itself. The length of the temporal connector 1250 threaded through the respective eyelet 1254 may be selected by the user in order to adjust the tensile force provided by the positioning and stabilizing structure 1300. For example, threading a greater length of the temporal connector 1250 through the eyelet 1254 may supply a greater tensile force.

In some forms, at least one of the temporal connectors 1250 may include an adjustment portion 1256 and a receiving portion 1258 (as shown in FIG. 4C). The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In certain forms, adjusting the position of the adjustment portion 1256 relative to the receiving portion 1258 may apply a posterior force to the display screen 1220 and/or the display unit housing 1205, and increase or decrease a sealing force of the light shield against the user's head (e.g., when the light shield acts as a seal-forming structure).

In certain forms, the adjustment portion 1256 may be constructed from a flexible and/or resilient material, which may conform to a shape of the user's head and/or may allow the adjustment portion to be threaded through the eyelet 1254. For example, the adjustment portion(s) 1256 may be constructed from an elastic textile, which may provide an elastic, tensile force. The remainder of the temporal connectors 1250 may be constructed from the rigid or semi-rigid material described above (although it is contemplated that additional sections of the temporal connectors 1250 may also be constructed from a flexible material).

### 5.2.2.4.1 Top Strap

In some forms, the positioning and stabilizing structure 1300 may include a top strap portion, which may overlay a superior region of the user's head. The head-mounted display system 1000 shown in FIG. 1A has a top strap portion, for example.

In some forms, the top strap portion may extend between an anterior portion of the head-mounted display system 1000 and a posterior region of the head-mounted display system 1000.

In some forms, the top strap portion may be constructed from a flexible material, and may be configured to compliment the shape of the user's head.

In certain forms, the top strap portion may be connected to the display unit housing 1205. For example, the top strap portion may be coupled to the superior face 1230. The top strap portion may also be coupled to the display unit housing 1205 proximate to a posterior end of the display unit housing 1205.

In certain forms, the top strap portion may be coupled to the forehead support 1360. For example, the top strap portion may be coupled to the forehead support 1360 proximate to a superior edge. The top strap portion may be connected to the display unit housing 1205 through the forehead support 1360.

In some forms, the top strap portion may be connected to the posterior support portion 1350. For example, the top strap portion may be connected proximate to a superior edge of the posterior support portion 1350.

In some forms, the top strap portion may overlay the frontal bone and the parietal bone of the user's head.

In certain forms, the top strap portion may extend along the sagittal plane as it extends between the anterior and posterior portions of the head-mounted display system 1000.

In certain forms, the top strap portion may apply a tensile force oriented at least partially in the superior direction, which may oppose the force of gravity.

In certain forms, the top strap portion may apply a tensile force oriented at least partially in the posterior direction, which may pull the interfacing structure 1100 toward the user's face (and supply a portion of the sealing force when the light shield acts as a seal-forming structure).

In some forms, the top strap portion may be adjustable in order to impart a selective tensile force on the display screen 1220 and/or the display unit housing 1205 in order to secure a position of the display screen 1220 and/or the display unit housing 1205.

In certain forms, the display unit housing 1205 and/or the forehead support 1360 (as the case may be) may include at least one loop or eyelet 1254, and the top strap portion may be threaded through that eyelet 1254, and doubled back on itself. The length of the top strap portion threaded through the eyelet 1254 may be selected by the user in order to adjust the tensile force provided by the positioning and stabilizing structure 1300. For example, threading a greater length of the top strap portion through the eyelet 1254 may supply a greater tensile force.

In some forms, the top strap portion may include an adjustment portion and a receiving portion. The adjustment portion may be positioned through the eyelet 1254, and may be coupled to the receiving portion (e.g., by doubling back on itself). The adjustment portion may include a hook material, and the receiving portion may include a loop material (or vice versa), so that the adjustment portion may be removably held in the desired position. In some examples, the hook material and the loop material may be Velcro.

### 5.2.2.5 Rotational Control

In some forms, the display unit housing 1205 and/or the display screen 1220 may pivot relative to the user's face while the user has donned the positioning and stabilizing structure. This may allow the user to see the physical environment while still wearing the user interface 1100. This may be useful for users who want to take a break for viewing the virtual environment, but do not wish to doff the positioning and stabilizing structure 1300.

In some forms, a pivot connection 1260 may be formed between a superior portion of the display unit housing 1205 and the positioning and stabilizing structure 1300. For example, the pivot connection 1260 may be formed on the superior face 1230 of the display unit housing 1205.

In certain forms, the pivot connection 1260 may be coupled to the forehead support 1360. The display unit housing 1205 may be able to pivot about an inferior edge of the forehead support 1360.

In one form, the temporal connectors 1250 may be coupled to the forehead support 1360 in order to allow the display unit housing 1205 to pivot.

In some forms, the pivot connection 1260 may be a ratchet connection, and may maintain the display unit housing 1205 in a raised position without additional user intervention.

### 5.2.3 Controller

As shown in FIG. 6, some forms of the head-mounted display system 1000 include a controller 1270 that can be engageable by the user in order to provide user input to the virtual environment and/or to control the operation of the head-mounted display system 1000. The controller 1270 can be connected to the head-mounted display unit 1200, and provide the user the ability to interact with virtual objects output to the user from the head-mounted display unit 1200.

### 5.2.3.1 Handheld Controller

In some forms, the controller 1270 may include a handheld device, and may be easily grasped by a user with a single hand.

In certain forms, the head-mounted display system 1000 may include two handheld controllers. The handheld controllers may be substantially identical to one another, and each handheld controller may be actuatable by a respective one of the user's hands.

In some forms, the user may interact with the handheld controller(s) in order to control and/or interact with virtual objects in the virtual environment.

In some forms, the handheld controller includes a button that may be actuatable by the user. For example, the user's fingers may be able to press the button while grasping the handheld controller.

In some forms, the handheld controller may include a directional control (e.g., a joystick, a control pad, etc.). The user's thumb may be able to engage the directional control while grasping the handheld controller.

In certain forms, the controller 1270 may be wirelessly connected to the head-mounted display unit 1200. For example, the controller 1270 and the head-mounted display unit 1200 may be connected via Bluetooth, Wi-Fi, or any similar means.

In certain forms, the controller 1270 and the head-mounted display unit 1200 may be connected with a wired connection.

### 5.2.3.2 Fixed Controller

In some forms, at least a portion of the controller 1270 may be integrally formed on the display unit housing 1205.

In some forms, the controller 1270 may include control buttons that are integrally formed on the display unit housing 1205. For example, the control buttons may be formed on the superior face 1230 and/or the inferior face 1232, so as to be engageable by the user's fingers when holding the user's palm rests against the lateral left or right face 1234, 1236 of the display unit housing 1205. Control buttons may also be disposed on other faces of the display unit housing 1205.

In some forms, the user may interact with the control buttons in order to control at least one operation of the head-mounted display system 1000. For example, the control button may be an On/Off button, which may selectively control whether the display screen 1220 is outputting an image to the user.

In certain forms, the control buttons and the head-mounted display unit 1200 may be connected with a wired connection.

In some forms, the head-mounted display system 1000 may include both the handheld controller and the control buttons.

### 5.2.4 Speaker

With reference to FIG. 6, in some forms the head-mounted display system 1000 includes a sound system or speakers 1272 that may be connected to the head-mounted display unit 1200 and positionable proximate to the user's ears in order to provide the user with an auditory output.

In some forms, the speakers 1272 may be positionable around the user's ears, and may block or limit the user from hearing ambient noise.

In certain forms, the speakers 1272 may be wirelessly connected to the head-mounted display unit 1200. For example, the speakers 1272 and the head-mounted display unit 1200 may be connected via Bluetooth, Wi-Fi, or any similar means.

In some forms, the speaker 1272 includes a left ear transducer and a right ear transducer. In some forms, the left and right ear transducers may output different signals, so that the volume and or noise heard by the user in one ear (e.g., the left ear) may be different than the volume and or noise heard by the user in the other ear (e.g., the right ear).

In some forms, the speaker 1272 (e.g., the volume of the speaker 1272) may be controlled using the controller 1270.

### 5.2.5 Power Source

With reference to FIG. 6, some forms of the head-mounted display system 1000 may include an electrical power source 1274 can provide electrical power to the head-mounted display unit 1200 and any other electrical components of the head-mounted display system 1000.

In certain forms, the power source 1274 may include a wired electrical connection that may be coupled to an external power source, which may be fixed to a particular location.

In certain forms, the power source 1274 may include a portable battery that may provide power to the head-mounted display unit 1200. The portable battery may allow the user greater mobility than compared to a wired electrical connection.

In certain forms, the head-mounted display system 1000 and/or other electronic components of the head-mounted display system 1000 may include internal batteries, and may be usable without the power source 1274.

In some forms, the head-mounted display system 1000 may include the power source 1274 in a position remote from the head-mounted display unit 1200. Electrical wires may extend from the distal location to the display unit housing 1205 in order to electrically connect the power source 1274 to the head-mounted display unit 1200.

In certain forms, the power source 1274 may be coupled to the positioning and stabilizing structure 1300. For example, the power source 1274 may be coupled to a strap of the positioning and stabilizing structure 1300, either permanently or removably. The power supply 1274 may be coupled to a posterior portion of the positioning and stabilizing structure 1300, so that it may be generally opposite the display unit housing 1205 and/or the head-mounted display unit 1200. The weight of the power source 1274, and the weight of the head-mounted display unit 1200 and the display unit housing 1205 may therefore be spread throughout the head-mounted display system 1000, instead of concentrated at the anterior portion of the head-mounted display system 1000. Shifting weight to the posterior portion of the head-mounted display system 1000 may limit the moment created at the user's face, which may improve comfort and allow the user to wear the head-mounted display system 1000 for longer periods of time.

In certain forms, the power source 1274 may be supported by a user distal to the user's head. For example, the power source 1274 may connected to the head-mounted display unit 1200 and/or the display unit housing 1205 only through an electrical connector (e.g., a wire). The power source 1274 may be stored in the user's pants pocket, on a belt clip, or a similar way which supports the weight of the power source 1274. This removes weight that the user's head is required to support, and may make wearing the head-mounted display system 1000 more comfortable for the user.

In some forms, the head-mounted display unit 1200 may include the power source 1274. For example, the display unit 1220 may be a cell phone, or other similar electronic device, which includes an internal power source 1274.

### 5.2.6 Control System

With reference to FIG. 6, some forms of the head-mounted display system 1000 include a control system 1276 that assists in controlling the output received by the user. Specifically, the control system 1276 can control visual output from the display screen 1220 and/or auditory output from the speakers 1272.

In some forms, the control system 1276 may include sensors that monitor different parameters (e.g., in the physical environment), and communicates measured parameters to a processor. The output received by the user may be affected by the measured parameters.

In some forms, the control system 1276 is integrated into the head-mounted display unit 1200. In other forms, the control system 1276 is housed in a control system support 1290 that is separate from, but connected to (e.g., electrically connected to) the head-mounted display unit 1200.

### 5.2.6.1 Power Source

In some forms, the control system 1276 may be powered by the power source 1274, which may be at least one battery used for powering components of the control system 1276. For example, sensors of the control system 1276 may be powered by the power source 1274.

In some forms, the at least one battery of the power source 1274 may be a low power system battery 1278 and a main battery 1280.

In certain forms, the low power system battery 1278 may be used to power a real time (RT) clock 1282 of the control system 1276.

### 5.2.6.1.1 Integrated Power Support Portion

In some forms, a battery support portion 1288 may support the low power system battery 1278 and/or the main battery 1280. The battery support portion 1288 may be directly supported on the head-mounted display system 1000.

In some forms, the battery support portion 1288 may be disposed within the display unit housing 1205.

In some forms, the battery support portion 1288 may be disposed on the positioning and stabilizing structure 1300. For example, the battery support portion 1288 may be coupled to the posterior support portion 1350. The weight of the head-mounted display system 1000 may be better balanced around the user's head. One form of a battery support portion 1288 is a battery pack housing, which will be described in more detail herein.

### 5.2.6.1.2 Remote Power Support Portion

In some forms, a battery support portion 1288 may support the low power system battery 1278 and/or the main battery 1280. The battery support portion 1288 may be coupled to the user independently of the positioning and stabilizing structure 1300 and/or the display unit housing 1205 (e.g., it may be coupled via a belt clip). The battery support portion 1288 also may be supported remote from the user's body (e.g., if the head-mounted display system 1000 receives power from a computer or video game console). A tether may couple the battery support portion 1288 to the control system 1276 and/or other electronics. The positioning of the battery support portion may improve comfort for the user, since the weight of the low power system battery 1278 and/or the main battery 1280 are not supported by the user's head.

### 5.2.6.2 Orientation Sensor

In some forms, the control system 1276 includes an orientation sensor 1284 that can sense the orientation of the user's body. For example, the orientation sensor 1284 may sense when the user rotates their body as a whole, and/or their head individually. In other words, the orientation sensor 1284 may measure an angular position (or any similar parameter) of the user's body. By sensing the rotation, the sensor 1284 may communicate to the display screen 1220 to output a different image.

In some examples, an external orientation sensor may be positioned in the physical environment where the user is wearing the head-mounted display system 1000. The external position sensor may track the user's movements similar to the orientation sensor 1284 described above. Using an external orientation sensor may reduce the weight required to be supported by the user.

### 5.2.6.2.1 Camera

In some forms, the control system 1276 may include at least one camera, which may be positioned to view the physical environment of the user.

In some forms, the orientation sensor 1284 is a camera, which may be configured to observe the user's physical environment in order to determine the orientation of the user's head (e.g., in what direction the user's head has tilted).

In some forms, the orientation sensor 1284 includes multiple cameras positioned throughout the head-mounted display system 1000 in order to provide a more complete view of the user's physical environment, and more accurately measure the orientation of the user's head.

In some forms, the cameras 1284 are coupled to the anterior face 1238 of the display unit housing 1205. The cameras 1284 may be positioned in order to in order to provide a “first-person” view.

In certain forms, the display screen 1220 may display the user's physical environment by using the cameras 1284, so that the user may feel as though they are viewing their physical environment without assistance from the head-mounted display system 1000 (i.e., the first person view). This may allow the user to move around their physical environment without removing the head-mounted display system 1000.

In one form, virtual objects may be displayed while the display screen 1220 is displaying the user's physical environment. The cameras 1284 may allow the head-mounted display system 1000 to operate as an MR device. The control system 1276 may include a control to switch operation between a VR device and an MR device.

### 5.2.6.3 Eye Sensor

In some forms, the control system 1276 may include an eye sensor that can track movement of the user's eyes. For example, the eye sensor may be able to measure a position of at least one of the user's eyes, and determine which direction at least one of the user's eyes are looking.

In some forms, the control system 1276 may include two eye sensors. Each sensor may correspond to one of the user's eyes.

In some forms, the eye sensors may be disposed in or proximate to the lenses 1240.

In some forms, the eye sensors may measure an angular position of the user's ears in order to determine the visual output from the display screen 1220.

### 5.2.6.4 Processing System

In some forms, the control system 1276 includes a processing system that may receive the measurements from the various sensors of the control system 1276.

In some forms, the processing system may receive measurements recorded by the orientation sensor 1284 and/or the eye sensors. Based on these measured values, the processor can communicate with the display screen 1220 in order to change the image being output. For example, if the user's eyes and/or the user's head pivots in the superior direction, the display screen 1220 may display a more superior portion of the virtual environment (e.g., in response to direction from the processing system).

### 5.3 Augmented Reality Display Interface

As shown in FIGS. 5A and 5B, a display apparatus or head-mounted display system 1000 in accordance with one aspect of the present technology comprises the following functional aspects: a display screen 1220 configured for augmented reality, a display unit housing 1205, and a positioning and stabilizing structure 1300. In some forms, a functional aspect may provide one or more physical components. In some forms, one or more physical components may provide one or more functional aspects. In use, the display screen 1220 is arranged to be positioned proximate and anterior to the user's eyes, so as to allow the user to view the display screen 1220.

In other aspects, the head-mounted display system 1000 may also include an interfacing structure 1100, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.4 Positioning and Stabilising Structures

FIGS. 7A-20C show positioning and stabilising structures 1300 and head-mounted display systems 1000 comprising positioning and stabilising structures 1300. The positioning and stabilising structures 1300 disclosed herein may be constructed and arranged in particular for use in head-mounted display systems 1000 for use in VR. However, it is to be understood that the positioning and stabilising structures 1300 and head-mounted display systems 1000 described herein, or individual features thereof, may be applied in any of VR, MR, AR or other artificial reality. The head-mounted display system 1000 may otherwise have any of the features, configurations, aspects, functions and the like as described elsewhere herein.

The head-mounted display systems 1000 shown throughout FIGS. 7A-20C may comprise a head-mounted display unit 1200 comprising a display unit housing 1205. The display unit housing 1205 may comprise a display. The display may be as described elsewhere herein or as known in the art. The head-mounted display unit 1200 may comprise an interfacing structure 1100 connected to the display unit housing 1205 and constructed and arranged to engage the user's face in use.

The positioning and stabilising structures 1300 shown in FIGS. 7A-20C are constructed and arranged to hold the head-mounted display unit 1200 in an operable position on the user's head in use (e.g., such that the display is positioned in a viewing position anterior to the user's eyes and such that the interfacing structure 1100 engages the user's face to form a light seal, such as at least in forehead, sphenoid and cheek regions of the user's face).

The interfacing structure 1100 may be configured to engage the user's face around a periphery of the user's eyes in use. The interfacing structure 1100 may be configured to engage the sides of the user's face lateral of the user's eyes and engage the user's forehead in use. The interfacing structure 1100 may engage the user's cheeks, the sides of the user's face lateral of the user's eyes and the user's forehead. The interfacing structure 1100 may engage the user's face at regions overlying the user's nose, maxilla, zygomatic bones, sphenoid bones and frontal bones. The interfacing structure 1100 may engage the user's face in regions shown in FIG. 4D, for example.

With reference to FIG. 7B, for example, the interfacing structure 1100 may comprise a face engaging flange 1118 structured and arranged to be provided around a periphery of an eye region of the user's face and configured to engage the user's face in use. The face engaging flange 1118 may be flexible and resilient. The face engaging flange 1118 may be formed from an elastomeric material, for example silicone or TPE. In some examples the interfacing structure 1100 comprises a cushion (not visible in the drawings). The cushion may be at least partially covered by the face engaging flange 1118. The cushion may be formed from foam, silicone, gel or another suitable cushion material or structure constructed to behave as a cushion. In some examples, the interfacing structure 1100 comprises a cushion but no face engaging flange 1118.

The interfacing structure 1100 may be configured to engage the user's face and resist compression when the head-mounted display unit 1200 is fastened securely to the user's face, while remaining comfortable to the user. The cushion (if present) may contribute to the resilience of the interfacing structure 1100. The interfacing structure 1100 may comprise a pair of cheek portions 1140 configured to engage the user's cheeks in use, a forehead portion 1175 configured to engage the user's forehead in use, and a pair of sphenoid portions 1170 located on respective lateral sides of the interfacing structure connecting between the forehead portion and the cheek portions and configured to engage the user's head proximate the sphenoid bone (see, e.g., FIG. 12E).

In some examples, the interfacing structure 1100 comprises a nasal portion 1180 between the cheek portions 1140. The nasal portion 1180 may be configured to engage the user's nose in use and may be configured to at least partially block light from reaching the user's eyes from the user's nose region (e.g., block light travelling via a path proximate the surfaces of the user's nose). The nasal portion 1180 may for example be configured to engage anterior, superior and/or lateral surfaces of the user's nose in use. The nasal portion 1180 may be attached to the cheek portions 1140.

### 5.4.1 Lateral Strap Portions and Top Strap Portion

FIG. 7A shows a positioning and stabilising structure 1300 according to an example of the present technology and FIG. 7B shows a head-mounted display system 1000 comprising the positioning and stabilising structure 1300 shown in FIG. 7A. The head-mounted display system 1000 comprises a head-mounted display unit 1200 comprising a display unit housing 1205 and an interfacing structure 1100.

The positioning and stabilising structure 1300 in this example comprises a pair of arms 1210 connected in use (e.g., fixedly attached or removably connected) to respective lateral sides of the display unit housing 1205 (e.g., to the housing and/or a pair of lateral support arms on the housing). The arms 1210 are in this example semi-rigid and are constructed and arranged to project posteriorly (e.g., in parallel at least along a portion of its length with the lateral support arms) from the display unit housing 1205 on respective lateral sides of the user's head in use. Anterior portions of the arms 1210 may include a connector 1208 (e.g., snap-fit connector) to facilitate removeable connection to the display unit housing 1205. The connector 1208 may be a plastic material adhered to the arm 1210 to form a one-piece structure. Each connector may include a flange 1209 to facilitate snap-fit connection to the housing unit. The connectors 1208 are elongate in the direction of the arms 1210 and are arranged to extend posteriorly from the housing unit along a portion of the arm.

The arms 1210 may be configured to resist bending about one or more axes and may therefore be described as rigidised or at least semi-rigid (i.e., semi-rigid or rigid). In this example, each arm 1210 comprises a posterior portion 1215 comprising a superior arm connection portion 1211 and an inferior arm connection portion 1212. The arms 1210 may comprise a textile outer layer and may be rigidised to be substantially rigid. In some examples the arms 1210 may comprise a substantially rigid component covered in a textile layer (e.g., textile on both sides or textile on one side). In some examples only a user-facing side of the arms comprises a textile layer.

In some examples each arm 1210 is at least partially covered by a textile sleeve. In some particular examples each arm 1210 is encapsulated within a textile sleeve. Partially or fully covering the arms 1210 may provide for comfortable contact between the arm 1210 and the user's head, may be aesthetically pleasing, may provide for a perception of comfort and may conceal or protect other components provided to the arms 1210, such as electronics, sensors, transducers or the like, or wiring running along an arm 1210 to a posterior battery pack or any other components.

The positioning and stabilising structure 1300 further comprises a top strap portion 1340 constructed and arranged to connect between each of the superior arm connection portions 1211 of the pair of arms 1210 (e.g., via posterior legs 1341 of the top strap portion 1340). In the example shown in FIGS. 7A and 7B, the top strap portion connects to the head-mounted display unit 1200 (e.g., via an anterior leg 1342 of the top strap portion 1340) in addition to each of the superior arm connection portions 1211 of the pair of arms 1210. The top strap portion 1340 is configured to apply a force to the head-mounted display unit 1200 in an at least partially superior direction which advantageously balances at least some of the weight of the head-mounted display unit 1200. The force applied by the top strap portion 1340 may also be applied in a partially posterior direction, which may advantageously help hold the head-mounted display unit 1200 against the user's face. In this example, the top-strap portion 1340 may be generally Y-shape. In other examples, the top strap portion 1340 connects only between the superior arm connection portions 1211 and not also to the head-mounted display unit 1200. In such an example, the top strap portion 1340 may overlie the parietal bones and/or frontal bone of the user's head in use and may be a superior transverse strap portion having any one or more features of a superior transverse strap portion described elsewhere herein.

The top strap portion 1340 may comprise a textile material. In some examples, the top strap portion 1340 may comprise a textile outer layer and a foam inner layer. The top strap portion 1340 may comprise a textile-foam laminate for example.

The positioning and stabilising structure 1300 further comprises an occipital strap portion 1320 constructed and arranged to connect between the inferior arm connection portions 1212 of the arms 1210 and engage a portion of the user's head overlying or lying inferior to an occipital region of the user's head in use, as shown in FIG. 7B. The occipital strap portion 1320 may be in tension in use and may apply a force to each arm 1210 in an at least partially posterior direction. This force may be transmitted through each arm 1210 to pull the head-mounted display unit 1200 in a partially posterior direction towards the user's face, which may advantageously provide for stable engagement between the interfacing structure 1100 and the user's face. The occipital strap portion 1320 may comprise a textile material. In some examples, the occipital strap portion 1320 may comprise a textile outer layer (on one or both sides) and a foam inner layer. The occipital strap portion 1320 may comprise a textile-foam laminate, for example.

The arms 1210 may be pivotably attached to the display unit housing 1205, which may advantageously allow the angle of head-mounted display unit 1200 to be adjusted to suit the user's particular anatomy. As shown in FIG. 7B, the arms 1210 may pivot relative to the display unit housing 1205 about axis 1203 such that the display unit housing is rotatable relative to the arms 1210 in the directions of arrows 1206. Alternatively, as described above, the arms 1210 may be attached to lateral support arms of the display unit housing and the lateral support arms may be pivotably connected to the remainder of the housing (e.g., about the same axis 1203). Thus, when the arms 1210 are connected to the lateral support arms of the display unit housing 1205, the arms 1210 will move along with the pivotal rotation of the lateral support arms.

The top strap portion 1340 may connect to the head-mounted display unit 1200 at a single location. The single location may be a medial location on the display unit housing 1200, for example. The single location may be aligned with the sagittal plane of the user's head in use. The top strap portion 1340 may be substantially Y-shaped, connected to two points (the superior arm connection portions 1211 of the arms 1210) proximate the posterior of the user's head and one point (on the head-mounted display unit 1200) anterior to the user's head in use.

The top strap portion 1340 may be permanently connected to the superior connection portions 1211 of the arms 1210. For example, the top strap portion 1340 may be sewn, welded (e.g., ultrasonic welded) or glued to the arms 1210 at the superior connection portions 1211, or may be permanently connected by another manner (e.g., permanent snap fit components). In other examples, the top strap portion 1340 may be removably connected to the arms 1210, for example by magnetic connectors or other suitable connectors.

The top strap portion 1340 or a portion thereof may be selectively adjustable in length (e.g., having a length that is able to be adjusted by the user as required, for example to achieve a good fit). When attached to the head-mounted display unit 1200, the top strap portion 1340 may pass through an eyelet on the head-mounted display unit 1200 and may be looped back and secured to itself, for example with a hook-and-loop connection. The user can then pull more or less of the top strap portion 1340 through the eyelet to adjust an effective length of the top strap portion 1340. Alternatively, the top strap portion 1340 may loop back after passing through the eyelet and may be secured to itself by another suitable connection, such as a slidable buckle or by attachment to one of a selection of domes or magnetic connection points. The domes may be protrusions that are configured to mate with corresponding structure disposed on the portion of the top strap portion 1340 that is looped back onto itself.

As illustrated in FIGS. 7A and 7B, the occipital strap portion 1320 comprises an occipital strap connector 1322 at one end of the occipital strap portion 1320 constructed and arranged to releaseably attach to a corresponding one of the inferior connection portions 1212 of the arms 1210. In other examples, the occipital strap portion 1320 may be permanently attached to the arms 1210.

However, in this particular example, the occipital strap connector 1322 is constructed and arranged to magnetically attach to the corresponding one of the inferior connection portions 1212. A magnetic connector may be particularly user friendly. The occipital strap portion 1320 may also be selectively adjustable in length (e.g., having a length that is able to be adjusted by the user as required, for example to achieve a good fit). The occipital strap portion 1320 may pass through an eyelet on the occipital strap connector 1322 and may be looped back and secured to itself, for example with a hook-and-loop connection. The user can then pull more or less of the occipital strap portion 1320 through the eyelet to adjust an effective length of the occipital strap portion 1320. Alternatively, the occipital strap portion 1320 may loop back after passing through the eyelet and may be secured to itself by another suitable connection, such as a slidable buckle or connection to one of a series of domes.

The top strap portion 1340, arms 1210 and occipital strap portion 1320 may together form a ring portion which engages and fits stably against posterior surfaces of the user's head. The ability to adjust the length of the occipital strap portion 1320, for example in the manner describe above, may advantageously allow the user to adjust the effective length/circumference of the ring portion and achieve a good (e.g., stable and comfortable) fit of the ring portion against the posterior surfaces of their head.

The combination of the magnetic connection between the occipital strap connector 1322 and the inferior connection portion 1212 of the arm 1210 and the selectively adjustable length of the occipital strap portion 1320 advantageously provides a set-and-forget adjustment and quick-connect arrangement. A user can adjust the length of the occipital strap portion 1320 once and then use the magnetic connector to quickly connect and disconnect the occipital strap portion 1320 during donning and doffing the head-mounted display system 1000 without having to readjust its length each time. This may be identified as a set-and-forget adjustable releaseable connection whereby the user only needs to make adjustments once, but can quickly release and reconnect the occipital strap portion 1320 from the arm 1210 during donning and doffing. The quick-connect/quick-disconnect arrangement may also advantageously allow users with long hair, for example in a ponytail, to easily don and doff the head-mounted display system 1000 by connecting the occipital strap portion 1320 underneath their hair rather than being required to feed their hair over the top of a strap portion.

In addition, or as an alternative, to an adjustable occipital strap portion 1320, in some examples, one or both of the arms 1210 may be formed in two parts releaseably connected to each other. The two parts of such an arm 1210 may be connected to each other (e.g., by a magnetic connection), to provide for quick and easy disconnection and reconnection during donning and doffing of the head-mounted display system 1000. Alternatively or additionally, one or both of the arms may be releaseably connected to the head-mounted display system 1000, to provide for quick connection and disconnection during donning and doffing or to enable the positioning and stabilising structure 1300 to be separated from the head-mounted display unit 1200 for cleaning, replacement, transport or the like. In further examples, the two parts of each arm 1210 may be moveably connected to each other. This may provide for size adjustment of the positioning and stabilising structure 1300. For example, a user with a larger head may adjust the length of the arms 1210 to increase a spacing between a posterior portion of the positioning and stabilising structure 1300 and the head-mounted display unit 1200.

In some examples, either or both of the inferior connection portions 1212 may be moveable relative to the respective arm 1210 to which it is connected. That is, one or both inferior connection portions 1212 may be movable relative to a remainder of the respective arm 1210. In some examples, one or both of the inferior connection portions 1212 may be slideable with respect to the remainder of the respective arm 1210. The inferior connection portions 1212 may be selectively adjustable in their positions with respect to other components of the head-mounted display system 1000, such as the head-mounted display unit 1200, the anterior portions of the arms 1210 or the superior connection portions 1211. An optimal location for each inferior connection portion 1212 may be proximate to the ear without contacting the ear, which may help the occipital strap portion 1320 engage the head in a low and stable position, which may help prevent the occipital strap portion from riding up in use. Movable inferior connection portions 1212 may enable each user to position the inferior connection portions 1212 at or close to the optimal location for the user's specific head shape and size.

The superior connection portion 1211 and the inferior connection portion 1212 of each arm 1210 may be spaced apart vertically from each other such that the inferior connection portion 1212 is closer to the Frankfort horizontal plane of the user's head than the superior connection portion 1211. The superior connection portion 1211 may be positioned proximate a superior portion of the user's head and the inferior connection portion 1211 may be positioned vertically proximate an eye level of the user's head. In some examples, the inferior connection portions 1211 are configured to be positioned superior to the otobasion superior of the user's head.

In some examples, the inferior connection portion 1212 may be spaced posteriorly from the superior connection portion 1211 in a horizontal direction. In some examples, the superior connection portion 1211 and the inferior connection portion 1212 may both be positioned posterior to the otobasion superior of the user's head.

Each arm 1210 may project posteriorly and curve towards a superior direction away from the display unit housing. In the illustrated example, the inferior connection portions 1212 are approximately at the same level in the superior-inferior axis as the connections of the arms 1210 to the display unit housing 1205. In an example, each arm 1210 may be narrower at an anterior location proximate its connection to the display unit housing 1205 and may be wider (in the superior-inferior axis) proximate the superior connection portion 1211 and the inferior connection portion 1212 to position the superior connection portion 1211 proximate a superior portion of the user's head in use (e.g., proximate a junction between the parietal bones and the frontal bone) and to position the inferior connection portion 1212 at an inferior and posterior portion of the user's head in use (e.g., proximate the occipital bone of the user's head in use). In some examples, such as the illustrated example, each arm 1210 widens in a posterior direction (e.g., gradually) (e.g., from a location aligned with a coronal plane intersecting each otobasion superior of the user's head).

Each arm 1210 may also curve medially to follow the shape of the user's head. Each arm 1210 may project posteriorly away from the display unit housing 1205 and curve medially proximate the posterior portion of the user's head.

In some examples, each arm 1210 may be structured to resist bending towards the superior and inferior directions and in some particular examples may be structured to allow for bending towards a medial direction to engage posteriorly-facing surfaces of the user's head. Advantageously, this may allow the arms 1210 to bend inwards to wrap around or “hug” the user's head in use for a secure and stable fit. A transverse cross section of each arm 1210 may have a height aligned substantially with the superior-inferior directions that is greater than a width aligned substantially with the medial-lateral directions. The relatively large height of the arm 1210 in cross section may provide a greater resistance to bending in superior and inferior directions as compared to the resistance to bending in a medial direction provided by the relatively smaller width of the arm 1210.

In some examples, the height of the cross section of each arm 1210 may be in the range of 15-30 mm while the width of the cross section may be in the range of 2-8 mm. The height may be 3-10 times as large as the width, in some particular examples. The actual dimensions may vary depending on the stiffness of the material(s) used to form the arms 1210 and the particular cross-sectional shape of each arm 1210. More generally, each arm may comprise a greater resistance to bending towards the superior and inferior directions than to bending towards a medial direction. Advantageously, the high stiffness to bending in the superior-inferior directions may allow the arms 1210 to support some of the weight of the head-mounted display unit 1200 while the low stiffness to bending medially allows the arms 1210 to conform to the curvature of the user's head.

In some examples, each arm 1210 comprises one or more hinges to facilitate bending of the respective arm to conform to the shape of the user's head. Such hinges may be formed by thinned portions of the arm 1210 and may act in addition to bending of non-hinge portions of the arm 1210.

In some examples, when the top strap portion 1340 is in tension, for example due to weight of the head-mounted display unit 1200 and/or shortening of the top strap portion 1340 by the user, the superior connection portions 1211 are urged towards the surface of the user's head. The top strap portion 1340 may pull the superior connection portions 1211 partially medially towards the surface of the user's head and in some examples into engagement with the user's head, or if the superior connection portions 1211 are already in contact with the user's head, the top strap portion 1340 may increase a force with which the superior connection portions 1211 are pulled against the user's head, in order to provide for a secure and stable fit.

Similarly, in some examples, when the occipital strap portion 1320 is in tension, for example when the occipital strap portion 1320 is tightened, the inferior connection portions 1212 may be urged towards the surface of the user's head. The occipital strap portion 1320 may pull the inferior connection portions 1212 partially medially towards the surface of the user's head and in some examples into engagement with the user's head, or if the inferior connection portions 1212 are already in contact with the user's head, the occipital strap portion 1320 may increase a force with which the inferior connection portions 1211 are pulled against the user's head, in order to provide for a secure and stable fit.

In some examples the occipital strap portion 1320 may be wider than shown in FIGS. 7A and 7B (the width being the length of the line or curve lying in the sagittal plane of the user's head produced by the occipital strap portion 1320 intersecting the sagittal plane when the user has donned the head-mounted display system 1000). A wider occipital strap portion 1320 may provide a low pressure on the user's head than a narrow occipital strap portion 1320, due to the greater surface area engaging the user's head. In some examples the occipital strap portion 1320 may be within the range of 25-50 mm wide, such as within the range of 30-40 mm wide, for example 35 mm wide.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

### 5.4.2 Ring Strap Portion

FIGS. 8A-9 show further examples of head-mounted display systems. FIGS. 8A and 8B show a head-mounted display system 1000 comprising a head-mounted display unit 1200 which may be as described with reference to FIGS. 7A-7B (or elsewhere herein). The head-mounted display unit 1200 may comprise a display unit housing 1205 comprising a display, and an interfacing structure 1100 connected to the display unit housing 1205 and constructed and arranged to engage the user's face in use.

As shown in FIGS. 8A-8B, the positioning and stabilising structure 1300 comprises a ring strap portion 1360. The ring strap portion 1360 is in this example constructed and arranged to lie on a path surrounding a posterosuperior region of the user's head, which may be known as the crown of the user's head. The ring strap portion 1360 may lie on a path over a superior region of the user's head, for example overlying the parietal bones proximate the frontal bone, lateral and posterior regions of the user's head, for example overlying the parietal bones proximate the temporal bones, and a posterior region of the user's head, for example overlying the occipital bone or overlying the parietal bones proximate the occipital bone.

The ring strap portion 1360 may surround a posterosuperior region of the user's head, as shown in FIG. 8B for example. The ring strap portion 1360 may lie on a path that is, e.g., continuously/steadily curved, without discrete/sudden changes in direction. In some examples, the ring strap portion 1360 may be semi rigid and/or may be structured to substantially hold an in-use shape when the head-mounted display system 1000 is not donned by the user. The ring strap portion 1360 may be configured to at least hold a partially round shape when not donned by the user, as opposed to being completely flaccid/floppy. The ring strap portion 1360, and, in some examples, substantially all of the positioning and stabilising structure 1300 (e.g., the ring strap portion 1360 and lateral strap portions 1330) may be at least sufficiently stiff (e.g., at least semi-rigid) to hold an in-use shape when not in use, and optionally may be sufficiently flexible to deform from an in-use shape under deliberate finger pressure alone.

The ring strap portion 1360 may be semi-rigid and formed from a textile and foam laminate material (e.g., textile covered foam) where the foam has increased rigidity as compared to the textile and therefore imparts rigidity to the ring strap portion 1360. Alternatively, the ring strap portion 1360 may have stiffness imparted by a rigidiser provided to the ring strap portion 1360 either internally or on a surface of the ring strap portion 1360. Such a rigidiser may have increased rigidity as compared to other materials of the ring strap portion thereby imparting rigidity to the ring strap portion. As described elsewhere in this disclosure, other strap portions may be provided with a rigidiser. The rigidisers may be formed from a plastic material (e.g., a thermoplastic material), or other suitable materials, in some examples. In some examples, the rigidiser is formed from Hytrel.

The ring strap portion 1360 may be structured to anchor in place against a posterosuperior region of the user's head such that the ring strap portion 1360 remains in place in use and substantially in an in-use shape in use. Because the posterosuperior region is convex and the ring strap portion 1360 engages the user's head surrounding a convex surface, when the ring strap portion 1360 is pulled against the posterosuperior portion by other strap portions of the positioning and stabilising structure 1300 the ring strap portion 1360 may become substantially immovable, providing for a stable engagement of the ring strap portion 1360 to the user's head. In some examples, the ring strap portion 1360 may comprise a small amount of elastic extensibility. A small amount of stretch may advantageously assist the ring strap portion 1360 to fit to the user's head snugly and securely although excessive stretch may result in excessive force applied to the user's head and/or may result in instability or movement of the positioning and stabilising structure 1300 in use.

In other examples the ring strap portion 1360 may be substantially inextensible. In some examples, the lateral strap portions 1330 are substantially inextensible. In other examples, the lateral strap portions 1330 may comprise portion(s) that are at least semi-rigid and/or substantially inextensible and other portion(s) that are elastic (e.g., relatively more elastic than the semi-rigid/inextensible portion(s)).

The ring strap portion 1360 in the example shown in FIGS. 8A and 8B forms a superior transverse strap portion 1370 constructed and arranged to engage a superior region of the user's head at or proximate a coronal plane aligned with each otobasion superior of the user's head. The ring strap portion 1360 further comprises an occipital strap portion 1320 being constructed and arranged to engage a region of the user's head overlying the occipital bone or overlying the parietal bones proximate occipital bone.

The positioning and stabilising structure 1300 in this example also comprises a pair of lateral strap portions 1330 connected to the ring strap portion 1360 and being constructed and arranged to connect to respective lateral sides of the head-mounted display unit 1200. The lateral strap portions 1330 may be in tension in use, which pulls the head-mounted display unit 1200 towards the user's face and pulls the ring strap portion 1360 against the posterosuperior region of the user's head, which causes the ring strap portion 1360 to be substantially fixed in place due to the convex shape of the surface of the user's head at the posterosuperior region.

The positioning and stabilising structure 1300 may be configured to partially resist angular change between the superior transverse strap portion 1370 and the occipital strap portion 1320 when the lateral strap portions 1330 are in tension. For example, the junction between the superior transverse strap portion 1370 and the occipital strap portion 1320 may be formed to have a sufficient stiffness to resist angular changes between the path of the superior transverse strap portion 1370 and the path of the occipital strap portion 1320 proximate the junction. Such a stiffness may be provided by material thickness or by the addition of stiffening components (e.g., rigidisers) or the like, by way of example only. The junction between the superior transverse strap portion 1370 and the occipital strap portion 1320 may be seamless. For example, the superior transverse strap portion 1370 and the occipital strap portion 1320 may be integrally formed at least at the junctions (although may be formed in segments elsewhere around the ring strap portion 1360. This may help to distribute tension in the lateral strap portions 1330 around the ring strap portion 1360 as a whole and may advantageously allow the ring strap portion 1360 to resist deformation and/or stretching due to transference of tension from the lateral strap portions 1330 and support some of the weight of the head-mounted display unit 1200 while remaining comfortable.

Other examples in which an upper rear strap is freely movable with respect to a low rear strap, while highly adjustable, may rely on higher forces exerted directly on the user's head under the straps to counter tension in the lateral side straps. Advantageously, the ring strap portion 1360 in the example shown in FIGS. 8A and 8B may distribute the force around the ring strap portion 1360 in the manner of “hoop stress” which may be found to be more comfortable by the user.

In the examples shown in FIGS. 8A and 8B, the lateral strap portions 1330 support at least some of the weight of the head-mounted display unit 1200 and may transfer some of the weight to the superior transverse strap portion 1370 and/or ring strap portion 1360 as a whole. In particular, the ring strap portion 1360 may support at least a majority of the weight of the head-mounted display unit 1200 via the lateral strap portions 1330. In some examples, the lateral strap portions 1330 and the superior transverse strap portion 1370 may support at least a majority of the weight of the head-mounted display unit 1200.

The lateral strap portions 1330 and superior transverse strap portion 1370 may support the weight of the head-mounted display unit 1200 by pulling it against the user's face snugly such that static friction and upwards components of normal forces exerted on the head-mounted display unit 1200 by the user's face counter the weight of the head-mounted display unit 1200. Additionally, or alternatively, the lateral strap portions 1330, anchored by their connections to the superior transverse strap portion 1370 as part of the ring strap portion 1360, may apply a partially superiorly directed force to the head-mounted display unit 1200 to counter at least some of the weight of the head-mounted display unit 1200. Each of the lateral strap portions 1330 may extend at least partially superiorly away from its respective connection to the head-mounted display unit 1200. For example, a posterior end portion (e.g., at the connection locations 1333 to the ring strap portion 1360) of the lateral strap 1330 portions may be positioned superiorly to an anterior end portion (e.g., at the connection point with the head-mounted display unit or arms 1210) of the lateral strap portions. This may result in tension in the lateral strap portions 1330 having a vertically upwards (e.g., superior) component to counter some of the weight.

In some examples, the lateral strap portions 1330 connect to the ring strap portion 1360 between (e.g., substantially midway between) the superior-most part of the ring strap portion 1360 and the inferior-most part of the ring strap portion 1360. As shown in the FIG. 8G example, the lateral strap portions 1330 connect proximate to but superiorly of a lateral midpoint around the ring strap portion 1360. The lateral strap portions 1330 may be positioned so as to be unlikely to contact the user's ears but may connect to the ring strap portion 1360 proximate to the user's ears. In some particular examples, the lateral strap portions 1330 may comprise rigidisers provided to the lateral strap portions 1330 and which extend posteriorly in use past the user's ear, optionally extending into the occipital strap portion. Discussed below with reference to FIGS. 8F-8I are examples in which the ring strap portion 1360 comprises a superior segment 1360a, a pair of lateral segments 1360b and an inferior segment 1360c.

In some examples the positioning and stabilising structure 1300 comprises semi-rigid portions (e.g., comprising rigidisers) in lateral strap portions 1330 and in the portions of the lateral segments 1360b which are inferior to the lateral strap portions 1330 in use. The positioning and stabilising structure 1300 may comprise a pair of rigidisers, each extending within a respective lateral strap portion 1330 and into a respect one of the portions of the lateral segments 1360b inferior to the lateral strap portions 1330. In some examples the lateral strap portions 1330 are semi-rigid.

In an example with reference to FIG. 8F-1, the lateral strap portions 1330 may comprise a layered arrangement including an inner (user-contacting) layer 1353 (e.g., textile material), a cushioning layer 1358 (e.g., foam, gel), a rigidiser layer 1359 (e.g., plastic, thermoplastic rigidiser), and an outer layer 1352 (e.g., textile material). In examples, the inner and outer textile layers may be a textile sleeve (e.g., a tubular knit textile). In other examples, the cushioning layer may be omitted. It will be appreciated that the layered structure described here may be used in any other strap portion described elsewhere in this disclosure as being rigidised or as having a rigidiser.

Each of the lateral strap portions 1330 may be selectively adjustable in length (e.g., having a length that is able to be adjusted by the user as required, for example to achieve a good fit). Each lateral strap portion 1330 may pass through a respective eyelet on the head-mounted display unit 1200 and may be looped back and secured to itself, for example with a hook-and-loop connection. In other examples, an arm including the eyelet may be part of the positioning and stabilising structure 1300 and configured for attachment to the display unit housing 1205. The user can then pull more or less of the lateral strap portion 1330 through the eyelet to adjust an effective length of the lateral strap portion 1330. Alternatively, each lateral strap portion 1330 may loop back after passing through an eyelet and may be secured to itself by another suitable connection, such as a slidable buckle or connection to one of a series of domes.

In the example shown in FIG. 8B, the head-mounted display unit 1200 comprises a pair of arms 1210 extending posteriorly from respective lateral sides of the display unit housing 1205. In other examples, the arms 1210 may be part of the positioning and stabilising structure 1300 and configured for attachment to the display unit housing 1205. It will be appreciated that the arms 1210 in any of the other illustrated examples herein, may be formed as part of the head-mounted display housing, or alternatively, may form part of the positioning and stabilising structure configured for attachment to the display unit housing. The lateral strap portions 1330 are each attached to a respective one of the arms 1210. In this particular example the lateral strap portions 1330 each pass through a respective guide 1213 located proximate a posterior end of a respective arm 1210 and then pass through an eyelet proximate an anterior end of the arm 1210 before looping back and securing to itself.

The arms 1210 may be pivotably attached to the display unit housing 1205, which may advantageously allow the angle of head-mounted display unit 1200 to be adjusted to suit the user's particular anatomy. The arms 1210 may be substantially rigid. For example, the arms 1210 may be formed of a rigid plastic material.

As indicated above, in some examples the lateral strap portions 1330 apply a force on the head-mounted display unit 1200 having a superiorly directed component. As shown in FIG. 8B, when the head-mounted display system 1000 is worn by the user, the lateral strap portions 1330 may connect to the ring strap portion 1360 at respective connection locations 1333 which are spaced superiorly from the arms 1210 (e.g. at the connection point of the arms with the head-mounted display unit). The connection locations 1333 may also be spaced superiorly with respect to the user's eyes in use. With this arrangement, the lateral strap portions 1330 when tensioned in use may pull the head-mounted display unit 1200 both posteriorly into engagement with the user's face as well as partially superiorly to take up some of the weight of the head-mounted display unit 1200, which may provide for a comfortable fit.

The positioning and stabilising structure 1300 further comprises a top strap portion 1340 in this particular example. The top strap portion 1340 is connected to the superior transverse strap portion 1370 and is constructed and arranged to connect to the head-mounted display unit, for example at a single location. The top strap portion 1340 may be aligned in use with the sagittal plane of the user's head and may apply a partially posterior and partially superior force to the head-mounted display unit 1200 to both pull the head-mounted display unit into engagement with the user's face and support some of the weight of the head-mounted display unit 1200 in use, providing for a stable and comfortable fit. The top strap portion 1340 may be selectively adjustable in length in the manner described with reference to FIGS. 7A-7B or elsewhere herein (e.g., by looping through an eyelet and securing to itself with a hook-and-loop or other suitable connection).

In some examples, the top strap portion 1340 is substantially non-rigid, such as floppy, flaccid or the like. In some examples the top strap portion 1340 is semi-rigid. In some examples, the top strap portion 1340 may be flexible, and in some examples the top strap portion may comprise a stiffness that is less than a stiffness of the superior transverse strap portion 1370, the lateral strap portions 1330 and/or the occipital strap portion 1320. It is to be understood that the top strap portion 1340 is optional.

FIG. 8E shows another example of a head-mounted display system 1000 similar to those shown in FIGS. 8A and 8B. In this particular example the top strap portion 1340 is connected to the occipital strap portion 1320 instead of to the superior transverse strap portion 1370. This may more evenly distribute the weight of the head-mounted display unit 1200 along the length of the top strap portion 1340 and thus over a larger area of the user's head which may enhance comfort. Additionally, the connection of the top strap portion 1340 with the occipital strap portion 1320 provides a connection location at a lower point on the user's head which may provide a more stable anchor for the top strap portion since the curved shape at the occiput may help the occipital strap portion stably engage and brace against the user's head rather than tend to slip or ride up the user's head when forces from the top strap portion 1340 are applied to the occipital strap portion 1320.

Another difference is that in this particular example the superior transverse strap portion 1370 is positioned proximate a coronal plane aligned with each otobasion superior of the user's head, but is spaced posteriorly from said coronal plane by a small amount. The superior transverse strap portion 1370 may still be aligned in the anterior-posterior directions with the user's ears, however. In this example the superior transverse strap portion 1370, occipital strap portion 1320 and lateral strap portions 1330 may be integrally formed. The superior transverse strap portion 1370 and the occipital strap portion 1320 form a ring strap portion 1360. The ring strap portion 1360 may be semi-rigid. The ring strap portion 1360 may be structured to substantially hold an in-use shape when the head-mounted display system 1000 is not donned by a user.

The ring strap portion 1360 may be semi-rigid and formed from a textile and foam laminate material (e.g., textile covered foam) where the foam has increased rigidity as compared to the textile and therefore imparts rigidity to the ring strap portion 1360. Alternatively, the ring strap portion 1360 may have stiffness imparted by a rigidiser provided to the ring strap portion 1360 either internally or on a surface of the ring strap portion 1360. Such a rigidiser may have increased rigidity as compared to other materials of the ring strap portion thereby imparting rigidity to the ring strap portion. The rigidiser may be formed from a plastic material (e.g., a thermoplastic material) in some examples. In some examples the rigidiser is formed from Hytrel.

In some examples, the positioning and stabilising structure 1300 does not comprise a top strap portion 1340.

FIGS. 8F-8H show a further example of a positioning and stabilising structure 1300 with similar components to the positioning and stabilising structure 1300 shown in FIGS. 8A and 8B. For example, the positioning and stabilising structure 1300 comprises lateral strap portions 1330, a ring strap portion 1360 comprising a superior transverse strap portion 1370 and an occipital strap portion 1320, and a top strap portion 1340. These components may be as described with reference to FIGS. 8A-8B and may function in the same way.

In FIGS. 8F-8H the positioning and stabilising structure 1300 is illustrated with the arms 1210 of the head-mounted display unit 1200 attached to the lateral strap portions 1330. In other examples, the arms 1210 may be part of the positioning and stabilising structure 1300 and configured for attachment to the display unit housing 1205. An arm 1210 is shown in isolation in FIG. 8M. Each arm 1210 may comprise one or more guides 1213a, 1213b configured to guide or at least help retain the respective lateral strap portion 1330 in position. With reference to FIG. 8M, the arms 1210 may each comprise a posterior guide 1213a and an anterior guide 1213b. Each lateral strap portion 1330 may pass through the posterior guide 1213a and then the anterior guide 1213b and then loop back and secure to itself, for example with a hook-and-loop connection. The end of each lateral strap portion 1330 may comprise a broken loop material configured to form a hook-and-loop connection with the non-user facing side of the lateral strap portion 1330. The broken loop material may be adhered or welded to an end portion of each lateral strap portion 1330. More or less of each lateral strap portion 1330 may be pulled through the guides 1213 before it is looped back and secured to itself, in order to adjust an effective length of the lateral strap portion 1330 (e.g., by bringing the arm 1210 closer or further away from the ring strap portion 1360).

In examples, each arm may be formed from a plastic material (e.g., polycarbonate or ABS) or any other suitable material.

In the example shown in FIGS. 8F-8H, the arms 1210 may have a sufficient length so as to facilitate stability of the head-mounted display system and to effectively transfer some of the weight of the head-mounted display unit 1200 to the ring strap portion 1360. The arms 1210 extend posteriorly from their connection points on the head-mounted display unit 1200 to locations proximate to and/or posterior to the posterior-most portions of the head-mounted display unit 1200 and interfacing structure 1100 (see the arms 1210 in the similar arrangements of FIGS. 8C and 8E).

Additionally, in this particular example, the arms 1210 each comprise the posterior guide 1213a described above, which is positioned proximate the end of the arm 1210. These features keep the length of the lateral strap portion 1330 between the ring strap portion 1360 and the ends of the arms 1210, e.g., a pivot arm length, short so that weight of the head-mounted display unit is transferred to the ring strap portion 1360. The arms 1210, which are rigid, help transfer the weight of the head-mounted display unit 1200 to the ring strap portion 1360. This may advantageously provide for a stable fit, especially during vigorous use of the head-mounted display system 1000.

Different strap portions may have different widths. In the example shown in FIGS. 8F-8H and 8I, a width of the occipital strap portion 1320 measured transversely to a length of the occipital strap portion 1320 is greater than a width of the superior transverse strap portion 1370 measured transversely to a length of the superior transverse strap portion 1370. The greater width in the occipital strap portion 1320 causes forces against the user's head to be applied over a larger surface area and thus may cause less pressure to be applied to the user's head. In examples where the occipital strap portion 1320 has a greater width than the superior transverse strap portion 1370, the occipital strap portion 1320 may have a lower pressure/force ratio as compared to the superior transverse strap portion 1370. In some examples the width of the occipital strap portion 1320 may be in the range of 30 mm-50 mm, for example 35-45 mm, for example 37-42 mm, such as 38 mm. In some examples the width of the superior transverse strap portion 1370 may be in the range of 20-40 mm, for example 25-35 mm, for example 28-33 mm, such as 31 mm.

Different strap portions may have different thicknesses. In the example shown in FIGS. 8F-8H, a thickness of the ring strap portion 1360 is greater than a thickness of the lateral strap portions 1330. In this particular example the thickness of the ring strap portion 1360 is greater than a thickness of the top strap portion 1340. In some examples, the thickness of the ring strap portion 1360 may be in the range of 6-10 mm, for example 7-9 mm, such as 8 mm. The thickness of either or each of the lateral strap portions 1330 and the top strap portion 1340 may be within the range of 2-6 mm, for example 3-5 mm, such as 4 mm. In other examples the top strap portion 1340 may have a thickness in the range of 2-4 mm, such as 2.5-3 mm, such as 2.7 mm.

Accordingly, the positioning and stabilising structure 1300 in the example shown in FIGS. 8G-8H comprises strap portions having a generous thickness and width, which may advantageously provide for high comfort levels and/or may provide space for components within the strap portions, such as electronics, sensors, transducers, cables, batteries, rigidisers, counterweights or the like. The strap portions may be formed from a plurality of layers, e.g., forming laminate structures. The generous thickness also helps the ring strap portion 1360 to hold its shape. While the ring strap portion 1360 and lateral strap portions 1330 may not be particularly extensible in length and while the ring strap portion 1360 may be sufficiently stiff that it holds its shape when not in use, the positioning and stabilising structure 1300 may be sufficiently flexible such that, in some particular examples, it is able to be donned by the user without disconnecting any strap portions from other strap portions or from the head-mounted display unit 1200. For example, a head-mounted display system 1000 with a positioning and stabilising structure 1300 as shown in FIGS. 8A-8B or in FIGS. 8F-8H, may be able to be donned by the user by pulling and/or stretching it over their head, for example in the same way they would put on a baseball cap.

FIGS. 8K and 8L show two example ring strap portion 1360 cross sections. These cross sections may alternatively be applied to other strap portions, such as the lateral strap portions 1330 or the top strap portion 1340, or any other strap portion of an example of a positioning and stabilising structure 1300 disclosed herein.

In the FIG. 8K example, the ring strap portion 1360 comprises an inner layer (1360(2), which may provide a majority, or substantially all, of the thickness of the strap, and which may be formed from foam, spacer fabric or the like. The inner layer may be covered by a user-facing layer 1360(1) configured to engage the user's head and a non-user facing layer 1360(3) configured to face away from the user's head. These layers may be formed from a textile material, for example. The user-facing layer and the non-user facing layer may be welded (e.g., RF or ultrasonic) at the edges to encapsulate the inner layer. In one example the overall thickness of the strap is 8 mm.

In the FIG. 8L example, the ring strap portion 1360 comprises two laminates joined at the edges. Each laminate may take the form of the laminate shown in FIG. 8K but with half the width of the overall strap (e.g., each laminate may have a thickness of 4 mm to produce a ring strap portion 1360 with a thickness of 8 mm. In some examples each of the two laminates forming the strap portion may comprise an inner layer 1360(2) formed from foam, spacer fabric or the like, and may comprise a single outer layer facing outwardly with respect to the strap. For example, one laminate may comprise a single user-facing layer 1360(1) and an inner layer 1360(2). The other laminate may comprise a single non-user facing layer 1360(3) and an inner layer 1360(2). The user-facing layer and the non-user facing layer may be formed from a textile material, for example. The two laminates may be jointed at the edges (e.g., by welding), but may not be joined in the middle, leaving space 1360(4) for a cable, electronics, rigidiser, or any other suitable and desired component to be provided. In some examples a flat cable, e.g., a ribbon cable or a cable with a flat cross section, may be provided between two layers forming a strap portion of the positioning and stabilising structure 1300.

In some examples, the entire positioning and stabilising structure 1300 is formed from machine washable components, such that the positioning and stabilising structure 1300 can be separated from the head-mounted display unit 1200 and washed in a washing machine, or at least hand washed easily without risk of damaging electronic components or components that cannot tolerate water. This may provide for a hygienic positioning and stabilising structure 1300. A further advantage of the ring strap portion 1360 as shown in various examples, such as those of FIGS. 8A-8H is that the ring strap portion 1360 provides a large opening for a user's hair, e.g., a bun, ponytail or long hair. The positioning and stabilising structure 1300 may be flexible enough to be comfortably flexed and/or stretched over a bun or ponytail during donning/setup and then may engage the user's head without interfering with the bun, ponytail, long hair or other hair feature.

In some examples of the present technology, the ring strap portion 1360 comprises a plurality of segments formed separately and joined together to form the ring strap portion 1360. The segments may or may not correspond directly to the superior transverse strap portion 1370 and the occipital strap portion 1320. In some examples, the ring strap portion 1360 may comprise two segments. In other examples, the ring strap portion 1360 may comprise three, four, five, six, seven or more segments.

As shown in FIGS. 8F-8H and 8I, in this particular example the ring strap portion comprises a superior segment 1360a, a pair of lateral segments 1360b and an inferior segment 1360c. The top strap portion 1340 may extend from the superior segment 1360a and the lateral strap portions 1330 may extend from respective lateral segments 1360b. FIG. 8I shows the positioning and stabilising structure 1300 in flattened form with the occipital strap portion 1320 split into two parts, showing the various segments and joint locations (but without illustrating the actual joints, e.g., no stitching is illustrated). In some examples, the inferior segment 1360c comprises a greater elasticity (e.g., lesser extension stiffness) than the lateral segments 1360b and/or the superior segment 1360a. In other examples, the superior segment 1360a comprises a greater elasticity than the inferior segment 1360c and/or the lateral segments 1360b. In further examples, the lateral segments 1360b comprise a greater elasticity than the superior segment 1360a and/or the inferior segment 1360c.

In some examples, the ring strap portion 1360 comprises a counterweight attached thereto. In some particular examples where the ring strap portion 1360 comprises an inferior segment 1360c, the inferior segment 1360c may comprise or form the counterweight, for example by having additional material added for weight or by having an additional component mounted thereto such as a battery pack. The provision of a counterweight to the inferior segment 1360c advantageously enables the counterweight to be positioned proximate the user's neck. Providing the counterweight close to the vertical axis of rotation of the user's head, e.g., at the neck as opposed to at the posterior-most location of the rounded posterior surface of the user's head, may limit the increase of moment of inertia that the counterweight adds to the head-mounted display system 1000, since the counterweight is positioned close to the axis of rotation. A low moment of inertia may be advantageous during vigorous movements of the user's head in use. In some examples the head-mounted display system 1000 may comprise two counterweights. The two counterweights may be provided to the occipital strap portion 1320 but may be spaced apart symmetrically across the sagittal plane. In some examples the two counterweights may be provided to respective inferior ends of the lateral segments 1360b, e.g., proximate to the inferior segment 1360c. In such an arrangement, the occipital strap portion 1320 may comprise elasticity proximate the sagittal plane.

Advantageously, forming the ring strap portion 1360 in segments may provide the ring strap portion 1360 with some amount of flexibility to conform to the shape of the user's head, as the joints between segments may function as hinges. The ring strap portion 1360 may otherwise be formed to be somewhat stiff, supporting itself substantially in an in-use shape when not donned by the user. The joints between the segments may also advantageously provide a cooling effect. The joints between the segments, and optionally between the segments and other strap portions, e.g., the top strap portion 1340 and/or lateral strap portions 1330, may be stitched, welded, glued or the like. In the example shown in FIGS. 8F-8H the segments and strap portions are stitched together.

In addition, in this particular example, a hinge 1361 may be created around the joint between the top strap portion 1340 and ring strap portion 1360 and around each joint between the lateral strap portion 1330 and ring strap portion 1360. FIG. 8J shows a detail view of a hinge 1361 proximate a lateral strap portion 1330. The hinges 1361 in these examples are created by a welding operation which heats and shrinks the strap proximate the joint. Each hinge 1361 may provide additional flexibility to the ring strap portion 1360 proximate the junction with the respective one of the lateral strap portions 1330 and top strap portion 1340. The hinges 1361 may be especially advantageous proximate the lateral strap portions 1330 as the lateral strap portions 1330 may be required to accommodate a relatively complex change in geometry to join between the arms 1210 and the ring strap portion 1340. Also, the hinges connecting the lateral strap portions 1360 may facilitate the positioning and stabilising structure in fitting different head sizes by allowing the lateral strap portions to pivot relative to the ring strap portion to adjust to the size of the user's head. The hinges 1361 may also help the top strap portion 1340 accommodate a change in geometry although in other examples there may be no hinge proximate the top strap portion 1340.

In either of the FIG. 8K or 8L examples, or in any other example in which the ring strap portion 1360 comprises a textile outer layer, the textile may be formed by knitting. The ring strap portion 1360 may comprise a textile outer layer having a stitch that substantially does not allow elastic extension (e.g., stretch) proximate the lateral strap portions 1330 but which allows at least some elastic extension at other locations around the ring strap portion 1360 (e.g., at superior and/or inferior locations). The textile material may be Nylon, polyester, or any other suitable material.

In some examples, lateral segments 1360b of the ring strap portion 1360 may comprise one or more textile layers having a stitch that substantially does not allow stretch. However, the superior segment 1360a and/or the inferior segment 1360c may comprise one or more textile layers that allow at least some elastic extension. In some examples the entire ring strap portion 1360 comprises one or more textile layers that are formed with a stitch that allows stretch in one direction but which does not allow stretch in a perpendicular direction. In such an example, the stitch may be aligned such that the stretchable direction is aligned substantially perpendicular to the length of the ring strap portion 1360 proximate the lateral strap portions 1330 but which is aligned substantially parallel to the length of the ring strap portion 1360 at superior and/or inferior locations around the ring strap portion 1360 to allow stretch in the ring strap portion 1360 but not proximate the lateral strap portions 1330, which may advantageously facilitate a stable fit.

In other examples, the entire ring strap portion 1360 may be formed as a single segment, e.g., one piece, of unitary construction.

FIGS. 8C and 8D show further examples of head-mounted display systems 1000 similar to that shown in FIGS. 8A and 8B. In these examples the positioning and stabilising structure 1300 does not comprise a top strap portion 1340. The lack of a top strap portion 1340 may provide an advantage in that the positioning and stabilising structure 1300 may be easier and/or more comfortable for a user with a large volume of hair to use and/or may be less likely to disturb a user's hair. Another difference is that in these examples the ring strap portion 1360 is wider in the superior transverse strap portion 1370 at a location intersecting the sagittal plane of the user's head (e.g., a superior and medial location) in use than at other locations around the ring strap portion 1360 (e.g., lateral locations or the posterior and medial location).

For example, the superior transverse strap portion 1370 comprises a greater width, at the location intersecting the sagittal plane, than at lateral portions of the superior transverse strap portion 1370 and a greater width than at the occipital strap portion 1320. The degree to which the superior transverse strap portion 1370 is wider than at other portions of the ring strap portion 1360 may vary. FIG. 8C shows an example in which the superior transverse strap portion 1370 is particularly wide proximate the sagittal plane, while FIG. 8D shows an example in which the superior transverse strap portion 1370 is less wide but still wider than other parts of the ring strap portion 1360. As shown in FIGS. 8C and 8D, the ring strap portion 1360 may have a width that gradually increases towards the superior transverse strap portion 1370 (e.g., the width may gradually increase from the occipital strap portion 1320 to the superior transverse strap portion 1370).

In both of the examples shown in FIGS. 8C and 8D the head-mounted display unit 1200 comprises arms 1210 projecting posteriorly from a display unit housing 1205, and the positioning and stabilising structure 1300 comprises lateral strap portions 1330 connecting to the arms 1210. In other examples, the arms 1210 may be part of the positioning and stabilising structure 1300 and configured for attachment to the display unit housing 1205. In the example shown in FIG. 8C the lateral strap portions 1330 reduce in width along their length from the ring strap portion 1360 towards the arms 1210. This creates a relatively wide and thus more stable connection area with the ring strap portion. In the example shown in FIG. 8D the lateral strap portions 1330 have substantially constant width. In the example shown in FIG. 8D the lateral strap portions 1330 curves superiorly away from the arms 1210 to connect to the ring strap portion 1360 at locations superior to the arms 1210 in use. The lateral strap portions 1330 may be selectively adjustable in length in the manner described with reference to FIGS. 8A-8B or elsewhere herein.

In further examples, the positioning and stabilising structures 1300 shown in FIGS. 8C and 8D may comprise a top strap portion 1340, for example substantially as described with reference to FIGS. 8A-8B or elsewhere herein.

The ring strap portions 1360 in FIGS. 8C and 8D may be semi-rigid and/or structured to substantially hold an in-use shape when not donned by the user, and may be as described with reference to FIG. 8A-8B or 8E, for example.

FIG. 9 shows another example of a positioning and stabilising structure 1300 similar to those shown in FIGS. 8C and 8D. In this example the ring strap portion 1360 comprises a greater width in the superior transverse strap portion 1370 proximate the sagittal plane of the user's head (e.g., in a medial location) compared to lateral locations such as proximate the occipital strap portion 1320. The superior transverse strap portion 1370 comprises an anterior edge and a posterior edge. In this particular example the anterior edge is more curved than the posterior edge to form the greater width at the medial location along the superior transverse strap portion 1370. The anterior edge curves anteriorly in lateral-to-medial directions. More particularly, the anterior edge first curves anteriorly along a lateral-to-medial direction and then curves back towards a medial direction proximate the sagittal plane of the user's head to form a rounded anterior edge. Thus, from relatively more lateral portions, the anterior edge curves anteriorly towards a medial portion of the superior transverse strap portion 1370. In this way, a medial portion of the superior transverse strap portion configured to engage at least proximate the sagittal plane of the user's head may form an anterior-most portion of the superior transverse strap portion. In further examples, the superior transverse strap portion 1370 may again curve anteriorly proximate the lateral strap portions 1330 to form a wider strap at the connection area with the lateral strap portions. The posterior edge may be substantially not curved anteriorly or posteriorly. The differences in curvature between the anterior edge and posterior edge may form the wider medial portion of the superior transverse strap portion 1370.

In some examples, such as those shown in FIGS. 8A-9, the superior transverse strap portion 1370 and the occipital strap portion 1320 are integrally formed. For example, the ring strap portion 1360 in some examples may comprise a seamless strap forming the superior transverse strap portion 1370 and the occipital strap portion 1320. The lateral strap portions 1330 and/or top strap portion 1340 may then be attached to the ring strap portion by sewing, welding (e.g., ultrasonic welding), gluing or by another suitable manner of connection.

The ring strap portion 1360 in FIG. 9 may be semi-rigid and/or structured to substantially hold an in-use shape when not donned by the user, and may be as described with reference to FIG. 8A-8B or 8E, for example.

The various strap portions in the positioning and stabilising structure 1300 shown in FIGS. 8A-9, such as the lateral strap portions 1330, top strap portion 1340, ring strap portion 1360 (e.g., superior transverse strap portion 1370 and occipital strap portion) may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330 and/or the ring strap portion 1360 to provide for additional stability.

### 5.4.3 Band Strap Portions

FIGS. 10A and 10B show head-mounted display systems 1000 each comprising a head-mounted display unit 1200 which may be as described with reference to FIGS. 7A-7B (or elsewhere herein). The head-mounted display unit 1200 may comprises a display unit housing 1205 comprising a display, and an interfacing structure 1100 connected to the display unit housing 1205 and being constructed and arranged to engage the user's face in use.

As shown in FIGS. 10A-10B, the positioning and stabilising structure 1300 in each of these examples comprises a band strap portion 1380. The band strap portion 1380 is in each of these examples constructed and arranged to encircle the user's head in use and engage a region of the user's head overlying the frontal bone and engage a region of the user's head overlying or lying inferior to the occipital bone. The band strap portion 1380 engages the user's head and provides an anchor to which other strap portions connect.

In the examples shown in FIGS. 10A-10B, the positioning and stabilising structure 1300 comprises a pair of lateral strap portions 1330 connected to the band strap portion 1380 at respective lateral sides of the user's head in use and being constructed and arranged to connect to respective lateral sides of the head-mounted display unit 1200. The lateral strap portions 1330 may be in tension in use to pull the head-mounted display unit 1200 into engagement with the user's face. The relatively immovable band strap portion 1380 provides an anchor from which the lateral strap portions 1330 may pull the head-mounted display unit 1200 towards the user's face.

The positioning and stabilising structure 1300 may further comprise an adjustment mechanism constructed and arranged to allow the user to selectively adjust the length of the band strap portion 1380. The band strap portion may have a pair of end portions that are connected to respective sides of the adjustment mechanism. The band strap portion may be considered to have two opposing sections each extending on opposite sides of the user's head and intersecting the sagittal plane at two locations (one location at a posterior portion of the user's head and one location at an anterior portion of the user's head). The adjustment mechanism may be configured to adjust an effective length of both sections of the band strap portion simultaneously and equally such that the head-mounted display unit remains in proper alignment for viewing when the length of the band strap portion is adjusted.

As illustrated in each of FIGS. 10A-10B for example, the adjustment mechanism comprises a dial adjustment mechanism 1390 comprising a dial 1392 which when turned adjusts the length of the band strap portion 1380. The dial 1392 may be a ratchet dial, for example. As illustrated, the dial 1392 is provided to the band strap portion 1380 in the region of the user's head overlying or lying inferior to the occipital bone. More particularly, the dial 1392 is aligned with the sagittal plane of the user's head in use (e.g., centred with respect to the user's head in use). In other examples, the dial 1392 may be provided elsewhere, for example at a side portion of the user's head.

In an example, as shown in FIG. 10B-1, the dial adjustment mechanism 1390 may comprise a rack and pinion assembly 1601. The dial 1392 may comprise a pinion 1602 meshed with a rack or a pair of racks connected to (e.g., within) the band strap portion 1380 such that rotation of the dial 1392 causes the racks to be pulled together or pushed apart to adjust the effective length of the band strap portion 1380.

In the illustrated example of FIG. 10B-1, the band strap portion 180 may include first and second end portions 1380(1), 1380(2) having racks 1604 extending therefrom. For example, a rack 1604 may extend from an upper portion of the first end portion 1380(1) and another rack 1604 may extend from a lower portion of the second end portion 1380(2), as those skilled in the art will understand. The pinion 1602 may be arranged to mesh with the racks 1604 of both the first and second end portions such that rotation of the pinion (via the dial 1392) will cause the end portions of the band strap portion to be pulled towards one another (e.g., in overlapping fashion) or pushed apart to adjust the effective length of the band strap portion 1380. When the dial is rotated, the length adjustment may be equal for both end portions 1380(1), 1380(2) of the band strap portion so that the head-mounted display unit remains in proper alignment for viewing by the user.

In other examples, the dial 1392 is connected to one or more wires, cables or the like which are connected to points on the band strap portion 1380. The wires or cables may be wound around a spool connected to the dial 1392 such that rotation of the dial 1392 causes more or less of the wires or cables to be wound around the spool, adjusting the effective length of the band strap portion 1380. The dial adjustment mechanism discussed here may be applicable to the dial adjustment mechanism in any other example of this disclosure.

In other examples, the adjustment mechanism does not comprise a dial and instead comprises another suitable mechanism such as a hook-and-loop connection, magnetic connector, connections between a plurality of domes and/or adjustable buckles or the like.

The band strap portion 1380 may be at least partially rigidised (e.g., at least semi-rigid) at the region of the user's head overlying or lying inferior to the occipital bone. This may provide for a stable fit around the back of the user's head. The band strap portion 1380 may comprise an internal rigidiser within external layers of the band strap portion 1380 or may comprise an external rigidiser, such as provided to a non-user facing side of the strap. In further examples the entire band strap portion 1380 is rigidised in this manner.

In the examples shown in FIGS. 10A-10B, the positioning and stabilising structure 1300 comprises a forehead pad 1395 attached to the band strap portion 1380 which is constructed and arranged to engage the user's forehead. The forehead pad 1395 may comprise a cushion, for example formed from foam, silicone, gel or the like and may provide for a comfortable engagement of the band strap portion 1380 to the user's forehead.

The positioning and stabilising structure 1300 in the illustrated examples comprises a top strap portion 1340 connected to the band strap portion 1380 proximate the user's forehead and constructed and arranged to connect to the head-mounted display unit 1200. The top strap portion 1340 may be constructed and arranged to connect to the head-mounted display unit 1200, for example at a single location. The top strap portion 1340 may be aligned in use with the sagittal plane of the user's head and may apply a partially posterior and partially superior force to the head-mounted display unit 1200 to both pull it into engagement with the user's face and support some of the weight of the head-mounted display unit 1200 in use, providing for a stable and comfortable fit. The top strap portion 1340 may be selectively adjustable in length in the manner described with reference to FIGS. 7A-7B or elsewhere herein (e.g., by looping through an eyelet and securing to itself with a hook-and-loop or other suitable connection).

In some examples, the positioning and stabilising structure 1300 does not comprise a top strap portion 1340.

The head-mounted display unit 1200 in the examples shown in FIGS. 10A-10B comprises a pair of arms 1210 provided to respective lateral sides of the head-mounted display unit 1200 and the lateral strap portions 1330 are attached to the arms 1210. In other examples, the arms 1210 may be part of the positioning and stabilising structure 1300 and configured for attachment to the display unit housing 1205. The arms 1210, their connection to the head-mounted display unit 1200 and the attachment of the lateral strap portions 1330 to the arms 1210 may be as described with reference to FIGS. 8A-8B.

The positioning and stabilising structure 1300 in the example shown in FIG. 10B further comprises a parietal strap portion 1310 constructed and arranged to engage a region of the user's head overlying the parietal bones. The parietal strap portion is connected to the band strap portion proximate the lateral strap portions 1330 and extends around a posterior portion of the user's head in spaced relation to an occipital portion of the band strap portion 1380. The parietal strap portion 1310 and the occipital portion of the band strap portion work together conforming to the shape at the posterior portion of the head at relatively high and low spaced locations thereby providing a stable engagement with the user's head. The parietal strap portion 1310 and the occipital portion of the band strap portion each functions to help stabilize the other making it less likely that either strap portion will slide in use in superior/inferior directions when both strap portions are present. The parietal strap portion 1310 may be elastically extendable to provide for a stable and comfortable fit for a range of users. In some examples the parietal strap portion 1310 is selectively adjustable by the user.

In some examples, such as the example shown in FIG. 10A, an anterior portion (e.g., forehead portion 1387) and a posterior portion (e.g., occipital portion 1320) of the band strap portion 1380 are integrally formed. For example, the band strap portion 1380 may comprise a seamless strap encircling the user's head and comprising a forehead portion and an occipital strap portion, save for any joint at the adjustment mechanism. The lateral strap portions 1330 and/or top strap portion 1340 may then be attached to the band strap portion by sewing, welding (e.g., ultrasonic welding), gluing or by another suitable manner of connection. In the FIG. 10A example, the lateral strap portions 1330 are also integrally formed with the band strap portion 1380. In the FIG. 10B example, the lateral strap portions 1330, parietal strap portion 1310 and posterior/occipital portion of the band strap portion 1380 are integrally formed, and the anterior/forehead portion of the band strap portion 1380 is attached by sewing, welding, gluing or another suitable manner of connection.

The various strap portions in the positioning and stabilising structure 1300 shown in FIGS. 10A and 10B such as the band strap portion 1380, lateral strap portions 1330, top strap portion 1340 and parietal strap portion 1310 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, parietal strap portion 1310 and/or the anterior portion of the band strap portion 1380 to provide for additional stability.

### 5.4.4 Pivotable Connection to Head-Mounted Display Unit

FIGS. 11A-11B show further examples of head-mounted display systems 1000. The positioning and stabilising structure 1300 of these examples are similar to those described with reference to FIGS. 10A and 10B. For example, the positioning and stabilising structure 1300 in each of the examples shown in FIGS. 11A-11B comprises a band strap portion 1380 constructed and arranged to encircle the user's head in use and engage a region of the user's head overlying the frontal bone and engage a region of the user's head overlying or lying inferior to the occipital bone. The band strap portion 1380 may form an occipital strap portion 1320 configured to engage the region overlying or lying inferior to the occipital bone. The band strap portion 1380 may fit snugly around the user's head in use. The positioning and stabilising structure 1300 further comprises a parietal strap portion 1310 similar to the example shown in FIG. 10B. Many features shared with the examples shown in FIGS. 10A and 10B will not be repeated and the following disclosure will focus on differences.

The band strap portion 1380 may comprise a textile outer layer, for example in the form of a textile sleeve, which may be knitted. The band strap portion 1380 may also comprise, or function as, a rigidiser. For example, the band strap portion 1380 may comprise a rigidiser layer, or a rigidiser member configured to resist deformation of the band strap portion 1380. The rigidiser layer or member may be formed from a thermoplastic elastomer, such as Hytrel, in some examples. The rigidiser may be inside of a textile sleeve. In one example, the band strap portion 1380 comprises a textile sleeved Hytrel rigidiser. The band strap portion 1380 may be partially flexible to conform to the shape of the user's head.

In the examples shown in FIGS. 11A and 11B, the head-mounted display unit 1200 is pivotably attached to the band strap portion 1380 at a pair of pivot connections 1381, to enable the head-mounted display unit 1200 to pivot about an axis aligned perpendicular to the sagittal plane of the user's head in use. In some examples, the head-mounted display unit 1200 may be configured to pivot for the purpose of adjusting its angle with respect to the positioning and stabilising structure 1300 to provide for a good fit to a particular user's head size and shape. In some examples, the head-mounted display unit 1200 may, additionally or alternatively, be configured to pivot between a viewing position in which the head-mounted display unit 1200 is positioned over the user's eyes and a non-viewing position in which the head-mounted display unit 1200 is positioned overlying the user's frontal bone. Advantageously this may allow the user to “flip up” the head-mounted display unit 1200 away from their eyes in order to view their real-world surroundings, take a break or the like without completely doffing the head-mounted display system 1000.

The pivot connections 1381 may be located proximate the mid-coronal plane of the user's head in use, as shown in FIGS. 11A-11B. In the example shown in FIG. 11A, the band strap portion 1380 comprises a pair of slots 1383 (e.g., linear slots) and the pivot connections 1381 are located within the slots 1383. The slots 1383 may allow the pivot connections 1381 to move with respect to the band strap portion 1380. Movement of the pivot connections 1381 may be in anterior-posterior directions (e.g., anterosuperior-posteroinferior directions). This may advantageously provide for further adjustability of the position and/or angle of the head-mounted display unit 1200 with respect to the positioning and stabilising structure 1300.

In particular examples, the pivot connections 1381 may enable the head-mounted display unit 1200 to move at least partially anteriorly during pivoting. As can be seen in FIG. 11A-1, this may facilitate movement of the head-mounted display unit 1200 from a viewing position to a non-viewing position, as an amount of anterior movement of the head-mounted display unit 1200 may be required for the head-mounted display unit to clear the user's forehead and/or the forehead portion 1387 of the band strap portion when moving to the non-viewing position. The head-mounted display unit 1200 may be able to move “up and away” from the user's eye region. The pivot connections 1381 may slide together such that the axis about which the head-mounted display unit 1200 pivots remains perpendicular to the sagittal plane of the user's head. During pivoting of the head-mounted display unit 1200 from the viewing position (FIG. 11A) to the non-viewing position (FIG. 11A-1), the pivot connections 1381 may move at least partially anteriorly within the slots 1383. The pivot connections 1381 may slide in a direction along the length of the band strap portion 1380 for example, which may be a partially anterior and partially superior direction.

In the non-viewing position, the head-mounted display unit 1200 may be positioned over the forehead portion 1387 of the band strap portion as shown in FIG. 11A-1, or, alternatively, the head-mounted display may be rotated further superiorly such that at least a majority of the head-mounted display is superior to the forehead portion 1387. In other examples, the slots 1383 may be curved (e.g., curved superiorly in the anterior direction) to facilitate movement to the non-viewing position. The upwardly curved slots may allow the head-mounted display unit to be moved to the non-viewing position with less rotation (or no rotation) at the pivot connections 1381.

The pivot connections 1381 may be lockable by the user. In some examples, the pivot connections 1381 allow for rotation of the head-mounted display unit 1200 about the pivot connections 1381 through a continuous range. Alternatively, the pivot connections 1381 may provide for indexed rotation of the head-mounted display unit 1200 whereby the user is able to rotate the head-mounted display unit 1200 between two or more positions at which the pivot connections 1381 support the head-mounted display unit 1200 and prevent rotation of the head-mounted display unit 1200 in the absence of the user forcing the head-mounted display unit 1200 to rotate. Lockable pivot connections 1381, or pivot connections 1381 which otherwise resist rotation of the head-mounted display unit 1200 during use may advantageously support some of the weight of the head-mounted display unit 1200 by resisting a moment produced at the pivot connections 1381 by the weight of the head-mounted display unit 1200, thus transferring that moment to the positioning and stabilising structure 1300 as a whole. This may advantageously reduce the perceived weight of the head-mounted display unit 1200 or at least make the head-mounted display system 1000 feel more balanced than if the pivot connections 1381 did not lock or at least partially resist rotation.

In the example shown in FIGS. 11A and 11B, the head-mounted display unit 1200 comprises a pair of arms 1200 connecting the head-mounted display unit 1200 to the band strap portion 1280. The head-mounted display unit 1200 may comprise a display unit housing 1205 comprising a display. The arms 1210 may connect the display unit housing 1205 to the band strap portion 1280. The arms 1210 may be rigidly connected to the display unit housing 1205. In the example shown in FIGS. 11A-11B, the arms 1210 form part of the display unit housing 1205. However, in other examples, the arms 1210 may form part of the positioning and stabilising structure 1300 and configured for removable attached to the display unit housing.

The arms 1210 in the examples shown in FIGS. 11A and 11B are pivotably connected to the band strap portion 1380 at pivot connections 1381. The pivot connections 1381 may allow the arms 1210 to each rotate about an axis aligned with both pivot connections 1381 (which may be aligned perpendicular to the sagittal plane of the user's head in use). In these examples, the arms 1210 are wide in the superior-inferior direction and form side shields configured to reduce the effect of any light leak at the lateral periphery of the interfacing structure 1100. This may advantageously help shield the user's eyes from undesired ambient light in their peripheral vision, allowing for greater immersion in the content provided by the display.

The positioning and stabilising structure 1300 may comprise a forehead pad 1395 attached to the band strap portion 1380 and configured to engage the user's forehead. The forehead pad 1395 may comprise an outer layer contacting the user's head formed from textile material. In some examples, the forehead pad 1395 may comprise a foam, gel, elastomer (e.g., silicone or TPE) and/or textile pad. The forehead pad 1395 or at least a face-contacting layer thereof may be breathable and may be low profile.

As illustrated in FIGS. 11A and 11B, the positioning and stabilising structure 1300 may comprise a parietal strap portion 1310 configured to engage the user's head at a region overlying the parietal bones of the user's head in use. The parietal strap portion 1310 may extend between lateral portions of the band strap portion 1380, for example between locations overlying temporal bones of the user's head. The parietal strap portion 1310 may be substantially inextensible or may have a low extensibility to allow a snug fit while providing support. The parietal strap portion 1310 may be formed from a textile material, for example a tubular knitted textile material. In some examples the parietal strap portion 1310 comprises a pair of elastically extendable lateral portions proximate the band strap portion 1380 and a posterior portion being less extendable than the elastically extendable lateral portions. The spaced relationship between the parietal strap portion 1310 and the occipital strap portion 1320 may help stabilize the positioning and stabilising structure, as described earlier.

The parietal strap portion 1310 may be connected to the band strap portion 1380 at locations spaced anteriorly from the pivot connections 1381, as shown in FIG. 11A. This arrangement may enable the tension in the parietal strap portion 1310 to produce a moment about the pivot connections 1381 in an opposite direction to a moment produced by the weight of the head-mounted display unit 1200, which may help support the head-mounted display unit 1200, and which may advantageously provide for comfort in use. Alternatively, in the example shown in FIG. 11B, the parietal strap portion 1310 connects to the band strap portion 1380 substantially at the locations of the pivot connections 1381.

The head-mounted display system 1000 further comprises one or more battery packs 1500 for powering the head-mounted display system 1000. As shown in FIG. 11A, the head-mounted display system 1000 comprises a battery pack 1500 attached to the occipital strap portion 1320. As shown in FIG. 11B, the head-mounted display system 1000 comprises a pair of battery packs 1500 attached to the occipital strap portion 1320, one located on each lateral side of the dial 1392. Positioning the battery packs 1500 at the posterior of the user's head on the occipital strap portion 1320 may help balance the weight of the head-mounted display system 1200. The occipital strap portion 1320 and/or battery packs 1500 may engage an occiput landmark on the user's head. A power cable may be integrated into or may run along the band strap portion 1380 from the battery packs 1500 and connect to the head-mounted display unit 1200.

The band strap portion 1380 may be adjustable in length and may comprise a dial adjustment mechanism 1390 comprising a rotatable dial 1392. The dial adjustment mechanism 1390 may be configured to cause a change in length of the band strap portion 1380 when the dial 1392 is rotated. The dial adjustment mechanism 1390 may be as described elsewhere herein and may be provided, for example, in the occipital strap portion 1320 of the band strap portion 1380. The dial 1392 may be positioned proximate the sagittal plane (e.g., intersecting the sagittal plane) of the user's head in use.

The head-mounted display unit 1200 comprises an interfacing structure 1100, visible in FIGS. 11A and 11B. The head-mounted display unit 1200 and interfacing structure 1100 in these examples are configured to be compact and low profile. The interfacing structure 1100 may engage the user's face, for example around a periphery of the user's eye region and over the ridge of the user's nose, partially supporting the head-mounted display unit 1200 and blocking ambient light from reaching the user's eyes in use (e.g., providing a light seal). In these examples, the interfacing structure 1100 comprises a foam laminate material. The foam laminate material may be thermoformed. The interfacing structure 1100 may further comprise a nose ridge support portion configured to engage the user's nose ridge in use. The interfacing structure 1100 may further comprise a breathable textile surface.

In some examples, the interfacing structure 1100 may comprise a face engaging portion formed from 3D textile which some users may consider to be particularly comfortable. Alternatively, the interfacing structure 1100 may be formed from a combination of silicone and foam, for example a silicone flange enclosing a foam cushion, which may provide for large variations in user anatomy due to the compressibility and conformability of the foam. In further examples the interfacing structure 1100 may be formed from silicone only, for example a curled silicone flange. A silicone surface may be particularly easy to clean. In each case, the interfacing structure 1100 may comprise varying properties at different locations around the periphery of the user's eye region, provided by variations in material thickness and/or geometry.

In some examples, such as the examples shown in FIGS. 11A and 11B, an anterior portion (e.g., forehead portion 1387) and a posterior portion (e.g., occipital portion 1320) of the band strap portion 1380 are integrally formed. For example, the band strap portion 1380 may comprise a seamless strap encircling the user's head and comprising a forehead portion 1387 and an occipital strap portion 1320, save for any joint at the adjustment mechanism. The parietal strap portion 1310 may then be attached to the band strap portion 1380 by sewing, welding (e.g., ultrasonic welding), gluing or by another suitable manner of connection.

The various strap portions in the positioning and stabilising structure 1300 shown in FIG. 11A or 11B such as the band strap portion 1380 and parietal strap portion 1310 may each comprise a textile material. In some examples, any or all of these strap portions may comprise a textile outer layer (on one or both sides) and a foam inner layer. Any or all of these strap portions may comprise a textile-foam laminate for example. The band strap portion 1380 may also comprise a rigidiser structured to make the band strap portion 1380 semi rigid or hold a substantially in-use shape when not on a user's head.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, parietal strap portion 1310 and/or the anterior and/or posterior portions of the band strap portion 1380 to provide for additional stability.

### 5.4.5 Band Strap Portion and Occipital Strap Portion

FIGS. 12A-12K show further examples of head-mounted display systems. FIG. 12A shows another example of a head-mounted display system 1000 comprising a band strap portion 1380. In this example, the positioning and stabilising structure 1300 comprises a pair of lateral strap portions 1330 constructed and arranged to connect to respective lateral sides of the head-mounted display unit 1200 and being connected to each other posterior to the user's head to form a band strap portion 1380 partially encircling the user's head. In this example, the band strap portion 1380 is in tension to pull the head-mounted display unit 1200 into engagement with the user's face.

The band strap portion 1380 may engage a region of the user's head overlying the parietal bones in use and in some particular examples may be semi-rigid at the region of the user's head overlying the parietal bones. This may provide for a comfortable and stable fit of the positioning and stabilising structure 1300. In some examples the entire band strap portion 1380 may be semi-rigid.

In other examples, the entire band strap portion 1380 and/or the occipital strap portion 1320 may be at least semi-rigid (e.g., having some semi-rigid and some rigid portions). When at least the band strap portion is rigidised, the lateral strap portions 1330 do not elastically pull the head-mounted display unit 1200 into engagement with the user's face. Instead, the head-mounted display system fits more like an adjustable helmet with the weight of the display unit more evenly distributed over the head-mounted display system 1000. The dial adjustment mechanism 1390 and the top strap portion 1340 may be adjusted to fit the arrangement to the particular user's head size. The band strap portion 1380 and the occipital strap portion may be provided with a cushion layer (e.g., foam or gel padding) to enable a snug and stable yet comfortable fit. In other examples, the top strap portion may also be provided with a cushion layer. This arrangement may provide a different feel for the user since the arrangement relies less on tension in the straps to provide a snug fit. Instead, the dial adjustment mechanism and the top strap portion are adjusted to set the positioning and stabilising structure at a substantially fixed size, whereas engagement of the user's head with padding in the interfacing structure 1100 and along the band strap portion 1380 and occipital strap portion 1320 (and in some examples the top strap portion 1340) provide a snug, stable and comfortable fit. Once donned, fine adjustments via the dial adjustment mechanism (and the top strap portion) can be made to pull the head-mounted display unit 1200 into desired engagement with the user's face.

In further examples, the band strap portion 1380 and/or the occipital strap portion 1320 may be formed of semi-rigid and/or rigid plastic materials. In other examples, the band strap portion and the occipital strap portion may be straps comprising textile (e.g., textile sleeve or textile inner and/or outer layers) and/or cushion (e.g., foam) layers, with rigidisers provided thereto to impart the rigidity.

As illustrated in FIG. 12A, the lateral strap portions 1330 each lie on a path extending posteriorly and partially superiorly away from the head-mounted display unit 1200 towards the posterior region of the user's head. This may allow the lateral strap portions 1330 to connect to the head-mounted display unit 1200 close to eye level while engaging a partially superior-facing surface of the user's head at the parietal bones. The band strap portion 1380 may then provide at least some superiorly-directed force to the head-mounted display unit 1200 in use, taking up at least some of the weight of the head-mounted display unit 1200. The lateral strap portions 1330 may connect to arms 1210 of the head-mounted display unit 1200 as described elsewhere herein. In other examples, the arms 1210 may be part of the positioning and stabilising structure 1300 and configured for attachment to the display unit housing 1205. The lateral strap portions 1330 or at least the anterior portions thereof, the arms 1210 and the connections between the lateral strap portions 1330, the arms 1210 and the head-mounted display unit 1200 may be substantially as described above with reference to FIGS. 8A-8B or elsewhere herein.

The positioning and stabilising structure 1300 further comprises an adjustment mechanism constructed and arranged to allow the user to selectively adjust the length of the band strap portion 1380. The adjustment mechanism may be disposed between the lateral strap portions 1330 so as to connect the lateral strap portions at a location posterior of the user's head and thereby form the band strap portion. In this way, the adjustment mechanism may be configured to simultaneously and equally adjust a length of both lateral strap portions to thereby adjust a length of the band strap portion. The adjustment mechanism in the example shown in FIG. 12A is a dial adjustment mechanism 1390 comprising a dial 1392, substantially as described with reference to FIG. 10B, and in other examples may be another suitable adjustment mechanism, such as one of the alternatives described above in relation to FIG. 10B.

The positioning and stabilising structure 1300 in this particular example comprises an occipital strap portion 1320 connected to the band strap portion 1380 and which is constructed and arranged to engage a region of the user's head overlying the occipital bone. A posterior portion of the band strap portion 1380 and occipital strap portion 1320 may together form a stable posterior portion of the positioning and stabilising structure 1300 from which other strap portions are able to extend and connect towards the head-mounted display unit 1200 under tension in use to pull the head-mounted display unit 1200 into engagement with the user's face. The occipital strap portion 1320 may be semi-rigid to provide for a stable fit against the occipital region of the user's head in use.

As shown, for example, in FIG. 12A, the occipital strap portion 1320 may provide a curved shape such that the occipital strap portion 1320 extends inferiorly from respective sides of the band strap portion 1380 and then extends posteriorly and medially to form a loop with the band strap portion 1380.

In an example with reference to FIG. 12A-1, the occipital strap portion 1320 may comprise a layered arrangement including an inner (user-contacting) layer 1425 (e.g., textile material), a cushioning layer 1426 (e.g., foam, gel), a rigidiser layer 1427 (e.g., plastic, thermoplastic rigidiser), and an outer layer 1424 (e.g., textile material). In examples, the inner and outer textile layers may be a textile sleeve (e.g., a tubular knit textile). In other examples, the cushioning layer may be omitted. It will be appreciated that the layered structure described here may be used in any other strap portion described elsewhere in this disclosure as being rigidised or as having a rigidiser.

The positioning and stabilising structure 1300 in the example shown in FIG. 12A further comprises a top strap portion 1340, which may connect between the band strap portion 1380 and the head-mounted display unit 1200. The top strap portion 1340 may be aligned centrally, e.g., with the sagittal plane of the user's head in use. The top strap portion 1340 may otherwise be as described above with reference to FIGS. 7A-7B, 8A-8B or FIG. 10A.

In some examples, such as the example shown in FIG. 12A, the lateral strap portions 1330 and the posterior (e.g., parietal) portion of the band strap portion 1380 are integrally formed. For example, the band strap portion 1380 may comprise a seamless strap encircling the user's head and comprising the lateral strap portions 1330 and a parietal strap portion, save for any joint at the adjustment mechanism. The occipital strap portion 1320 and/or top strap portion 1340 may then be attached to the band strap portion 1380 by sewing, welding (e.g., ultrasonic welding), gluing or by another suitable manner of connection.

The various strap portions in the positioning and stabilising structure 1300 shown in FIG. 12A such as the band strap portion 1380, top strap portion 1340 and occipital strap portion 1320 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, top strap portion 1340, occipital strap portion 1320 and/or the posterior portion of the band strap portion 1380 to provide for additional stability.

The example shown in FIGS. 12B-12C is similar to that shown in FIG. 12A and the disclosure above in relation to FIG. 12A is to be understood to apply to FIGS. 12B and 12C unless the context clearly requires otherwise. Furthermore, in the description of FIGS. 12B and 12C, only particular points of difference will be described. In the example shown in FIGS. 12B and 12C the positioning and stabilising structure 1300 does not comprise a top strap portion 1340.

In the example shown in FIGS. 12B and 12C, the positioning and stabilising structure 1300 comprises a pair of lateral strap portions 1330 constructed and arranged to connect to respective lateral sides of the head-mounted display unit 1200 and being connected to each other posterior to the user's head to form a band strap portion 1380 partially encircling the user's head. While in the example shown in FIG. 12A, the band strap portion 1380 connects to arms 1210, in the example shown in FIGS. 12B-12C, the lateral strap portions 1330 are attached to the interfacing structure 1100 of the head-mounted display system 1000. FIG. 12C shows schematically how the band strap portion 1380 and interfacing structure 1100 together fit around and encircle the user's head, and may be described as “hugging” the user's head to provide a secure fit. The positioning and stabilising structure 1300 in this example is attached to the head-mounted display unit 1200 at locations on the head-mounted display unit 1200 facing towards or being adjacent to the user's face, rather than to locations of the head-mounted display unit 1200 facing away from the user, allowing the headgear to hug a large portion of the circumference of the user's head. Furthermore, attaching the positioning and stabilising structure 1300 to the interfacing structure may provide for a compact, or low-profile, head-mounted display system 1000 since additionally exterior components such as arms are not provided.

In the example shown in FIGS. 12B and 12C, the head-mounted display unit 1200 comprises side shields 1214. The side shields 1214 may be as described elsewhere herein and may extend posteriorly from respective lateral sides of the head-mounted display unit 1200 past lateral portions of the interfacing structure 1100. For example, the side shields 1214 may be attached to the display unit housing 1205 and may extend posteriorly to help shield the user's peripheral vision from ambient light, extending for example to locations proximate the user's ears. Each of the side shields 1214 may extend posteriorly to a position proximate a respective otobasion superior of the user's head. In other examples, the side shields 1214 may attach to the positioning and stabilising structure 1300 and function as arms. In some examples battery packs (e.g., similar to battery packs 1500 described elsewhere) may be provided in the side shields 1214. In other examples, battery packs (e.g., similar to battery packs 1500 described elsewhere) may be provided to portions of the parietal strap portion proximate the side shields 1214 and/or the user's mid-coronal plane.

The posterior portion of the band strap portion 1380 may form a parietal strap portion 1310. The band strap portion 1380, including the parietal strap portion of the band strap portion 1380, may be formed from a tubular knitted material having a hollow interior portion and as indicated by the broken line shown in FIG. 12B, may comprise a rigidiser 1305 disposed in the hollow interior along some or all of its length.

In this example, the head-mounted display system 1000 also comprises an adjustment mechanism 1308 provided to the parietal strap portion 1310, as shown in FIGS. 12B and 12C. The adjustment mechanism 1308 may be a dial adjustment mechanism or an adjustable buckle, or other suitable adjustment mechanism, to allow one or two portions of the parietal strap portion 1310 to be overlapped to a selected extent to vary an effective length of the band strap portion 1380.

The occipital strap portion 1320 in the FIGS. 12B-12C example is attached to the band strap portion 1320, as shown in FIG. 12B. The occipital strap portion 1320 may be pulled downwardly by the user when donning the head-mounted display system 1000 from a location overlying the parietal bones, down to a location overlying or lying inferior to the occipital bone. The occipital strap portion 1320 may securely engage a posteroinferiorly-facing surface of the user's head, and if the user has a ponytail, it may advantageously pass through the gap between the parietal strap portion 1310 and the occipital strap portion 1320 unimpeded. The occipital strap portion may be a tubular knit strap.

In some examples, such as the example shown in FIGS. 12B and 12C, the lateral strap portions 1330 and the posterior (e.g., parietal) portion of the band strap portion 1380 are integrally formed. For example, the band strap portion 1380 may comprise a seamless strap encircling the user's head and comprising the lateral strap portions 1330 and a parietal strap portion, save for any joint at the adjustment mechanism. The occipital strap portion 1320 may then be attached to the band strap portion 1380 by sewing, welding (e.g., ultrasonic welding), gluing or by another suitable manner of connection.

The various strap portions in the positioning and stabilising structure 1300 shown in FIGS. 12B and 12C such as the band strap portion 1380 and occipital strap portion 1320 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, occipital strap portion 1320 and/or the posterior portion of the band strap portion 1380 to provide for additional stability.

The examples of head-mounted display systems 1000 shown in FIGS. 12D-12J have similarities to the examples shown in FIGS. 12A-12C. For example, each of the head-mounted display systems 1000 shown in FIGS. 12D-12J comprises a positioning and stabilising structure 1300 comprising a band strap portion 1380 formed by lateral strap portions 1330 and a parietal strap portion 1310, and further comprising an occipital strap portion 1320. The disclosure in relation to FIGS. 12A-12C above is to be considered relevant to the examples shown in FIGS. 12D-12I unless the context clearly requires otherwise. The following disclosure will focus on particular points of difference in the examples shown in FIGS. 12D-12I.

In the FIG. 12D example, the parietal strap portion 1310 comprises a dial adjustment mechanism 1390 comprising dial 1392, which may operate in the same way as dial adjustment mechanisms 1390 described elsewhere herein, such as with reference to FIG. 12A. The occipital strap portion 1320 shown in FIG. 12D is attached to the band strap portion 1380 and may comprise a rigidiser (to provide semi-rigid stiffness to the occipital strap portion 1320 which may provide a curved shape such that the occipital strap portion 1320 extends inferiorly from the parietal strap portion 1310 and then extends posteriorly and medially from both sidse of the user's head to form a loop with the parietal strap portion. In this example it may not be necessary for the user to manually pull the occipital strap portion 1320 away from the parietal strap 1310 down into position when donning the head-mounted display system 1000. Instead, the parietal strap portion 1310 and occipital strap portion 1320 may together be pulled over the user's head and down into position. The occipital strap portion 1320 and/or the band strap portion 1380 may hold substantially an in-use shape when the head-mounted display system 1000 is not worn by a user.

In the FIG. 12D example the interfacing structure 1100 may be as described with reference to FIGS. 11A and 11B, or as described elsewhere herein.

The examples shown in FIGS. 12E-12G have many of the same features as described with reference to other examples herein. Only particular differences are discussed below.

FIG. 12E shows a head-mounted display system 1000 according to another example of the present technology. This is a similar example to that shown in FIG. 12D although in the FIG. 12E example the occipital strap portion 1320 does not have a distinct curve produced by extending in an inferior direction and then a posterior direction as shown in the FIG. 12D example. Instead, the occipital strap portion 1320 extends in a substantially posteroinferior direction and then curves medially on each lateral side of the user's head. In the FIG. 12E example, the occipital strap portion is attached to the band strap portion 1380, for example proximate the head-mounted display unit 1200. In some examples, the occipital strap portion 1320 is attached to the band strap portion 1380 superior to and substantially in line with the user's ears. The occipital strap portion 1320 may be attached to a user-facing surface of the band strap portion 1380, as shown in FIG. 12E.

FIGS. 12F-12G show a head-mounted display system 1000 according to another example of the present technology. In this example, both the band strap portion 1380 and the occipital strap portion 1320 are attached to and extend from the head-mounted display unit 1200, as opposed the occipital strap portion 1320 being attached to the band strap portion 1380. The lateral strap portions 1330 of the band strap portion 1380 may be attached to the head-mounted display unit 1200, for example to the display unit housing 1205 of the head-mounted display unit 1200. In other examples they may be attached to the interfacing structure 1100, for example in the manner shown and described with reference to FIGS. 12B and 12C. Furthermore, the occipital strap portion 1320 may alternatively be attached to the side shields 1214. The occipital strap portion 1320 in this example may lie against non-user facing surfaces of the band strap portion 1380 proximate the side shields.

In other examples, the occipital strap portion 1320 may be attached to the band strap portion 1320 proximate the head-mounted display unit 1200, for example proximate side shields 1214.

In any of these examples, the band strap portion 1380 may comprise a variable extensibility along its length. For example, the band strap portion 1380 may comprise one or more elastically extendable portions. In the example shown in FIGS. 12F-12G, the band strap portion 1380 comprises elastically extendable lateral strap portions 1330 proximate the head-mounted display unit 1200 and a parietal strap portion 1310 between the elastically extendable lateral strap portions 1330 which is less elastically extendable than the lateral strap portions 1330. In some examples, the parietal strap portion 1310 is substantially inextensible. More generally, the band strap portion 1380 may be at least partially rigidised at the region of the user's head overlying the parietal bones of the user's head. The elastically extendable lateral portions may allow for the band strap portion 1380 to automatically adjust in length to snugly fit to a user's head while the less extensible (or substantially inextensible) parietal strap portion 1310 engages a posterior region of the user's head without elastic extension which may provide for a more comfortable fit and may facilitate easy over-the-head donning while maintaining overall stability.

In some examples the parietal strap portion 1310 may be rigidised, for example by a rigidiser provided to the parietal strap portion 1310 but not to the elastically extendable lateral strap portions 1330. The rigidiser may be formed from a TPE such as Hytrel, or a suitable thermoplastic material. In other examples, cushioning (e.g., foam or gel padding) may be provided to the parietal strap portion 1310 to enhance comfort. This construction of elastically extendable lateral strap portions 1330 and a less extendable or substantially inextensible parietal strap portion 1310 may be applied to any example disclosed herein. In other examples the entire band strap portion 1380 is at least partially rigidised.

The examples shown in FIGS. 12H-12J have many of the same features as described with reference to other examples herein. Only particular differences are discussed below.

The head-mounted display system 1000 shown in FIG. 12H further comprises a battery pack 1500 provided to the band strap portion 1380, for example to the parietal strap portion 1310 of the band strap portion 1380. The battery pack 1500 may provide power to the head-mounted display unit 1200 and may be connected to the head-mounted display unit 1200 by one or more power cables, which may be sheathed in the band strap portion 1380 or connected to an exterior surface thereof, by way of examples only. The battery pack 1500 in this example comprises a housing which also houses a dial adjustment mechanism 1390, which may function to allow adjustment of the length of the band strap portion 1380 in the same way as described with reference to the band strap portion 1380 in other examples. A dial 1392 of the dial adjustment mechanism 1390 is provided at a posterior surface of the battery pack 1500.

The battery pack 1500 may comprise a plurality of batteries or cells. In some examples the battery pack 1500 may comprise one or more cells on the band strap portion 1380 located on one side of the sagittal plane of the user's head in use and one or more cells on the band strap portion 1380 located on the other side of the sagittal plane of the user's head in use. In the example shown in FIG. 12H, the battery pack 1500 comprises two cells on each lateral side of the band strap portion 1380. The dial adjustment mechanism 1390 and dial 1392 are located between the two pairs of battery cells in this example. This arrangement may balance the weight of the batteries across the sagittal plane of the user's head and the placement of the battery pack 1500 at a posterior location on the user's head may result in the battery pack 1500 functioning as a counterweight to the weight of the head-mounted display unit 1200, balancing weight of the head-mounted display system 1000 across the user's coronal plane in use. In other examples, the head-mounted display system 1000 may comprise a different number of cells and/or they may be positioned differently relative to each other.

FIG. 12I shows an example of a head-mounted display system 1000 according to the present technology in which battery packs 1500 are provided to the side shields 1214. Side shields 1214 are described in more detail above. As illustrated, each side shield comprises a battery pack 1500. Each of the battery packs 1500 may comprise a pair of batteries or cells. This arrangement may balance weight of the batteries across the user's sagittal plane in use while also positioning the weight of the batteries close to the coronal plane of the user's head (e.g., close to directly superiorly over the user's neck) in use, which may make the weight of the batteries easier for the user to bear due to minimal force moments being created about axes perpendicular to the sagittal plane.

In some examples, such as the examples shown in FIGS. 12D-12J, the lateral strap portions 1330 and the parietal strap portion 1310 of the band strap portion 1380 are integrally formed. For example, the band strap portion 1380 may comprise a seamless strap encircling the user's head and comprising the lateral strap portions 1330 and a parietal strap portion 1310, save for any joint at the adjustment mechanism. In the examples in which the occipital strap portion 1320 is attached to the band strap portion 1380, the attachment may be by sewing, welding (e.g., ultrasonic welding), gluing or by another suitable manner of connection.

The various strap portions in the positioning and stabilising structure 1300 shown in FIGS. 12D-12J such as the band strap portion 1380 and occipital strap portion 1320 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, occipital strap portion 1320 and/or the parietal strap portion 1310 of the band strap portion 1380 to provide for additional stability.

FIG. 12J shows a head-mounted display system 1000 which is a variation of the head-mounted display system 1000 shown in FIGS. 12F and 12G. In this example the occipital strap portion 1320 comprises a textile sleeve 1321. The textile sleeve 1321 is elastically extendable in length to allow for size adjustment of the occipital strap portion 1320. That is, the textile sleeve 1321 is stretchy to allow it to extend as required to accommodate a user's head size. It is also flexible to conform to the user's head shape, at least in portions of the occipital strap portion 1320 that are not rigidised. In other examples, the occipital strap portion 1320 may comprise a textile sleeve 1321 that is not elastically extendable. In the example illustrated in FIG. 12J, the textile sleeve 1321 comprises a knitted tube with a hollow interior portion. The textile sleeve 1321 may comprise a flexible tubular shape and may be formed by knitting with a stitch that allows for a high elastic extensibility.

The occipital strap portion 1320 may comprise at least one rigidiser 1323. The rigidiser 1323 may be disposed within the hollow interior portion of the textile sleeve 1321. FIG. 12K shows a schematic cross section view through the textile sleeve 1321 showing the rigidiser 1323 inside the interior of the tubular textile sleeve 1321. In other examples, a rigidiser may be provided outside of but attached to material forming the occipital strap portion 1320.

In the example shown in FIG. 12J, the occipital strap portion 1320 comprises a pair of rigidisers 1323. Each rigidisier 1323 may be connected to and may extend posteriorly away from the head-mounted display unit 1200. Each rigidiser 1323 may comprise a posterior end and the posterior ends of the rigidisers 1323 may be spaced laterally apart from each other proximate a posterior surface of the user's head. That is, the rigidisers 1323 may not be connected to each other and may be spaced apart from each other. This lack of connection between the rigidisers 1323 in this example advantageously avoids the rigidisers restricting the ability of the occipital strap portion 1320 to adjust in size to accommodate different head sizes. In other examples the rigidisers 1323 may be connected by an extensible portion, may be semi-rigid and elastic such that they can extend in length while still providing some rigidity or may be substantially rigid but may allow for selective length adjustment (e.g., they may be connected by a rack-and-pinion dial adjustment mechanism, connected by a friction fit which can be selectively adjusted by the user, or may be connected by a cord, the tension within which may be adjustable by a dial). Examples in which the rigidisers 1323 are attached by a cord/wire wound around a dial which may be turned to adjust tension in the cord have the advantage the rigidisers 1323 may then be formed with curvature in three dimensions. In some examples in which the rigidisers are connected by a rack and pinion style adjustment the rigidisers may only have curvature in one dimension.

The rigidisers 1323 may take a variety of three-dimensional shapes. For example, each rigidiser 1323 may extend posteriorly and curve medially to follow curvature of the posterior surface of the user's head. The rigidisers 1323 may extend along a path that provides a force vector that pulls the head-mounted display into proper engagement with the user's face to ensure a stable fit without light leak. In the example shown in FIG. 12J, each rigidiser 1323 extends posteriorly and curves inferiorly and medially to follow curvature of the posterior surface of the user's head. The three-dimensional curved shape advantageously facilitates and encourages the rigidiser 1323 (and therefore also the rigidised portions of the occipital strap portion 1320) to fit closely to the user's head and follow the contours of the user's head posteriorly past the user's ears and then inferiorly and medially to wrap around the head at the region overlying or lying inferior to the occipital bone.

In the example shown in FIG. 12J, the textile sleeve 1231 is constrained by the rigidisers 1323 to lie on a curved path defined by curvature in each rigidiser 1323. The textile sleeve 1231 is able to stretch over and along the rigidisers 1323 to elastically extend in length. The textile may be a knitted textile and may, for example, be provided with elastane or other suitable arrangements (e.g., materials, knit structure) to provide sufficient stretchability and elasticity. When the textile sleeve 1231 stretches, the portions of the textile sleeve 1231 that surround each rigidiser 1323 are forced by the rigidisers 1323 to each keep a three-dimensional shape corresponding to the three-dimensional shape of the rigidiser 1323. During fitting of the positioning and stabilising structure 1300 to the user's head, the textile sleeve 1231 may extend in length without change in three-dimensional shape at the portions of the textile sleeve 1231 surrounding or overlying the rigidisers 1323 (which may be identified as “rigidised” portions of the textile sleeve 1231). Advantageously, this keeps the rigidised portions in a predetermined three dimensional shape independently of length extension to keep most of the occipital strap portion 1320 in a predetermined location on the user's head, such as in a low position proximate the posterior of the user's head and hugging the user's head. In some examples the rigidisers 1323 may be formed in a shape that requires the user's head to spread them apart when the user dons the head-mounted display system 1000, which may advantageously facilitate snug contact between the occipital strap portion 1320 and the user's head in use. In other examples, the textile sleeve 1231 may be fixedly adhered to the rigidisers 1323 along the length of the rigidisers which may reduce the amount of available stretch in the textile sleeve since the textile sleeve would only be able to stretch in the area where the rigidisers are not present (e.g., between the pair of rigidisers and proximate the sagittal plane). However, this arrangement may provide a more snug fit and stable fit.

In some examples, such as the example shown in FIGS. 12J and 12K, the rigidisers 1321 may be structured to resist bending towards the superior and inferior directions. However, the rigidisers 1321 may be structured to bend towards the medial and lateral directions, to allow them to conform to a range of head sizes while not deviating significantly from their vertical positions on the head.

In some examples, the sleeve 1321 is formed from a material other than a textile material, although textile has an advantage in being highly comfortable or at least being perceived as highly comfortable. The sleeve 1321 may be either or both of elastically extendable and selectively extendable in length. In some examples, the sleeve 1321 is elastically extendable (e.g., a textile sleeve 1321 in the form of a knitted tube as described above) and also selectively extendable in length in that the user is able to selectively adjust a starting length of the sleeve 1321. The sleeve 1321 may be selectively adjusted in any manner described herein, for example a dial adjustment or by a buckle whereby the user is able to adjust an amount of overlap between portions of the sleeve 1321 to adjust an effective length of the occipital strap portion 1320.

The positioning and stabilising structure, for example as shown in FIG. 12J, may be designed so that the positioning and stabilizing structure 1300 springs ‘out of the box’, for example due to the rigidizers being formed to maintain the shape of some or part of the positioning and stabilizing structure 1300. Advantageously, the orientation of the positioning and stabilizing structure 1300 is made clear to the user.

### 5.4.6 Multiple Band Strap Portions

FIGS. 13-16 show further examples of head-mounted display systems. FIG. 13 shows a head-mounted display system 1000 comprising a head-mounted display unit 1200 which may be as described with reference to FIGS. 7A-7B (or elsewhere herein). The head-mounted display unit 1200 may comprise a display unit housing 1205 comprising a display, and an interfacing structure 1100 connected to the display unit housing 1205 and being constructed and arranged to engage the user's face in use.

The head-mounted display system 1000 shown in FIG. 13 comprises a positioning and stabilising structure 1300 comprising a pair of lateral strap portions 1330 constructed and arranged to connect to respective lateral sides of the head-mounted display unit 1200 and being connected to each other at a posterior location of the user's head to form a first band portion 1382 partially encircling the user's head. The first band portion 1382 may be in tension in use to pull the head-mounted display unit 1200 into stable engagement with the user's face.

The positioning and stabilising structure 1300 in the FIG. 13 example further comprises a second band portion 1384 encircling the user's head. The second band portion 1384 is connected to the first band portion 1382 at the posterior region of the user's head and is constructed and arranged to engage the user's head at the posterior region and at a forehead region of the user's head, as shown in FIG. 13. The second band portion 1384 may engage the user's head snugly to provide a relatively immovable strap portion from which other strap portions may extend, such as the first band portion 1382 and a top strap portion 1340 (to be described below). The second band portion 1384 may overlie surfaces of the user's head facing partially laterally and partially superiorly, due to the superior portion of the head being somewhat dome-shaped. This prevents the second band portion 1384 from sliding down the user's head, enabling it to function as a ring strap portion anchoring to the curved surfaces of the user's head and supporting some of the weight of the head-mounted display unit 1200.

The positioning and stabilising structure 1300 may further comprise an adjustment mechanism constructed and arranged to allow the user to selectively adjust the length of the first band portion 1382 and the length of the second band portion 1384 simultaneously. Advantageously, the user is able to adjust two strap portions at the same time, which may provide for a head-mounted display system 1000 which is able to be easily and quickly adjusted to fit a particular user.

The adjustment mechanism may be a dial adjustment mechanism 1390 and may be as described above with reference to FIG. 10A, 10B or 12, or as described elsewhere herein. In particular, the dial adjustment mechanism 1390 in the FIG. 13 example comprises a dial 1392 which when turned adjusts the length of the first band portion 1382 and the second band portion 1384. The dial may be positioned centrally, for example in the sagittal plane of the user's head in use. The adjustment mechanism may alternatively be any one of the alternatives described with reference to FIGS. 10A-10B, such as a dial 1392 which is connected to one or more wires or cables which are attached to points on the first band portion 1382 and/or second band portion 1384

In some alternative examples, the positioning and stabilising structure 1300 may comprise two separate adjustment mechanisms for each of the first band portion 1382 and the second band portion 1384, or only one of the first band portion 1382 and the second band portion 1384 may be adjustable. The positioning and stabilising structure 1300 may comprise a first adjustment mechanism constructed and arranged to allow the user to selectively adjust the length of the first band portion 1382. The first adjustment mechanism may comprise a first dial adjustment mechanism comprising a first dial which when turned adjusts the length of the first band portion 1382. The positioning and stabilising structure 1300 may additionally or alternatively comprise a second adjustment mechanism constructed and arranged to allow the user to selectively adjust the length of the second band portion 1384. The second adjustment mechanism may comprise a second dial adjustment mechanism comprising a second dial which when turned adjusts the length of the second band portion 1384.

In the example shown in FIG. 13, the lateral strap portions 1330 lie on a path extending posteriorly and partially inferiorly away from the head-mounted display unit 1200 towards the posterior location of the user's head. By extending partially inferiorly, the first band portion 1382 may advantageously engage the user's head inferior to the posterior-most point of the user's skull, which may provide for a stable fit of both the first band portion 1382 and the second band portion 1384 when tightened snugly. However, in some alternative examples the lateral strap portions 1330 may extend posteriorly or posteriorly and partially superiorly from the head-mounted display unit 1200.

The lateral strap portions 1330 may connect to arms 1210 of the head-mounted display unit 1200. The lateral strap portions 1330 or at least the anterior portions thereof, the arms 1210 and the connections between the lateral strap portions 1330, the arms 1210 and the head-mounted display unit 1200 may be substantially as described above with reference to FIGS. 8A-8B or elsewhere herein.

The positioning and stabilising structure 1300 in the example shown in FIG. 13 further comprises a top strap portion 1340. The top strap portion 1340 may connect between the second band portion 1384 and the head-mounted display unit 1200. The top strap portion 1340 may be selectively adjustable and may be as described with reference to FIGS. 7A-7B, 8A-8B or FIG. 10A, or as described elsewhere herein. In other examples the positioning and stabilising structure 1300 does not comprise a top strap portion 1340.

In some examples, such as the example shown in FIG. 13, the lateral strap portions 1330 and the posterior portion of the first band portion 1382 are integrally formed. For example, the first band portion 1382 may comprise a seamless strap encircling the user's head and comprising the lateral strap portions 1330 and a posterior strap portion, save for any joint at the adjustment mechanism. The second band portion 1384 may then be attached to the first band portion 1382 by sewing, welding (e.g., ultrasonic welding), gluing or by another suitable manner of connection, for example as dictated by the requirements of the single adjustment mechanism.

Likewise, the second band portion 1384 may be a seamless strap encircling the user's head save for any joint at the adjustment mechanism. The top strap portion 1340 may then be attached to the second band portion 1384 by sewing, welding, gluing or by another suitable manner of connection.

The various strap portions in the positioning and stabilising structure 1300 shown in FIG. 13 such as the first band portion 1382, second band portion 1384 and top strap portion 1340 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330, top strap portion 1340, and/or the first band portion 1382 or second band portion 1384 (for example at the posterior portions thereof) which may provide for additional stability.

FIGS. 14-16 show further examples of head-mounted display systems 1000 comprising positioning and stabilising structures 1300 having a first band portion 1382 and a second band portion 1384. The first band portion 1382 is constructed and arranged to connect to respective lateral sides of a head-mounted display unit 1200, partially encircle the user's head and engage a posterior region of the user's head. The second band portion 1384 is constructed and arranged to encircle a portion of the user's head and engage the posterior region of the user's head and a superior region of the user's head at or proximate a coronal plane aligned with each otobasion superior of the user's head.

The first band portion 1382 in the examples shown in FIGS. 14-16 is formed by lateral strap portions 1330 which are in use connected to respective lateral sides of the head-mounted display unit 1200 and are positioned on respective lateral sides of the user's head. The first band portion 1382 is also formed by a posterior strap portion 1385 connected to the lateral strap portions 1330 and being constructed and arranged to engage the posterior region of the user's head in use.

The second band portion 1384 in the examples shown in FIGS. 14-16 is formed by the posterior strap portion 1385 and a superior transverse strap portion 1370 connected to the posterior strap portion 1385 and constructed and arranged to engage the user's head at or proximate the coronal plane aligned with each otobasion superior.

The first band portion 1382 may be in tension in use to pull the head-mounted display unit 1200 into stable engagement with the user's face. The second band portion 1384 may stabilise the first band portion 1382.

As shown in each of FIGS. 14-16, the second band portion 1384 may be wider at the superior region of the user's head than at the posterior region. That is, the superior transverse strap portion 1370 may be wider than the posterior strap portion 1385. The width of the second band portion 1384 may taper increasingly from the posterior strap portion 1385 to the superior transverse strap portion 1370 with a maximum width being at a location at which the superior transverse strap portion 1370 intersects with the sagittal plane, and a minimum width being at a location at which the posterior strap portion 1385 intersects with the sagittal plane. The increased width of the superior transverse strap portion 1370 may help to more evenly distribute some of the weight of the display unit across a superior region of the user's head.

In the example shown in FIG. 15, the increased width of the superior transverse strap portion 1370 is provided by an anterior portion 1371 of the superior transverse strap portion 1370 being attached (e.g., by sewing, welding, gluing etc.) to a posterior portion 1372 of the superior transverse strap portion 1370. The posterior portion 1372 of the superior transverse strap portion 1370 may have a constant width and the anterior portion 1371 of the superior transverse strap portion 1370 may increase in width from its lateral ends to a medial location.

In the examples shown in FIGS. 14 and 15, the lateral strap portions 1330 and posterior strap portion 1385 are integrally formed with each other, and the superior transverse strap portion 1370 comprises ends attached to and extending superiorly and anteriorly from the first band portion 1382, for example extending from locations at or proximate the posterior region on respective lateral sides of the user's head. The first band portion 1382 may comprise a seamless strap encircling the user's head and comprising the lateral strap portions 1330 and a posterior strap portion 1385. The second band portion 1384 may then be attached to the first band portion 1382 by sewing, welding (e.g., ultrasonic welding), gluing or by another suitable manner of connection.

In the example shown in FIG. 16, the superior transverse strap portion 1370 and the posterior strap portion 1385 are integrally formed, and the lateral strap portions 1330 are each attached to and extend anteriorly from the second band portion 1384, for example extending from locations proximate to the posterior region of the user's head on respective lateral sides of the user's head. The second band portion 1384 may comprise a seamless strap encircling the user's head and comprising the posterior strap portion 1385 and the superior transverse strap portion 1370. The first band portion 1382 may then be attached to the second band portion 1384 by sewing, welding (e.g., ultrasonic welding), gluing or by another suitable manner of connection.

As shown in each of FIGS. 14-16, the lateral strap portions 1330 may lie in use on a path extending posteriorly and partially inferiorly away from the head-mounted display unit 1200 towards the posterior region of the user's head. By extending partially inferiorly, the first band portion 1382 may advantageously engage the user's head inferior to the posterior-most point of the user's skull, which may provide for a stable fit of both the first band portion 1382 and the second band portion 1384 when tightened snugly. However, in some alternative examples, the lateral strap portions 1330 may extend posteriorly or posteriorly and partially superiorly from the head-mounted display unit 1200.

In some examples the lateral strap portions 1330 are rigidised and may be provided with sufficient stiffness to prevent the posterior strap portion 1385 from riding up on the user's head. In some examples, the entire first band portion 1382 is semi-rigid or comprises a rigidised strap, to advantageously facilitate a consistent fit to an inferior location posterior to the user's head and/or prevent riding up. Furthermore, in some examples the second band portion 1384 is rigidised or comprises or is formed from a semi-rigid material. In some examples, both the first band portion 1382 and second band portion 1384 are semi rigid or rigidised, which may advantageously facilitate the first band portion 1382 being able to support some of the weight of the head-mounted display unit 1200 by transferring weight to the second band portion 1384 and then to superior surfaces of the user's head.

The lateral strap portions 1330 may connect to arms 1210 of the head-mounted display unit 1200 and may be selectively adjustable in length to vary the length of the first band portion 1382. The lateral strap portions 1330 or at least the anterior portions thereof and their length adjustability (e.g., with hook-and-loop connections), the arms 1210 and the connections between the lateral strap portions 1330, the arms 1210 and the head-mounted display unit 1200 may be substantially as described above with reference to FIGS. 8A-8B or elsewhere herein.

In some examples, the length of the second band portion 1384 may be selectively adjustable by the user. This may allow the user to achieve a personalised fit. The second band portion 1384 may be provided with ends which are connected by a hook-and-loop connection, for example. More or less of the ends of the second band portion 1384 may be overlapped to adjust the effective length of the second band portion 1384. Alternatively, the ends of the second band portion 1384 may be connectable by a magnetic clip, and one of the ends of the second band portion 1384 may be fed through the clip, looped back and secured to itself with a hook-and-loop connection or via one of a series of domes, for example. More or less of the second band portion 1384 may be fed through the magnetic clip to adjust the effective length of the second band portion 1384. Alternatively, the magnetic clip may be another type of clip or buckle able to join to ends of a strap.

The second band portion 1384 in the examples shown in FIGS. 14-16 may be semi-rigid and/or structured to substantially hold an in-use shape when not donned by the user. The functions and material options for the ring strap portion 1360 described elsewhere herein, such as with reference to FIG. 8A-8B or 8E, for example, are to be understood to be applicable to the second band portion 1384.

While the positioning and stabilising structures 1300 shown in FIGS. 14-16 do not comprise top strap portions extending to the head-mounted display units 1200, in some alternative examples the positioning and stabilising structure 1300 further comprises a top strap portion 1340. The top strap portion 1340 may connect between the second band portion 1384 and the head-mounted display unit 1200. The top strap portion 1340 may be selectively adjustable and may be as described with reference to FIGS. 7A-7B, 8A-8B or FIG. 10A, or as described elsewhere herein.

The various strap portions in the positioning and stabilising structure 1300 shown in FIGS. 14-16 such as the first band portion 1382, second band portion 1384 and portions thereof (e.g., the lateral strap portions 1330, posterior strap portion 1385 and superior transverse strap portion 1370) may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In other examples, rigidisers may be added to the lateral strap portions 1330 or to the first band portion 1382 or second band portion 1384 (for example at the posterior portions thereof) which may provide for additional stability.

### 5.4.7 Head-Mounted Display Unit with Superior Connection to Positioning and Stabilising Structure

FIG. 17 shows another example of a head-mounted display system 1000 comprising a positioning and stabilising structure 1300 having a band strap portion 1380 constructed and arranged to encircle a portion of the user's head. In this example, the band strap portion 1380 is formed by a posterior strap portion 1385 constructed and arranged to engage the posterior region of the user's head and a superior transverse strap portion 1370 constructed and arranged to engage a superior region of the user's head at or proximate a coronal plane aligned with each otobasion superior of the user's head.

In this example, the positioning and stabilising structure 1300 further comprises a pair of lateral strap portions 1330 connecting between the band strap portion 1380 and respective lateral sides of the head-mounted display unit 1200. The lateral strap portions 1330 lie in use on a path extending posteriorly away from the head-mounted display unit 1200 and curving superiorly to connect to the band strap portion 1380 at or proximate the superior transverse strap portion 1370. In this particular example, the lateral strap portions 1330 are rigidised. The rigidised structure of the lateral strap portions 1330 and their connection to the band strap portion 1380 at or proximate the superior transverse strap portion 1370 may enable them to partially support the weight of the head-mounted display unit 1200, which may allow for the head-mounted display unit 1200 to be pulled posteriorly against the user's face with less force than otherwise.

The lateral strap portions 1330 may function as extensions of the arms 1210 in this example. Each of the lateral strap portions 1330 may be sufficiently stiff to hold its curved shape in use while supporting the head-mounted display unit 1200. Each of the lateral strap portions 1330 may comprise a substantially rigid structure encased in a textile sleeve. Each lateral strap portion 1330 (or at least an inner structural component thereof) may be structured to resist bending in superior/inferior directions and/or anterior-posterior directions. This may advantageously facilitate the lateral strap portions 1330 transferring force to the head-mounted display unit 1200, for example to hold the head-mounted display unit 1200 against the user's face and at least partially support the weight of the head-mounted display unit 1200 without excessive shape change.

In some examples the lateral strap portions 1330 may have a width larger than a thickness. For example, the width may be multiple times larger than the thickness, such as 3, 4, 5, 6 or more times larger than the thickness. The lateral strap portions 1330 may be shaped such that the width of the lateral strap portions 1330 is oriented in the superior/inferior and/or anterior/posterior directions and the thickness is oriented in the medial-lateral directions. In some examples, the lateral strap portions 1330 are shaped such that the width is oriented so as to be substantially parallel to adjacent surfaces of the user's head and the thickness is oriented so as to be substantially perpendicular to adjacent surfaces of the user's head. This may enable the lateral strap portions 1330 to bend towards and away from the user's head in order to fit closely to the user's head, while retaining sufficient stiffness to support at least some of the weight of the head-mounted display unit 1200 and to transfer force to the head-mounted display unit 1200 to hold it against the user's face.

A rigidiser in the lateral strap portions 1330, or a rigidiser for any other component described herein, may be formed from a plastic material (e.g., thermoplastic material, for example a thermoplastic elastomer) in some examples. In some examples, the rigidiser or rigidising material may be formed from Hytrel. In some examples (such as variations of the FIG. 17 example or variations of any other example described herein), the lateral strap portions 1330 may be integrally formed with arms 1210 attached to the head-mounted display unit 1200.

The superior transverse strap portion 1370 and the posterior strap portion 1385 may be integrally formed, for example as described with reference to FIG. 16. In the example shown in FIG. 17, the posterior strap portion 1385 may be constructed and arranged to overlie the occipital bone of the user's head in use. The band strap portion 1380 may provide a relatively immovable portion from which other strap portions, such as the lateral strap portions 1330 and a top strap portion 1340 (if present) are able to extend and pull against.

The length of the band strap portion 1380 may be selectively adjustable, for example in one of the ways in which the second band portion 1384 of FIGS. 14-16 is described as optionally being adjustable above, or as described elsewhere herein. In some examples, the band strap portion 1380 comprises a dial adjustment mechanism (e.g., of the rack and pinion type or of a wound cord type). In one particular example, the band strap portion 1380 may comprise a pair of ends connected to each other in use, one of the pair of ends comprising an eyelet and the other of the pair of ends being passed through the eyelet, looped back and secured to itself. More or less of the band strap portion 1380 may be passed through the eyelet before being secured to itself, to adjust an effective length of the band strap portion 1380.

In the example shown in FIG. 17, the positioning and stabilising structure 1300 may comprise a counterweight 1386 attached to the posterior strap portion 1385. The counterweight may help balance the weight of the head-mounted display unit 1200, reducing the perceived weight of the head-mounted display unit 1200 on the user's face, distributing the weight across the user's head. In some examples the counterweight 1386 is a dead weight (e.g., formed from a metal, sand or like). In other examples, the counterweight 1386 is provided by a functional item such as a battery pack 1500, camera, processor or other electronic or non-electronic component which has a sufficient weight to act as a counterweight and also has another function.

The lateral strap portions 1330 may connect to arms 1210 of the head-mounted display unit 1200. The anterior portions of the lateral strap portions 1330, the arms 1210 and the connections between the lateral strap portions 1330, the arms 1210 and the head-mounted display unit 1200 may be substantially as described above with reference to FIGS. 8A-8B or elsewhere herein. For example, the arms 1210 may connect to the lateral strap portions 1330 via a hook-and-loop connection whereby the lateral strap portions 1330 each loop through an eyelet or slot in a respective one of the arms 1210 and is fastened back to itself with a hook-and-loop connection.

As an alternative to a hook-and-loop connection between the arms 1210 and the lateral strap portions 1330, one or more components of the head-mounted display system 1000 may be selectively adjustable in position with respect to one or more other components of the head-mounted display system 1000, which may advantageously allow for the head-mounted display system 1000 to fit a range of user head shapes and sizes and may allow for individuals to adjust the head-mounted display system 1000 to fit well (e.g., stably and comfortably). In one example, the band strap portion 1380 is able to move closer or further away from the head-mounted display unit 1200. For example, the lateral strap portions 1330 may be selectively moveable along rails on the arms 1210. Alternatively, the arms 1210 may be selectively moveable along their length with respect to the head-mounted display unit 1200. Further yet, in some examples the arms may extend and retract. In any of these examples, the components may be structured to move between a series of discrete incremental positions and may mechanically snap together in each of the incremental positions. These adjustment options are to be understood to be applicable to variations on any of the example head-mounted display systems 1000 disclosed herein.

The band strap portion 1380 in the example shown in FIG. 17 may be semi-rigid and/or structured to substantially hold an in-use shape when not donned by the user. The functions and material options for the ring strap portion 1360 described elsewhere herein, such as with reference to FIG. 8A-8B or 8E, for example, are to be understood to be applicable to the band strap portion 1380. In a particular example, the band strap portion 1380 is rigidised, for example being formed from a semi rigid material or being formed from a flexible material attached to a semi-rigid or substantially rigid material. For example, in some examples the band strap portion 1380 comprises an internal rigidiser encased in a textile sleeve.

While the positioning and stabilising structure 1300 in the example shown in FIG. 17 comprises no top strap portion 1340, in other examples the positioning and stabilising structure 1300 further comprises a top strap portion 1340. The top strap portion 1340 may connect between the band strap portion 1380 (for example at the superior transverse strap portion 1370) and the head-mounted display unit 1200. The top strap portion 1340 may be selectively adjustable and may be as described with reference to FIGS. 7A-7B, 8A-8B or FIG. 10A, or as described elsewhere herein. In other examples, the positioning and stabilising structure 1300 does not comprise a top strap portion 1340.

In some examples, such as the example shown in FIG. 17, the superior transverse strap portion 1370 and the posterior strap portion 1385 of the band strap portion 1380 are integrally formed. For example, the band strap portion 1380 may comprise a seamless strap encircling the user's head and comprising the superior transverse strap portion 1370 and the posterior strap portion 1385, save for any joint at an adjustment mechanism. The lateral strap portions 1330 may then be attached to the band strap portion 1380 by sewing, welding (e.g., ultrasonic welding), gluing or by another suitable manner of connection, for example as dictated by the requirements of any adjustment mechanism.

The various strap portions in the positioning and stabilising structure 1300 shown in FIG. 17 such as the band strap portion 1380 and lateral strap portions 1330 may each comprise a textile material. In some examples, any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples some or all strap portions may comprise silicone, rigid plastic, foam, leather or another suitable material.

In some examples, the lateral strap portions 1330 and the band strap portion 1380 are rigidised which may enable the weight of the head-mounted display unit 1200 and the counterweight 1386 to be evenly distributed over the user's head, or at least more evenly than otherwise.

### 5.4.8 Rigidised Strap Portions

FIGS. 18A, 18B and 19 show head-mounted display systems 1000 comprising further examples of positioning and stabilising structures 1300. In these examples, the positioning and stabilising structure 1300 comprises a superior transverse strap portion 1370 constructed and arranged to engage a superior portion of the user's head in use and an occipital strap portion 1320 constructed and arranged to engage a region of the user's head overlying the occipital bone in use. The positioning and stabilising structure 1300 further comprises a pair of lateral strap portions 1330 each connected to a respective junction 1306 of the superior transverse strap portion 1370 and the occipital strap portion 1320 and each constructed and arranged to connect to a respective lateral side of the head-mounted display unit 1200. In these examples, the lateral strap portions 1330 are rigidised. Rigidised portions are indicated by cross-hatching in FIGS. 18A, 18B and 19.

The superior transverse strap portion 1370 may in use be substantially aligned with a coronal plane of the user's head aligned with each otobasion superior of the user's head. As illustrated, the superior transverse strap portion 1370 may be wider at the sagittal plane of the user's head than proximate the junctions 1306 with the occipital strap portion 1320, as this may provide for a comfortable and stable fit of the superior transverse strap portion 1370 to the user's head. The wider superior portion of the superior transverse strap portion may also help to more evenly distribute some of the weight of the display unit over the superior portion of the user's head.

In the examples shown in FIGS. 18A and 18B, the lateral strap portions 1330 are integrally formed with the superior transverse strap portions 1370. In addition to rigidisation of the lateral strap portions 1330, portions of the superior transverse strap portion 1370 proximate respective lateral strap portions 1330 may be rigidised. In the examples shown in FIGS. 18A and 18B, the superior transverse strap portion 1370 is rigidised along its entire length. Furthermore, in this particular example, the positioning and stabilising structure 1300 comprises a single rigidiser 1305, indicated by the cross-hatched portion in FIGS. 18A and 18B, extending from one lateral strap portion 1330 through the superior transverse strap portion 1370 and into the other lateral strap portion 1330. Portions of the occipital strap portion 1320 proximate respective lateral strap portions 1330 may be rigidised as well, in some examples. As shown in FIG. 18A, the single rigidiser 1305 comprises posteriorly projecting portions extending into respective ends of the occipital strap portion 1320. As shown in FIGS. 18A and 18B, an anterior portion of the superior transverse strap portion 1370 may not include the rigidiser such that the rigidiser is continuous only through a posterior portion of the superior transverse strap portion; however, in other examples, the entire superior transverse strap portion 1370 may include the rigidiser.

The superior transverse strap portion 1370 and/or the occipital strap portion 1320 in the examples shown in FIGS. 18A-18B may be semi-rigid and/or structured to substantially hold an in-use shape when not donned by the user. The functions and material options for the ring strap portion 1360 described elsewhere herein, such as with reference to FIG. 8A-8B or 8E, for example, are to be understood to be applicable to the portion of the positioning and stabilising structure 1300 formed by the superior transverse strap portion 1370 and occipital strap portion 1320.

The occipital strap portion 1320 may be able to be separated into two portions, or may comprise a removable connection at one end thereof, allowing the occipital strap portion 1320 to be disconnected at one end (or part way along its length) to facilitate donning and doffing of the head-mounted display system 1000. The occipital strap portion 1320 may be, additionally or alternatively, selectively adjustable in length by the user. In the positioning and stabilising structure 1300 shown in FIGS. 18A and 18B, the occipital strap portion 1320 comprises an occipital strap connector 1322 at one end of the occipital strap portion 1320 constructed and arranged to releaseably attach to an occipital strap connection portion at or proximate one of the junctions 1306 of the occipital strap portion 1320 and the superior transverse strap portion 1370. The occipital strap connector 1320 in this example is constructed and arranged to magnetically attach to the occipital strap connection portion. The occipital strap portion 1320 in this example may connect and disconnect to the occipital strap connection portion in the same way as the occipital strap portion 1320 connects to the inferior connection portion 1212 in the example shown in FIGS. 7A and 7B. The occipital strap portion 1320 in FIGS. 18A and 18B may also be selectively adjustable in the same way as the occipital strap portion 1320 in FIGS. 7A and 7B is selectively adjustable.

In the example shown in FIG. 19, each of the lateral strap portions 1330 is rigidised and also comprises a superior transverse strap connection portion 1331 connected to the superior transverse strap portion 1370 and an occipital strap connection portion 1332 connected to the occipital strap portion 1320. Each lateral strap portion 1330 may extend posteriorly in use from its connection to the head-mounted display unit 1200 and may project superiorly to form the superior transverse strap connection portion 1331 and may project posteriorly and partially inferiorly to form the occipital strap connection portion 1332. Each of the superior transverse strap portion 1370 and occipital strap portion 1320 may connect to the lateral strap portions 1330 by any suitable manner of connection. In the example shown in FIG. 19, each of the superior transverse strap portion 1370 and occipital strap portion 1320 connects to the lateral strap portions 1330 by passing through a slot in the lateral strap portions 1330, looped back and securing to itself by a hook and loop connection. Alternatively, the connections may comprise buckles, magnetic connectors, a series of domes or the like.

The FIG. 19 example advantageously allows for both of the superior transverse strap portion 1370 and the occipital strap portion 1320 to be adjusted in length, which may allow for the head-mounted display system 1000 to fit to a wide range of head sizes and/or allow for large amounts of adjustability. In some examples, each of the superior transverse strap portion 1370 and the occipital strap portion 1320 are adjustable independently of each other such as by each connecting to the lateral strap portions 1330 by an adjustable hook-and-loop connection. In other examples, the superior transverse strap portion 1370 and occipital strap portion 1320 are adjustable simultaneously by an adjustment mechanism that adjusts the length (or at least effective length) of both the superior transverse strap portion 1370 and occipital strap portion 1320. Such a simultaneous adjustment mechanism could be a dial on one or both sides of the positioning and stabilising structure 1300 connected to ends of each of the superior transverse strap portion 1370 and occipital strap portion 1320, for example in a rack-and-pinion arrangement as described elsewhere herein or by cords attached to the dial configured to be retracted to tighten the strap portions or extended to loosen the strap portions upon turning of the dial, also as described elsewhere herein.

An advantage of simultaneous adjustment of the superior transverse strap portion 1370 and occipital strap portion 1320 is that the positioning and stabilising structure 1200 can be adjusted to fit a user's head without substantially changing the location of the junction between the superior transverse strap portion 1370 and occipital strap portion 1320 on the user's head, at least with respect to one or more features on the user's head, such as their eyes or their ears. For example, the positioning and stabilising structure 1200 may be configured so that the adjustment mechanism enables the superior transverse strap portion 1370 and occipital strap portion 1320 to be adjusted simultaneously while maintaining the posterior ends of the lateral strap portions 1330 at a substantially constant spacing from each respective otobasion superior. Alternatively or additionally, the superior transverse strap portion 1370 and occipital strap portion 1320 may be adjustable simultaneously resulting in an angle of each of the lateral strap portions 1330 and/or arms 1210 with respect to the Frankfort horizontal plane of the user's head remaining substantially constant.

In the example shown in FIG. 19, each lateral strap portion 1330 comprises a rigidiser 1305 which rigidises the lateral strap portion 1330 including the portions that form the superior transverse strap connection portion 1331 and the inferior transverse strap connection portion 1332. The rigidiser 1305 is indicated by the cross-hatched portion in FIG. 19.

The lateral strap portions 1330 may connect to arms 1210 of the head-mounted display unit 1200. The anterior portions of the lateral strap portions 1330, the arms 1210 and the connections between the lateral strap portions 1330, the arms 1210 and the head-mounted display unit 1200 may be substantially as described above with reference to FIGS. 8A-8B or elsewhere herein. In some examples the lateral strap portions 1330 are integrally formed with the arms 1210.

While the positioning and stabilising structures 1300 in the examples shown in FIG. 18A-19 comprise no top strap portion 1340, in other examples the positioning and stabilising structure 1300 further comprises a top strap portion 1340. The top strap portion 1340 may connect between the superior transverse strap portion 1370 and the head-mounted display unit 1200. The top strap portion 1340 may be selectively adjustable and may be as described with reference to FIGS. 7A-7B, 8A-8B or FIG. 10A, or as described elsewhere herein.

In some examples, the lateral strap portions 1330, superior transverse strap portion 1370 and the occipital strap portion 1370 are integrally formed. For example, the positioning and stabilising structure 1300 may comprise a seamless strap comprising the pair of lateral strap portions 1330, the superior transverse strap portion 1370 and the occipital strap portion 1320, save for any joint at an adjustment mechanism.

The various strap portions in the positioning and stabilising structure 1300 shown in FIGS. 18A-19 such as the lateral strap portions 1330, superior transverse strap portion 1370 and the occipital strap portion 1370 may each comprise a textile material. In some examples any or all of these strap portions may comprise a textile outer layer (on one or both sides) and a foam inner layer. Any or all of these strap portions may comprise a textile-foam laminate for example.

In other examples of the present technology, some or all of the portions of the positioning and stabilising structure 1300 may comprise materials other than or in addition to textile or textile and foam. In some examples, some or all strap portions may comprise silicone, rigid plastic, foam, leather or another suitable material.

In the examples illustrated in FIGS. 18A and 18B, the occipital strap portion 1320 or at least a portion thereof is not rigidised. In other examples substantially all of the occipital strap portion 1320 may be rigidised. In the example shown in FIG. 19, the superior transverse strap portion 1370 is not rigidised but in other examples it may be rigidised.

### 5.4.9 Additional Examples

FIGS. 20A-20C show further examples of head-mounted display systems 1000. The head-mounted display systems 1000 in these examples each comprise a positioning and stabilising structure 1300 comprising a first band portion 1382 constructed and arranged to connect to respective lateral sides of the head-mounted display unit 1200, partially encircle the user's head and engage a posterior region of the user's head in use. The positioning and stabilising structures 1300 further comprise a second band portion 1384 constructed and arranged to connect to respective lateral sides of the head-mounted display unit 1200 and engage a superior region of the user's head in use. The first band portion 1382 may in use pull the head-mounted display unit 1200 posteriorly into engagement with the user's face while the second band portion 1384 may pull the head-mounted display unit 1200 at least partially superiorly. The second band portion 1384 may also pull the head-mounted display unit 1200 at least partially posteriorly, in some examples. The combination of the first band portion 1382 and the second band portion 1384 may advantageously pull the head-mounted display unit 1200 posteriorly for stable engagement with the user's face, and superiorly to support some of the weight of the head-mounted display unit 1200.

As shown in each of FIGS. 20A and 20B, the second band portion 1384 in these examples is wider at the superior region of the user's head than at lateral (relatively inferior) regions of the user's head. This may advantageously provide for a stable fit of the second band portion 1384 to the user's head and/or reduce pressure applied to the surface of the user's head by distributing some of the weight of the display unit over a larger portion at the superior region of the user's head.

In the example shown in FIG. 20C, the first band portion 1382 comprises a semi-rigid portion 1396 constructed and arranged to engage the posterior region of the user's head in use. The semi-rigid portion 1396 may provide for a stable fit of the first band portion 1382 to the posterior surface of the user's head. The first band portion 1382 may be wider at the posterior region of the user's head than at lateral regions of the user's head, as shown in FIGS. 20B and 20C, which may provide additional stability. The first band portion 1382 may engage the user's head at regions overlying the occipital bone and/or overlying the parietal bones proximate the occipital bones. In the example shown in FIG. 20A, the first band portion 1382 may engage the user's head at a low position overlying the occipital bone but not the parietal bones.

As illustrated in each of the examples shown in FIGS. 20A-20C, the second band portion 1384 lies on a path extending posteriorly from each lateral side of the head-mounted display unit and curving superiorly into a superior transverse strap portion 1370 constructed and arranged to engage the superior region of the user's head.

As illustrated in FIG. 20C, the second band portion 1384 may comprise a pair of substantially rigid portions 1388 at the respective connections between the second band portion 1384 and the lateral sides of the head-mounted display unit 1200. The substantially rigid portions 1388 may enable the second band portion 1384 to support some of the weight of the head-mounted display unit 1200 by rigidising the curved portions of the second band portion 1384. The substantially rigid portions 1388 extend posteriorly from each lateral side of the head-mounted display unit 1200 and curve superiorly.

In the FIG. 20C example, the anterior end portion of the second band portion 1384 may form an arm 1210 (e.g., rigid arm). The arm 1210 may connect (e.g., snap-fit connect) to a lateral side of the head-mounted display (e.g., to a lateral support arm of the head-mounted display). The arm 1210 may be rotatable relative to the head-mounted display (e.g., via the lateral support arm which may be rotatable relative to the head-mounted display). In another example, the arm 1210 and second band portion 1384 may be formed as part of the head-mounted display.

Either or both of the first band portion 1382 and the second band portion 1384 may be selectively adjustable in length, for example by any manner disclosed herein in which a strap portion may be adjusted. For example, either or both of the first band portion 1382 and the second band portion 1384 may pass through a respective eyelet, loop back and secure to itself with a hook-and-loop connection.

For example, as shown in FIG. 20C, the first band portion 1382 is arranged to loop through an eyelet in buckle 1398 and attach to itself in a suitable manner (e.g., hoop and look connection). The buckle 1398 is anchored to the second band portion 1384 along a horizontally extending portion of the second band portion 1384 so that the second band portion is aligned with the first band portion 1382 when the first band portion is looped through the buckle 1398 (see the exploded view in FIG. 20C-1). This ensures that the head-mounted display is properly aligned on the user's head when the first band portion is adjusted to pull the head-mounted display into desired engagement with the user's head. In another example, the buckle 1398 could be a ladder buckle which would hold the tension itself and the free ends of the first band portion 1382 could be held down by any suitable means (e.g., hook and loop arrangement).

A buckle 1397 is anchored at the superior end of the second band portion 1384. The superior transverse strap portion 1370 is arranged to loop through an eyelet in buckle 1397 and attach to itself in a suitable manner (e.g., hook and loop connection). In an example, the eyelet in buckle 1397 may be arranged substantially perpendicularly to the eyelet in buckle 1398 such that the superior transverse strap portion 1370 is arranged substantially perpendicularly to the horizontal portion of the second band portion 1384. In this manner, the superior transverse strap portion 1370 may be arranged to support the weight of the head-mounted display by exerting only a vertical force component on the second band portion. In other examples, the eyelet in buckle 1397 may be slightly angled with respect to the eyelet in buckle 1398 such that the superior transverse strap portion 1370 exerts both a vertical force component and posterior oriented force component on the second band portion 1384. In other examples, the buckle 1397 could be a ladder buckle which would hold the tension itself and the free ends of the superior transverse strap portion could be held down by any suitable means (e.g., hook and loop arrangement). It is also noted that, in another example, the buckle 1397 could be anchored to the superior transverse strap portion 1370 and the second band portion 1384 could be arranged to loop through the buckle.

In other examples of FIGS. 20A-20C, the first band portion 1382 and/or second band portion 1384 may connect to arms 1210 of the head-mounted display unit 1200. The anterior portions of band portions, the arms 1210 and the connections between the band portions, the arms 1210 and the head-mounted display unit 1200 may be substantially as described above with reference to FIGS. 8A-8B (in the context of lateral strap portions 1330) or elsewhere herein. In some examples the first band portion 1382 is attached to the arms 1210 and the second band portion 1384 is connected to the first band portion 1382 proximate the arms 1210. In other examples, the second band portion 1384 is attached to the arms 1210 and the first band portion 1382 is connected to the second band portion 1384 proximate the arms 1210.

While the positioning and stabilising structure 1300 in the example shown in FIGS. 20A-20C comprises no top strap portion 1340 connecting to the head-mounted display unit 1200, in other examples the positioning and stabilising structure 1300 further comprises a top strap portion 1340. The top strap portion 1340 may connect between the second band strap portion 1384 (for example at the superior transverse strap portion 1370) and the head-mounted display unit 1200. In further examples the top strap portion 1340 may connect between the first band portion 1382 and the head-mounted display unit 1200. The top strap portion 1340 may be selectively adjustable and may be as described with reference to FIGS. 7A-7B, 8A-8B or FIG. 10A, or as described elsewhere herein.

The first band portion 1382 and/or second band portion 1384 may each comprise a seamless strap encircling the user's head. Alternatively, either or both of the first band portion 1382 and second band portion 1384 may be formed from a plurality of strap portions connected together.

The various strap portions in the positioning and stabilising structures 1300 shown in FIG. 20A-20C such as the first band portion 1382 and second band portion 1384 may each comprise a textile material. In some examples, either or both of these strap portions may comprise a textile outer layer (on one or both sides) and a foam inner layer. Either or both of these strap portions may comprise a textile-foam laminate for example.

In other examples of the present technology, some or all of the portions of the positioning and stabilising structure 1300 may comprise materials other than or in addition to textile or textile and foam. In some examples, some or all strap portions may comprise silicone, rigid plastic, foam, leather or another suitable material.

In variations of the examples shown in FIGS. 20A and 20B, the first band portion 1382 and second band portion 1384 may be rigidised.

### 5.5 Cleaning

In some forms, the head-mounted display system 1000 or at least a portion thereof, is designed to be used by a single user, and cleaned in a home of the user, e.g., washed in soapy water, without requiring specialised equipment for disinfection and sterilisation. Specifically, the positioning and stabilizing structure 1300 and the interfacing structure 1100 are designed to be cleaned, as they are both in direct contact with the user's head.

In some other forms, the components of the positioning and stabilizing structure 1300 and interfacing structure 1100 are used in labs, clinics and hospitals wherein a single head-mounted display may be reused on multiple persons or used during medical procedures. In each of the labs, clinics and hospitals the head-mounted displays, or relevant components thereof, can be reprocessed and be exposed to, for example, processes of thermal disinfection, chemical disinfection and sterilisation. As such, the design of the positioning and stabilizing structure and interfacing structure may need to be validated for disinfection and sterilisation of the mask in accordance with ISO17664.

Materials may be chosen to withstand reprocessing. For example, robust materials may be used in the positioning and stabilizing structure 1300 to withstand exposure to high level disinfection solutions and agitation with a brush. Further, some components of the positioning and stabilizing structure are separable, and in-use may be disconnected to improve the reprocessing efficacy.

In some examples, the interfacing structure 1100 may, in use, be in contact with the user's head and therefor may become dirty (e.g., from sweat). The interfacing structure 1100 may be designed to be removed from the display unit housing 1205, to provide the ability to remove it for cleaning and/or replacement. It may be desirable to wash the interfacing structure 1100 while not getting the positioning and stabilizing structure 1300 wet. Alternatively or in addition, the positioning and stabilizing structure 1300 may be dirty from contact with the user's head, and may be removed for cleaning and/or replacement independently of the interfacing structure 1100. In either case, this may be facilitated by allowing these components to disconnect for such a purpose.

In some examples, a cover (e.g., constructed from a textile, silicone, etc.) may be removably positioned over the interfacing structure and can be removed to be cleaned and/or replaced after each use. The cover may allow the interface structure 3400 to remain fixed to the display unit housing 1205, and still provide a surface that can be easily cleaned after being used.

### 5.6 External Computer

In some forms, the head-mounted display system 1000 (e.g., VR, AR, and/or MR) may be used in conjunction with a separate device, like a computer or video game console. For example, the display interface may be electrically connected to the separate device.

In some forms, at least some processing for the head-mounted display system 1000 may be performed by the separate device. The separate device may include a larger and/or more powerful processor than could be comfortably supported by the user (e.g., the processor of the separate device may be too heavy for the user to comfortably support on their head).

### 6 GLOSSARY

For the purposes of the present technology disclosure, in certain forms of the present technology, one or more of the following definitions may apply. In other forms of the present technology, alternative definitions may apply.

### 6.1 General

Ambient: In certain forms of the present technology, the term ambient will be taken to mean (i) external of the display interface and/or user, and (ii) immediately surrounding the display interface and/or user.

For example, ambient light with respect to a display interface may be the light immediately surrounding the user, e.g., the light in the same and/or adjacent room as a user, and/or natural light from the sun.

In certain forms, ambient (e.g., acoustic) noise may be considered to be the background noise level in the room where a user is located, other than for example, noise generated by the display device or emanating from speakers connected to the display device. Ambient noise may be generated by sources outside the room.

Leak: The word leak will be taken to be an unintended exposure to light. In one example, leak may occur as the result of an incomplete seal between a display unit and a users' face.

Noise, radiated (acoustic): Radiated noise in the present document refers to noise which is carried to the user by the ambient air. In one form, radiated noise may be quantified by measuring sound power/pressure levels of the object in question according to ISO 3744.

User: A person operating the display interface and/or viewing images provided by the display interface. For example, the person may be wearing, donning, and/or doffing the display interface.

### 6.1.1 Materials

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240

Polycarbonate: a thermoplastic polymer of Bisphenol-A Carbonate.

### 6.1.2 Mechanical Properties

Resilience: Ability of a material to absorb energy when deformed elastically and to release the energy upon unloading.

Resilient: Will release substantially all of the energy when unloaded. Includes e.g., certain silicones, and thermoplastic elastomers.

Hardness: The ability of a material per se to resist deformation (e.g., described by a Young's Modulus, or an indentation hardness scale measured on a standardised sample size).
‘Soft’ materials may include silicone or thermo-plastic elastomer (TPE), and may, e.g., readily deform under finger pressure.
‘Hard’ materials may include polycarbonate, polypropylene, steel or aluminium, and may not e.g., readily deform under finger pressure.

Stiffness (or rigidity) of a structure or component: The ability of the structure or component to resist deformation in response to an applied load. The load may be a force or a moment, e.g., compression, tension, bending or torsion. The structure or component may offer different resistances in different directions. The inverse of stiffness is flexibility.

Floppy structure or component: A structure or component that will change shape, e.g., bend, when caused to support its own weight, within a relatively short period of time such as 1 second.

Rigid structure or component: A structure or component that will not substantially change shape when subject to the loads typically encountered in use. An example of such a use may be setting up and maintaining a user interface in sealing relationship.

As an example, an I-beam may comprise a different bending stiffness (resistance to a bending load) in a first direction in comparison to a second, orthogonal direction. In another example, a structure or component may be floppy in a first direction and rigid in a second direction.

### 6.2 Materials

Closed-cell foam: Foam comprising cells that are completely encapsulated, i.e., closed cells.

Elastane: A polymer made from polyurethane.

Elastomer: A polymer that displays elastic properties. For example, silicone elastomer.

Ethylene-vinyl acetate (EVA): A copolymer of ethylene and vinyl acetate.

Fiber: A filament (mono or poly), a strand, a yarn, a thread or twine that is significantly longer than it is wide. A fiber may include animal-based material such as wool or silk, plant-based material such as linen and cotton, and synthetic material such as polyester and rayon. A fiber may specifically refer to a material that can be interwoven and/or interlaced (e.g., in a network) with other fibers of the same or different material.

Foam: Any material, for example polyurethane, having gas bubbles introduced during manufacture to produce a lightweight cellular form.

Neoprene: A synthetic rubber that is produced by polymerization of chloroprene. Neoprene is used in trade products: Breath-O-Prene.

Nylon: A synthetic polyamide that has elastic properties and can be used, for example, to form fibres/filaments for use in textiles.

Open-cell foam: Foam comprising cells, i.e., gas bubbles that aren't completely encapsulated, i.e., open cells.

Polycarbonate: a typically transparent thermoplastic polymer of Bisphenol-A Carbonate.

Polyethylene: A thermoplastic that is resistant to chemicals and moisture.

Polyurethane (PU): A plastic material made by copolymerizing an isocyanate and a polyhydric alcohol and, for example, can take the form of foam (polyurethane foam) and rubber (polyurethane rubber).

Semi-open foam: Foam comprising a combination of closed and open (encapsulated) cells.

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240.

Spacer Fabric: A composite construction comprised of two outer textile substrates joined together and kept apart by an intermediate layer of monofilaments.

Spandex: An elastic fibre or fabric, primarily comprised of polyurethane. Spandex is used in trade products: Lycra.

Textile: A material including at least one natural or artificial fiber. In this specification, a textile may refer to any material that is formed as a network of interwoven and/or interlaced fibers. A type of textile may include a fabric, which is constructed by interlacing the fibers using specific techniques. These include weaving, knitting, crocheting, knotting, tatting, tufting, or braiding. Cloth may be used synonymously with fabric, although may specifically refer to a processed piece of fabric. Other types of textiles may be constructed using bonding (chemical, mechanical, heat, etc.), felting, or other nonwoven processes. Textiles created through one of these processes are fabric-like, and may be considered synonymous with fabric for the purposes of this application.

Thermoplastic Elastomer (TPE): Are generally low modulus, flexible materials that can be stretched at room temperature with an ability to return to their approximate original length when stress is released. Trade products that use TPE include: Hytrel, Dynaflex, Medalist

Thermoplastic Polyurethane (TPU): A thermoplastic elastomer with a high durability and flexibility.

### 6.3 Mechanical Properties

Resilience: Ability of a material to absorb energy when deformed elastically and to release the energy upon unloading.

Resilient: Will release substantially all of the energy when unloaded. Includes e.g., certain silicones, and thermoplastic elastomers.

Hardness: The ability of a material per se to resist deformation (e.g., described by a Young's Modulus, or an indentation hardness scale measured on a standardised sample size).
‘Soft’ materials may include silicone or thermo-plastic elastomer (TPE), and may, e.g., readily deform under finger pressure.
‘Hard’ materials may include polycarbonate, polypropylene, steel or aluminium, and may not e.g., readily deform under finger pressure.

Stiffness (or rigidity) of a structure or component: The ability of the structure or component to resist deformation in response to an applied load. The load may be a force or a moment, e.g., compression, tension, bending or torsion. The structure or component may offer different resistances in different directions.

Floppy structure or component: A structure or component that will change shape, e.g., bend, when caused to support its own weight, within a relatively short period of time such as 1 second.

Rigid structure or component: A structure or component that will not substantially change shape when subject to the loads typically encountered in use.
As an example, an I-beam may comprise a different bending stiffness (resistance to a bending load) in a first direction in comparison to a second, orthogonal direction. In another example, a structure or component may be floppy in a first direction and rigid in a second direction.

### 6.4 Anatomy

The following definitions correspond references identified in FIGS. 1-2.

### 6.4.1 Anatomy of the Face

Ala: the external outer wall or “wing” of each nostril (plural: alar)

Alare: The most lateral point on the nasal ala.

Alar curvature (or alar crest) point: The most posterior point in the curved base line of each ala, found in the crease formed by the union of the ala with the cheek.

Auricle: The whole external visible part of the ear.

(nose) Bony framework: The bony framework of the nose comprises the nasal bones, the frontal process of the maxillae and the nasal part of the frontal bone.

Bridge (nasal): The nasal bridge is the midline prominence of the nose, extending from the Sellion to the Pronasale.

(nose) Cartilaginous framework: The cartilaginous framework of the nose comprises the septal, lateral, major and minor cartilages.

Cheilion: A point located at the corner of the mouth.

Columella: the strip of skin that separates the nares and which runs from the pronasale to the upper lip.

Columella angle: The angle between the line drawn through the midpoint of the nostril aperture and a line drawn perpendicular to the Frankfort horizontal while intersecting subnasale.

Endocanthion: The point at which the upper and lower eyelids meet, proximal to the Sellion.

Epicranius: The Epicranius, or frontal belly, refers to structures that cover the cranium.

External occipital protuberance: A protuberance on the outer surface of the occipital bone.

Frankfort horizontal plane: A line extending from the most inferior point of the orbital margin to the left tragion. The tragion is the deepest point in the notch superior to the tragus of the auricle.

Glabella: Located on the soft tissue, the most prominent point in the midsagittal plane of the forehead.

Interpupillary Distance: The distance between the centres of the pupils of the eyes.

Lateral nasal cartilage: A generally triangular plate of cartilage. Its superior margin is attached to the nasal bone and frontal process of the maxilla, and its inferior margin is connected to the greater alar cartilage.

Lip, inferior (labrale inferius): A point on the face between the mouth and supramenton, lying in the median sagittal plane.

Lip, superior (labrale superius): A point on the face between the mouth and nose, lying in the median sagittal plane.

Greater alar cartilage: A plate of cartilage lying below the lateral nasal cartilage. It is curved around the anterior part of the naris. Its posterior end is connected to the frontal process of the maxilla by a tough fibrous membrane containing three or four minor cartilages of the ala.

Nares (Nostrils): Approximately ellipsoidal apertures forming the entrance to the nasal cavity. The singular form of nares is naris (nostril). The nares are separated by the nasal septum.

Naso-labial sulcus or Naso-labial fold: The skin fold or groove that runs from each side of the nose to the corners of the mouth, separating the cheeks from the upper lip.

Naso-labial angle: The angle between the columella and the upper lip, while intersecting subnasale.

Otobasion inferior: The lowest point of attachment of the auricle to the skin of the face.

Otobasion superior: The highest point of attachment of the auricle to the skin of the face.

Pronasale: the most protruded point or tip of the nose, which can be identified in lateral view of the rest of the portion of the head.

Philtrum: the midline groove that runs from lower border of the nasal septum to the top of the lip in the upper lip region.

Pogonion: Located on the soft tissue, the most anterior midpoint of the chin.

Ridge (nasal): The nasal ridge is the midline prominence of the nose, extending from the Sellion to the Pronasale.

Sagittal plane: A vertical plane that passes from anterior (front) to posterior (rear). The midsagittal plane is a sagittal plane that divides the body into right and left halves.

Sellion: Located on the soft tissue, the most concave point overlying the area of the frontonasal suture.

Septal cartilage (nasal): The nasal septal cartilage forms part of the septum and divides the front part of the nasal cavity.

Subalare: The point at the lower margin of the alar base, where the alar base joins with the skin of the superior (upper) lip.

Subnasal point: Located on the soft tissue, the point at which the columella merges with the upper lip in the midsagittal plane.

Supramenton: The point of greatest concavity in the midline of the lower lip between labrale inferius and soft tissue pogonion.

Superciliary arch: A protuberance of the frontal bone above the eye.

Temporalis muscle: A muscle in the temporal fossa that serves to raise the lower jaw.

Temporomandibular joint: A freely moveable joint between the temporal bone and mandible that allows for the opening, closing, protrusion, retraction, and lateral movement of the mandible.

Vermillion, upper: A red part of the lips covered with stratified squamous epithelium which is in continuity with the oral mucosa of the gingivolabial groove.

### 6.4.2 Anatomy of the Skull

Frontal bone: The frontal bone includes a large vertical portion, the squama frontalis, corresponding to the region known as the forehead.

Lateral cartilage: Portion of cartilage lateral of the Septal cartilage and inferior to the Nasal bones.

Mandible: The mandible forms the lower jaw. The mental protuberance is the bony protuberance of the jaw that forms the chin.

Masseter minor: A lower portion of the Masseter muscle of which raises the lower jaw.

Maxilla: The maxilla forms the upper jaw and is located above the mandible and below the orbits. The frontal process of the maxilla projects upwards by the side of the nose, and forms part of its lateral boundary.

Nasal bones: The nasal bones are two small oblong bones, varying in size and form in different individuals; they are placed side by side at the middle and upper part of the face, and form, by their junction, the “bridge” of the nose.

Nasion: The intersection of the frontal bone and the two nasal bones, a depressed area directly between the eyes and superior to the bridge of the nose.

Occipital bone: The occipital bone is situated at the back and lower part of the cranium. It includes an oval aperture, the foramen magnum, through which the cranial cavity communicates with the vertebral canal. The curved plate behind the foramen magnum is the squama occipitalis.

Orbit: The bony cavity in the skull to contain the eyeball.

Parietal bones: The parietal bones are the bones that, when joined together, form the roof and sides of the cranium.

Septal cartilage: Cartilage of the nasal septum.

Sphenoid bone: A wedge shaped bone of the base of the cranium.

Supraorbital foramen: An opening in the inferior bone of the orbit for the passage of the Supraorbital nerve, artery and vein.

Temporal bones: The temporal bones are situated on the bases and sides of the skull, and support that part of the face known as the temple.

Trapezius minor: A triangular-shaped superficial muscle of the upper back.

Zygomatic bones: The face includes two zygomatic bones, located in the upper and lateral parts of the face and forming the prominence of the cheek.

### 6.5 User Interface

Frame: Frame will be taken to mean a display housing unit that bears the load of tension between two or more points of connection with a headgear and/or a hoop. The frame may seal against the user's face in order to limit and/or prevent the ingress and/or egress of light.

Hoop: Hoop will be taken to mean a form of positioning and stabilizing structure designed for use on a head. For example the hoop may comprise a collection of one or more struts, ties and stiffeners configured to locate and retain a user interface in position on a users' face for holding a display unit in an operational position in front of a user's face. Some ties are formed of a soft, flexible, elastic material such as a laminated composite of foam and fabric/textile. In some forms, the term headgear may be synonymous with the term hoop.

Membrane: Membrane will be taken to mean a typically thin element that has, preferably, substantially no resistance to bending, but has resistance to being stretched.

Seal: May be a noun form (“a seal”) which refers to a structure, or a verb form (“to seal”) which refers to the effect. Two elements may be constructed and/or arranged to ‘seal’ or to effect ‘sealing’ therebetween without requiring a separate ‘seal’ element per se.

Shell: A shell will be taken to mean a curved, relatively thin structure having bending, tensile and compressive stiffness. For example, a curved structural wall of a mask may be a shell. In some forms, a shell may be faceted. In some forms a shell may be airtight. In some forms a shell may not be airtight.

Stiffener: A stiffener will be taken to mean a structural component designed to increase the bending resistance of another component in at least one direction.

Strut: A strut will be taken to be a structural component designed to increase the compression resistance of another component in at least one direction.

Swivel (noun): A subassembly of components configured to rotate about a common axis, preferably independently, preferably under low torque. In one form, the swivel may be constructed to rotate through an angle of at least 360 degrees. In another form, the swivel may be constructed to rotate through an angle less than 360 degrees.

Tie (noun): A structure designed to resist tension.

### 6.6 Shape of Structures

Products in accordance with the present technology may comprise one or more three-dimensional mechanical structures, for example a mask cushion or an impeller. The three-dimensional structures may be bounded by two-dimensional surfaces. These surfaces may be distinguished using a label to describe an associated surface orientation, location, function, or some other characteristic. For example a structure may comprise one or more of an anterior surface, a posterior surface, an interior surface and an exterior surface. In another example, a seal-forming structure may comprise a face-contacting (e.g., outer) surface, and a separate non-face-contacting (e.g., underside or inner) surface. In another example, a structure may comprise a first surface and a second surface.

To facilitate describing the shape of the three-dimensional structures and the surfaces, we first consider a cross-section through a surface of the structure at a point, p. See FIG. 3A to FIG. 3E, which illustrate examples of cross-sections at point p on a surface, and the resulting plane curves. FIGS. 3A to 3E also illustrate an outward normal vector at p. The outward normal vector at p points away from the surface. In some examples we describe the surface from the point of view of an imaginary small person standing upright on the surface.

### 6.6.1 Curvature in One Dimension

The curvature of a plane curve at p may be described as having a sign (e.g., positive, negative) and a magnitude (e.g., 1/radius of a circle that just touches the curve at p).

Positive curvature: If the curve at p turns towards the outward normal, the curvature at that point will be taken to be positive (if the imaginary small person leaves the point p they must walk uphill). See FIG. 3A (relatively large positive curvature compared to FIG. 3B) and FIG. 3B (relatively small positive curvature compared to FIG. 3A). Such curves are often referred to as concave.

Zero curvature: If the curve at p is a straight line, the curvature will be taken to be zero (if the imaginary small person leaves the point p, they can walk on a level, neither up nor down). See FIG. 3C.

Negative curvature: If the curve at p turns away from the outward normal, the curvature in that direction at that point will be taken to be negative (if the imaginary small person leaves the point p they must walk downhill). See FIG. 3D (relatively small negative curvature compared to FIG. 3E) and FIG. 3E (relatively large negative curvature compared to FIG. 3F). Such curves are often referred to as convex.

### 6.6.2 Curvature of Two Dimensional Surfaces

A description of the shape at a given point on a two-dimensional surface in accordance with the present technology may include multiple normal cross-sections. The multiple cross-sections may cut the surface in a plane that includes the outward normal (a “normal plane”), and each cross-section may be taken in a different direction. Each cross-section results in a plane curve with a corresponding curvature. The different curvatures at that point may have the same sign, or a different sign. Each of the curvatures at that point has a magnitude, e.g., relatively small. The plane curves in FIGS. 3A to 3E could be examples of such multiple cross-sections at a particular point.

Principal curvatures and directions: The directions of the normal planes where the curvature of the curve takes its maximum and minimum values are called the principal directions. In the examples of FIG. 3A to FIG. 3E, the maximum curvature occurs in FIG. 3A, and the minimum occurs in FIG. 3E, hence FIG. 3A and FIG. 3E are cross sections in the principal directions. The principal curvatures at p are the curvatures in the principal directions.

Region of a surface: A connected set of points on a surface. The set of points in a region may have similar characteristics, e.g., curvatures or signs.

Saddle region: A region where at each point, the principal curvatures have opposite signs, that is, one is positive, and the other is negative (depending on the direction to which the imaginary person turns, they may walk uphill or downhill).

Dome region: A region where at each point the principal curvatures have the same sign, e.g., both positive (a “concave dome”) or both negative (a “convex dome”).

Cylindrical region: A region where one principal curvature is zero (or, for example, zero within manufacturing tolerances) and the other principal curvature is non-zero.

Planar region: A region of a surface where both of the principal curvatures are zero (or, for example, zero within manufacturing tolerances).

Edge of a surface: A boundary or limit of a surface or region.

Path: In certain forms of the present technology, ‘path’ will be taken to mean a path in the mathematical-topological sense, e.g., a continuous space curve from f(0) to f(1) on a surface. In certain forms of the present technology, a ‘path’ may be described as a route or course, including e.g., a set of points on a surface. (The path for the imaginary person is where they walk on the surface, and is analogous to a garden path).

Path length: In certain forms of the present technology, ‘path length’ will be taken to mean the distance along the surface from f(0) to f(1), that is, the distance along the path on the surface. There may be more than one path between two points on a surface and such paths may have different path lengths. (The path length for the imaginary person would be the distance they have to walk on the surface along the path).

Straight-line distance: The straight-line distance is the distance between two points on a surface, but without regard to the surface. On planar regions, there would be a path on the surface having the same path length as the straight-line distance between two points on the surface. On non-planar surfaces, there may be no paths having the same path length as the straight-line distance between two points. (For the imaginary person, the straight-line distance would correspond to the distance ‘as the crow flies’.)

### 6.6.3 Space Curves

Space curves: Unlike a plane curve, a space curve does not necessarily lie in any particular plane. A space curve may be closed, that is, having no endpoints. A space curve may be considered to be a one-dimensional piece of three-dimensional space. An imaginary person walking on a strand of the DNA helix walks along a space curve. A typical human left ear comprises a helix, which is a left-hand helix, see FIG. 3M. A typical human right ear comprises a helix, which is a right-hand helix, see FIG. 3N. FIG. 3O shows a right-hand helix. The edge of a structure, e.g., the edge of a membrane or impeller, may follow a space curve. In general, a space curve may be described by a curvature and a torsion at each point on the space curve. Torsion is a measure of how the curve turns out of a plane. Torsion has a sign and a magnitude. The torsion at a point on a space curve may be characterised with reference to the tangent, normal and binormal vectors at that point.

Tangent unit vector (or unit tangent vector): For each point on a curve, a vector at the point specifies a direction from that point, as well as a magnitude. A tangent unit vector is a unit vector pointing in the same direction as the curve at that point. If an imaginary person were flying along the curve and fell off her vehicle at a particular point, the direction of the tangent vector is the direction she would be travelling.

Unit normal vector: As the imaginary person moves along the curve, this tangent vector itself changes. The unit vector pointing in the same direction that the tangent vector is changing is called the unit principal normal vector. It is perpendicular to the tangent vector.

Binormal unit vector: The binormal unit vector is perpendicular to both the tangent vector and the principal normal vector. Its direction may be determined by a right-hand rule (see e.g., FIG. 3L), or alternatively by a left-hand rule (FIG. 3K).

Osculating plane: The plane containing the unit tangent vector and the unit principal normal vector. See FIGS. 3K and 3L.

Torsion of a space curve: The torsion at a point of a space curve is the magnitude of the rate of change of the binormal unit vector at that point. It measures how much the curve deviates from the osculating plane. A space curve which lies in a plane has zero torsion. A space curve which deviates a relatively small amount from the osculating plane will have a relatively small magnitude of torsion (e.g., a gently sloping helical path). A space curve which deviates a relatively large amount from the osculating plane will have a relatively large magnitude of torsion (e.g., a steeply sloping helical path). With reference to FIG. 3O, since T2>T1, the magnitude of the torsion near the top coils of the helix of FIG. 3O is greater than the magnitude of the torsion of the bottom coils of the helix of FIG. 3O

With reference to the right-hand rule of FIG. 3M, a space curve turning towards the direction of the right-hand binormal may be considered as having a right-hand positive torsion (e.g., a right-hand helix as shown in FIG. 3O). A space curve turning away from the direction of the right-hand binormal may be considered as having a right-hand negative torsion (e.g., a left-hand helix).

Equivalently, and with reference to a left-hand rule (see FIG. 3K), a space curve turning towards the direction of the left-hand binormal may be considered as having a left-hand positive torsion (e.g., a left-hand helix). Hence left-hand positive is equivalent to right-hand negative.

### 6.6.4 Holes

A surface may have a one-dimensional hole, e.g., a hole bounded by a plane curve or by a space curve. Thin structures (e.g., a membrane) with a hole, may be described as having a one-dimensional hole. See for example the one dimensional hole in the surface of structure shown in FIG. 3F, bounded by a plane curve.

A structure may have a two-dimensional hole, e.g., a hole bounded by a surface. For example, an inflatable tyre has a two dimensional hole bounded by the interior surface of the tyre. In another example, a bladder with a cavity for air or gel could have a two-dimensional hole. In a yet another example, a conduit may comprise a one-dimension hole (e.g., at its entrance or at its exit), and a two-dimension hole bounded by the inside surface of the conduit. See also the two dimensional hole through the structure shown in FIG. 3H, bounded by a surface as shown.

### 6.7 Other Remarks

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated herein by reference in their entirety to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative examples and that other arrangements may be devised without departing from the spirit and scope of the technology.

### 6.8 Selected Reference Signs List

100 User
1000 Head-mounted display system
1100 Interfacing structure
1101 Interfacing structure clip
1102 Chassis portion
1118 Face engaging flange
1121 First end of face engaging flange
1122 Second end of face engaging flange
1123 Face engaging region
1130 Cushion
1131 Cushion body
1135 Cushion clip
1140 Cheek portion
1150 Closed loop portion
1160 Open loop portion
1170 Sphenoid portion
1175 Forehead portion
1180 Nasal portion
1182 Pronasale portion
1186 Bridge portions
1200 Head-mounted display unit
1205 Display unit housing
1220 Display screen
1230 Superior face
1232 Inferior face
1234 Lateral left face
1236 Lateral right face
1238 Anterior face
1240 Lens
1250 Temporal connector
1254 Eyelet
1256 Adjustment portion
1258 Receiving portion
1260 Pivot connection
1270 Controller
1272 Speaker
1274 Power source
1276 Control system
1278 Low power system battery
1280 Main battery
1282 Real time clock
1284 Orientation sensor
1286 Processing system
1288 Battery support portion
1290 Control system support
1300 Positioning and stabilising structure
1350 Posterior support portion
1360 Forehead support

1-27. (canceled)

28. A positioning and stabilising structure for holding a head-mounted display unit in an operative position on a user's head, the positioning and stabilising structure comprising:
a ring strap portion forming a ring shape including an occipital strap portion being constructed and arranged to engage a region of the user's head overlying the occipital bone or overlying the parietal bones proximate the occipital bone; and
a pair of lateral strap portions configured to extend along respective sides of the user's head in use, each lateral strap portion having 1) a posterior end portion connected to a respective side of the ring strap portion at a connection location, and 2) an anterior end portion adapted to connect to a respective lateral side of a head-mounted display unit,
wherein, when the positioning and stabilising structure is worn in use, each connection location is positioned superior to the anterior end portion of the respective lateral strap portion.

29. The positioning and stabilising structure of claim 28, wherein each of the lateral strap portions extends at least partially superiorly in a direction from the anterior end portion to the posterior end portion.

30. The positioning and stabilising structure of claim 28, wherein the ring strap portion is structured to substantially hold an in-use shape when the positioning and stabilising structure is not donned by the user.

31. The positioning and stabilising structure of claim 28, wherein the positioning and stabilising structure is configured to resist angular change between the superior transverse strap portion and the occipital strap portion when the lateral strap portions are tensioned in use.

32. The positioning and stabilising structure of claim 28, wherein a width of the occipital strap portion measured transversely to a length of the occipital strap portion is greater than a width of the superior transverse strap portion measured transversely to a length of the superior transverse strap portion.

33. The positioning and stabilising structure of claim 28, wherein a thickness of the ring strap portion is greater than a thickness of the lateral strap portions.

34. The positioning and stabilising structure of claim 33, wherein the thickness of the ring strap portion is greater than a thickness of the top strap portion.

35. The positioning and stabilising structure of claim 28, wherein the ring strap portion comprises a plurality of segments formed separately and joined together to form the ring strap portion.

36. The positioning and stabilising structure of claim 35, wherein the segments comprise a superior segment, a pair of lateral segments and an inferior segment.

37. The positioning and stabilising structure of claim 28, wherein the ring strap portion comprises at least a pair of hinges, each hinge being located proximate one of the connection locations between the ring strap portion and a respective one of the lateral strap portions.

38. The positioning and stabilising structure of claim 28, wherein each of the lateral strap portions is selectively adjustable in length.

39. The positioning and stabilising structure of claim 38, wherein each of the lateral strap portions is configured to be secured to itself to form a loop that is adapted to connect to the head-mounted display unit.

40. The positioning and stabilising structure of claim 39, wherein each of the lateral strap portions is configured to be secured to itself with a hook-and-loop connection.

41. The positioning and stabilising structure of claim 28, wherein the occipital strap portion is constructed and arranged to be positioned at or proximate the Frankfort Horizontal plane of the user's head in use.

42. The positioning and stabilising structure of claim 28, wherein the positioning and stabilising structure further comprises a top strap portion connected to the superior transverse strap portion or the occipital strap portion and configured to extend anteriorly therefrom, in use, over a portion of the user's head overlying the user's frontal bone, the top strap portion being adapted to connect to the head-mounted display unit.

43. The positioning and stabilising structure of claim 42, wherein the ring strap portion has a rigidity at a location along its length that is different than the rigidity at a location along a length of each lateral strap portion.

44. The positioning and stabilising structure of claim 42, wherein the top strap portion is selectively adjustable in length.

45. The positioning and stabilising structure of claim 44, wherein the top strap portion is configured to be secured to itself to form a loop that is adapted to connect to the head-mounted display unit.

46. The positioning and stabilising structure of claim 45, wherein the top strap portion is configured to be secured to itself with a hook-and-loop connection.

47. The positioning and stabilising structure of claim 28, wherein the ring strap portion is wider in the superior transverse strap portion at a location intersecting the sagittal plane of the user's head in use than at other locations around the ring strap portion.

48. The positioning and stabilising structure of claim 47, wherein the superior transverse strap portion comprises a greater width at the location intersecting the sagittal plane than at lateral portions of the superior transverse strap portion.

49. The positioning and stabilising structure of claim 48, wherein the superior transverse strap portion comprises an anterior edge and a posterior edge, the anterior edge being more curved than the posterior edge to form the greater width.

50. The positioning and stabilising structure of claim 49, wherein the anterior edge curves anteriorly in lateral to medial directions and the posterior edge is substantially not curved anteriorly or posteriorly.

51. The positioning and stabilising structure of claim 28, wherein the ring strap portion has increased rigidity in areas directly adjacent the connection locations as compared to a rigidity in at least one other area of the ring strap portion.

52. The positioning and stabilising structure of claim 28, wherein the ring strap portion further includes a superior transverse strap portion constructed and arranged to engage a superior region of the user's head at or proximate a coronal plane.

53. A head-mounted display system, comprising:
a head-mounted display unit comprising:
a display unit housing comprising a display; and
an interfacing structure connected to the display unit housing and constructed and arranged to engage the user's face in use; and
the positioning and stabilising structure of claim 28.

54. The head-mounted display system of claim 53, wherein the head-mounted display unit comprises a pair of arms extending posteriorly from respective lateral sides of the display unit housing, the lateral strap portions each being configured to attach to a respective one of the arms.

55. The head-mounted display system of claim 54, wherein the arms are pivotably attached to the display unit housing.

56-135. (canceled)
